(19) United States
(12) Patent Application Publication
(10) Pub. No.: US 2004/0056779 A1
(43) Pub. Date: Mar. 25, 2004

(54) Transportation signaling device

(76) Inventor: Rodger H. Rast, Gold River, CA (US)

Correspondence Address: Rastar Corporation, 11230 Gold Express Drive, Gold River, CA, 95670, US

(21) Appl. No.: 10/612,225

(22) Filed: Jul. 1, 2003

Related U.S. Application Data
(60) Provisional application No. 60/394,160, filed on Jul. 1, 2002.

(51) Int. Cl. G08G 3/00

(52) U.S. Cl. 340/985

(57) ABSTRACT

An apparatus for generating buoy light signals using a collimated light source. The system provides for communication of system conditions and ambient conditions, and can provide homeland security monitoring. The system senses motion of the buoy and compensates the direction of lighting, and optionally acoustics, being generated out over a body of water. Numerous other transportation related embodiments are described including devices for providing user comfort when flying, automotive signaling, auto parking control, sports bottles, visors, and lures.

### CROSS-REFERENCE TO RELATED APPLICATIONS

This application claims priority from U.S. provisional application serial No. 60/394,160 filed on Jul. 1, 2002.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to transportation and more particularly to a transportation signaling devices and other transportation related devices and systems.

2. Description of the Background Art

Conventional maritime signaling devices (buoys) are configured with a light mounted atop a raised structure attached to a floating platform that is generally anchored to the floor of a body of water. These systems may additionally, or alternately, generate audio signals to warn ships and small boats of the presence of land. These buoys may be configured with a colored light, a sound, a color pattern marking, indicia, or combination thereof that provide identification of the buoy as a specific landmark on the waterway.

Lighted buoys of this type, however, require large amounts of power and are unable to cast a light beam very far out into the waterway. In addition, the amount of information generated to passing ships and back from the buoy to maintenance personnel and monitoring entities, is severely limited.

As can be seen, therefore, the development of buoy systems that provide extended-range lighted signals along with additional information to both ships and ground based personnel, would enhance maritime safety.

### SUMMARY OF THE INVENTION

The present invention is a buoy system and method that is capable of properly orienting a collimated light source, such as a laser light source, over a desired compass arc and elevation angle, despite the movement of the buoy in the rolling waves. Audio information may also be created and directed by the buoy system toward desirable directions and sound energy curtailed over land or other areas that would prefer quite. The system can generate different audio messages or sounds depending on the direction that the audio is generated.

The buoy can be configured with data and status collection sensors. A camera and microphone is preferably connected to a wireless communication system on the buoy to allow monitoring of conditions at the buoy as well as to provide a remote communication device that may be utilized by persons in that water or a passing boat that are in distress.

Power systems are described for providing substantial quantities of electrical power to a buoy system while not requiring substantial maintenance.

An aspect of the invention is to provide buoy signaling that can be seen a farther distance while utilizing less power.

Another aspect of the invention is to generate audio and visual signals from a buoy that do not disturb parties on land.

Another aspect of the invention is to register ambient conditions at the buoy and communicate that information to a remote station.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a partial cross-section and block diagram of a Buoy signaling system according to an embodiment of the present invention, shown with a rotating output module for directing light and sound energy.

FIG. 2 is a side view of a buoy system according to an aspect of the present invention, shown with a wave action operated power generator.

FIG. 3 is a edge view of the generator mechanism shown in FIG. 2 according to an aspect of the present system.

FIG. 4 is a detailed view of ratchet engagement within the generator mechanism of FIG. 3.

FIG. 5 is a side view of the generator mechanism shown in FIG. 3.

FIG. 6 is a side view of an alternative embodiment of a generator transmission for the wave action operated power generator of the present invention.

FIG. 7 is an underside view of a ship hull according to an embodiment of a propeller synchronization system, shown with sensor strips attached.

FIG. 8 is a block diagram of the synchronization system of FIG. 7.

FIG. 9 is a flowchart of the synchronization system of FIG. 8.

FIG. 10 is a block diagram of a clock synchronization system according to an embodiment of the present invention.

FIG. 11 is a pictorial view of a flight pillow according to an embodiment of the present invention, shown for being supported on a tray table.

FIG. 12 is a side view of optional ear muffs for the flight pillow of FIG. 11.

FIG. 13 is a top view of optional ear muffs of FIG. 12.

FIG. 14 is a flowchart for an embodiment of a common mapping interface and business method for providing map based services over the internet.

FIG. 15 is a facing view of a rear lighting panel for a vehicle according to an embodiment of the present invention, shown discrete elements being separately controlled to produce driving indications.

FIG. 16 is a facing view of three light situations, turning, braking, and reversing, displayed according to an example of the present invention.

FIG. 17 is a side view of a vehicle having display based trim, according to an aspect of the present invention, and shown as an LED strip.

FIG. 18 is a block diagram of a vehicle scrolling display according to an embodiment of the present invention, shown with a simplified control interface, and aspect of which accepts voice commands for controlling the visual display output directed at other drivers and pedestrians.

FIG. 19 is a block diagram of an auxiliary system cutout system according to an embodiment of the present invention, shown for deactivating the load of the A/C and optionally the alternator, in response to user attempts to accelerate.

FIG. 20 is a flowchart of a parking registration system according to an embodiment of the present invention.

FIG. 21 is a block diagram of a parking alarm system according to an embodiment of the present invention, shown for generating an audio alert when other than the owner of the space parks over the alarm unit.

FIG. 22 is a facing view of a tape measure according to an embodiment of the present invention, shown with a recess for receiving a notepad.

FIG. 23 is a side view of the tape measure of FIG. 22.

FIG. 24 is a facing view of a tape measure according to an embodiment of the present invention, shown with an electronically writable surface.

FIG. 25 is a detailed top view of the transparent viewer for a tape measure.

FIG. 26 is a top view of underside tape markings according to an embodiment of the present invention, shown for detecting the position of the tape measure extension.

FIG. 27 is a top view of detection sensors according to aspect of the present invention.

FIG. 28 is a side view of detecting underside tape markers to determined extended distance according to aspect of the present invention.

FIG. 29 is a list of controls for an electronic tape measure with recording interface according to an embodiment of the present invention.

FIG. 30 is a facing view of a tape measure having a recording interface according to an embodiment of the present invention.

FIG. 31 is a facing view of a tape measure module configured for insertion in a PDA, or similar electronic device, according to an embodiment of the present invention.

FIG. 32 is a block diagram of the circuitry within the tape measure module of FIG. 31.

FIG. 33 is a flowchart of a tool tracking system according to an embodiment of the present invention.

FIG. 34 is a block diagram of a tool tracking system according to an embodiment of the present invention.

FIGS. 35-37 are views of article retention devices according to aspects of the present invention.

FIG. 38 is a schematic of a trailer light testing system according to an embodiment of the present invention, shown with a microcontroller modulating aspects of the light connections.

FIG. 39 is an underside view of an automated roadway sealing system according to an embodiment of the present invention, shown with a multiple nozzles operating on multiple tracks.

FIG. 40 is an side view of crack detection according to an aspect of the present invention, shown with a laser light projection and camera imaging of pavement cracks.

FIG. 41 is schematic of the automated roadway sealing system of FIG. 39.

FIG. 42 is a top view of an manual roadway sealing wand according to an embodiment of the present invention, shown for dispensing a single stream of sealant over a crack without the need of user accuracy.

FIG. 43 is a side view of a pressurized nozzle reservoir according to an aspect of the roadway sealing system.

FIG. 44 is a block diagram of a treadmill Run/Walk selection system according to an embodiment of the present invention, with portions of a user interface connected to a control computer.

FIG. 45 is a side view of a metered output sports bottle according to an embodiment of the present invention, shown with a central chamber selective valve.

FIGS. 46-48 are side views of sports bottles having a reserve quantity of fluid according to an embodiments of the present invention.

FIGS. 49-51 are views of a suspension visor according to an embodiment of the present invention.

FIGS. 52-53 are views of an alternate embodiment of the suspension visor of FIG. 49.

FIG. 54 is a schematic of a toy audio “stink bomb” according to an embodiment of the present invention, shown with a microcontroller with RFID locator.

FIG. 55 is a side view of a fisherman utilizing a patrolling lure according to an embodiment of the present invention.

FIG. 56 is a side view of a patrolling lure according to an embodiment of the present invention.

### DETAILED DESCRIPTION OF EMBODIMENT(S)

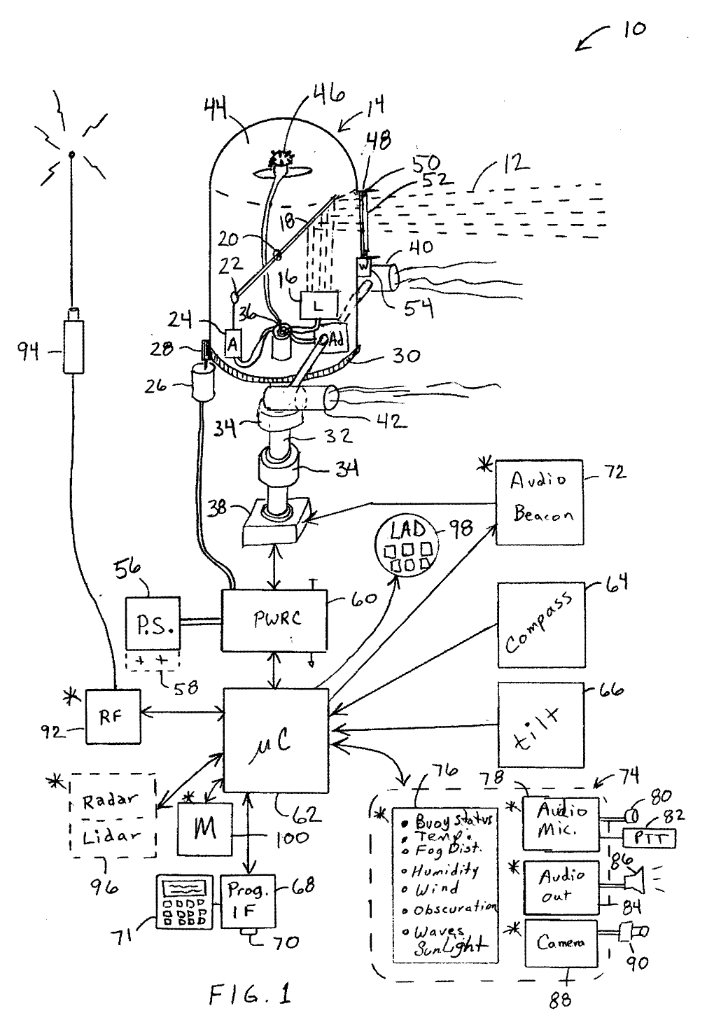

Referring more specifically to the drawings, for illustrative purposes the present invention is embodied in the apparatus generally shown in FIG. 1 through FIG. 56.

Illustrative embodiment(s) of the invention are described herein and depicted in the drawings, the invention is susceptible of embodiment in many forms and it should be understood that the present disclosure is to be considered as an exemplification of the principle aspects of the invention and is not intended to limit the invention to the embodiment(s) illustrated. Various aspects, modes, embodiments, variations, and features may be described throughout the specification which need not be implemented to practice aspects of the invention. Furthermore, preferred elements of the invention may be referred to whose inclusion is generally optional, limited to specific applications or embodiment, or with respect to desired uses, results, cost factors and so forth.

Throughout the specification numerous values and type designations may be provided for the elements of the invention in order that a complete, operable, embodiment of the invention be disclosed. However, it should be understood that such values and type designators are merely representative and are not critical unless specifically so stated. The scope of the invention is not limited to one or more specific exemplifications within a described embodiment.

The present system and method may be implemented in a number of ways, however, the following is limited to descriptions of one or more preferred embodiments of the invention that may be readily practiced and easily understood. It should be appreciated, however, that one of ordinary skill in the art can modify these embodiments, especially in view of the teachings found herein, to implement a number of variations on the embodied invention without the need for creative effort and without departing from the teachings of the invention as described and/or claimed.

1. Buoy Signaling Systems.

Methods and systems of signaling (light, sound, radio) are described from floating navigation buoys.

1.1 Introduction.

The system provides enhanced signaling capabilities for a buoy wired to receive power or which has its own power source. One aspect of the invention is the use of a laser based lighting system. It will be appreciated that laser light is collimated and even operating at a very low power is capable of directing a beam of light many miles. Laser light itself may be generated with five to ten times the efficiency of incandescent lighting, while its collimated output provides for directing the light into a small pattern so that the light output at a distance can easily be 3-5 orders of magnitude above that for a dispersive (undirected) incandescent source.

As a lighted buoy is subject to swaying movements within the waves, the use of undirected lighting sources has been preferred, assuring that light is at least generated in a plane parallel to the surface of the water for visibility. These current omni directional buoys suffer a number of drawbacks, such as limited range and signaling capability.

The present invention, however, is capable of directing the highly collimated laser lighting sources to maintain a given relative angle with the horizontal (plane of the water surface) despite the motions of the buoy. The system primarily comprises a laser light source, a translation stage, a tilt sensor, and a controller. The translation stage is configured to offset the measured tilt of the platform to maintain the direction of the laser light toward a specific direction or following a scan of the horizon. A number of ways exist to embody the present invention, the following is provided by way of example.

1.2 Lighted Laser Beacon.

FIG. 1 depicts an embodiment 10 of the invention with rotating light beacon 12 within a housing 14. The light beacon 12 is generated from a laser light source 16, preferably comprising a number of elements, such as from four to eight (4-8) which are retained in a given pattern, or angular spread. A means for directing the path of the laser light is provided, exemplified as a means for changing inclination angle of the light and a means for changing the horizontal direction of the light. It will be appreciated that light may be directed in two or three dimensions using a number of alternative mechanisms.

The means for changing inclination angle is exemplified as a mirror 18 connecting through pivot 20 and connected at distal end 22 to actuator 24. Movement of the actuator changes the mirror angle and thus the angular direction of the beam. The inclination adjustment preferably is capable of adjusting the inclination angle of the light over an angle that is equal to or approaches the angle by which the buoy may be subjected in rough conditions, wherein the light direction can be maintained toward the horizon.

The means for changing the horizontal direction of the light source is exemplified as a means for rotating housing 14, depicted as a geared motor 26 whose output 28 is coupled to a gear ring 30 of housing 14. Housing 14 is connected through a rotating shaft 32 and bearings 34 (or bushings). Power may be routed into rotating housing 14 by means of a commutator arrangement at the top 36 and bottom 38 of rotating shaft 32 which allows unrestricted rotating motion. Alternatively, coiled or otherwise flexible wiring may be utilized so long as the rotation is limited, such as for example to a back and forth movement where less than about 7200 is traversed.

The means for changing horizontal direction of the light source is also shown for adjusting the direction of a pair of audio sources 40, 42. Although conventional audio sources may be utilized, it is preferred that ultrasonic transducers are utilized with sound in the human audio range being heard at the intersection of the two beams. It will be appreciated that audio energy becomes increasingly direction as wavelength decreases, wherein the preferred arrangement allows the sound to be generated toward specific direction (i.e. only out toward the ocean), and to allow different audio messages to be generated in response to direction, such as angle from the beacon, obstruction warnings that depend on the angular relationship of the boat to the buoy, and so forth.

Housing 14 is optionally configured with a transparent domed top 44 with omni directional marking light 46. It will be noted that direction beam 12 can not be seen from all direction, wherein a low intensity light marker 46 is provided so the buoy can preferably be easily located from land, sea, or air. Light marker 46 preferably comprises a high efficiency source, such as an LED lighting cluster.

Light beacon 12 is directed through a transparent lens 50 that is protected by a surrounding shroud 48. A wiper assembly comprising a wiper blade 52 and actuator 54 is also shown for automatically clearing the lens of water spray the reaches the lens. A reservoir of detergent material having anti-scaling properties may be incorporated so that mineral deposits on the lens may be minimized.

A conventional lens 50 may be used for preventing materials from entering the system. It may be desired to use a rotating transparent ring that is cleaned as is rotates within the housing, wherein even in the worst storms the front of the lens remains clear of obstructions. Cameras used within a number of sporting events utilize a similar mechanism wherein a lens is set to move, or rotate past the front of the camera when dirt, or precipitation obscure the view (i.e. as sensed for example based on reflected light intensity).

Alternatively a fan may be utilized to drive a shaft of air from underneath the unit out through the light output hood so that particles of water, or dirt, are unable to penetrate the hood. A coarse mesh screen may be used to prevent incursion of larger items, such as birds, insects, and so forth.

As the rotating beacon rotates, the angle of the mirror is altered to compensate for the buoy angle such that the laser beams can be retained at a given angular relationship to the horizontal. It is preferred that the multiple beams be deployed with an angular spread wherein an pattern of beams of generated which may be seen at various distances from the buoy. Additionally, these beams may be coded in an off-on-off pattern or using colors wherein information may be readily conveyed as to distance from the buoy or the buoy location. For example a pattern of colored lights may be configured with the (1st) top beam showing full green, a 2nd beam showing intermittent green, a 3rd and 4th beam showing white or blue laser light, a 5th beam with intermittent red light, and a 6th beam with a full on red pattern. The beam angles can convey general information on distance from the buoy to a small ship.

The activity of the lasers may optionally be modulated to “write” a short note, which for example would be read on the side of the vessel. By utilizing a series of vertical laser pixels which are directed to near the horizontal and modulating the pixels on and off in a similar manner to a dot matrix print head, a text message can be sent by the buoy, such as its location, to small boats and ships. The message could be seen if any fog were present wherein the message would be written in the fog, or on the side of a vessel. Although this may have limited applicability in these times of inexpensive GPS systems.

1.3.1 Alternate Control of Light Beacon.

It will be appreciated that the laser may be directed by an X-Y stage without the need for rotation of the head portion, this would be best suited for buoys whose beacon is to be directed to span a generally limited angular area, such as an arc of less than one hundred eighty degrees. In addition, a number of other mechanisms may be utilized for scanning the laser light.

By way of example a modified version of the “splatter reflector” described herein under “Laser Sign Embodiments” may be utilized for directing the light in a rotating pattern. The application, incorporated herein by reference is included within application serial No. 60/394,160 filed Jul. 1, 2002, and a subsequent application Ser. No. ______ filed ______. The splatter reflector may be shaped as an inverted pyramidal structure with any number of desired external facets, preferably from four to sixteen. The lasers reflect from the facets out toward a horizontal direction while the facets themselves direct each group of lasers to span a given arc. The coloring, or pattern of each laser section may be modulated in relation to the angular position in relation to the buoy, which can be facilitated by the compass, wherein passing boats can get a fix on their angular position in relation to the buoy. The housing for the “splatter reflector” is preferably transparent with the lasers distributed around the periphery either singly or preferably in vertically arranged groups, such as from 4-16 lasers. The “splatter reflectors” would provide similar abilities for writing on fog, the water surface, ships, and so forth.

The splatter reflector may be oriented on a vertical rotational axis with a plurality of lasers about its periphery. The module for the reflector may be gimbaled to remain horizontal, or it is preferably configured with an X-Y translation stage wherein the reflector may be maintained in a vertical position despite changes in angular position of the buoy. In this way the unit can output more light (lasers arranged vertically and circumferentially.

1.3 Control System and I/O.

The operation of the laser, mirror actuator, rotational drive and other elements within the buoy are preferably controlled by a microcontroller, or other control circuit. A block diagram is shown within the figure connecting to the rotatable housing 14.

Power to the buoy systems is provided by a power source 56, preferably having a redundant source of power 58. Power source 56 may be associated with a wired power source, a battery power source, a solar cell power source, a fuel cell power source described below, a wave powered source, or any convenient source of power. The redundant source of power preferably comprises batteries, capacitors, or some form of highly reliable power source that is capable of powering the buoy through at least a portion of the night should the other source of power fail. Furthermore, a separate redundant source of power is preferably provided for operating the sensors and communications of the buoy, wherein maintenance personnel can keep in contact with the buoy for an extended period of time despite a failure in the main power system. Power is routed from power source 56 to a power controller 60, which regulates power to the control systems, and provides power control under the direction of the microcontroller for lights, audio generators, along with actuators and other electromechanical devices.

A control and communication system are shown to the power source and rotating beacon assembly, comprising a microcontroller 62 (although other forms of device control may be utilized, such as custom ASICs, PLAs, gate arrays, and so forth). Program memory, data memory, and peripheral devices for microcontroller 62 are considered part of microcontroller 62 and are not shown In a simple configuration, a compass 64 and tilt sensor 66 are coupled to the microcontroller 62. Compass 64 may comprise an inexpensive solid state compass, or a redundant group of compasses providing fault tolerance (i.e. a voting scheme). The tilt sensor may comprise an electromechanical unit, an electronic tilt sensor, an accelerometer in at least two axis, or similar device capable of sensing platform tilting.

These sensors indicate the compass orientation of the buoy along with the tilt of the buoy platform in response to wind and waves. Programming which executes on microcontroller 62 utilizes the compass direction and tilt information to correct the motion of the light beacon and optionally the audio generator to retain a generally horizontal path spanning the desired range of compass headings. For example, as the housing 14 tilts to the left in the figure, actuator 24 is extended raising coupling 22 to lower the other end of mirror 18, wherein beacon 12 is retained in the horizontal plane. Similarly the motion of motor 26, preferably a stepper motor, can be modulated in response to compass heading changes wherein the output direction, or direction scanning is performed without buoy motion induced fluctuations.

It is preferable that the programming for microcontroller 62 include heuristics, or neural equivalents, for estimating platform motion. Estimating motion for a fairly massive platform is relatively easy considering the inertia of the system. The estimates need not be completely accurate, such as compensating for wind gusts, yet they can tighten the feedback loop so that light and audio output can more readily track the changing conditions.

The buoy system can be programmed for any desired pattern of light disbursal, which may take the form of a polar map wherein the signals to be generated are in response to the compass direction of light being generated. For example the light may be shut off toward shore, angled off the water in a bay area, or otherwise controlled to meet the local conditions. The laser beams, although generally low in power, may be diffused if desired to reduce the intensity of any direct light.

1.4 External Control of Buoy System.

A programming interface 68 with input connector 70 is shown connected to microcontroller 62, wherein the operational parameters of the buoy, or its control programming may be altered by authorized personnel. By way of example, interface 68 and connector 70 may be configured as a USB interface allowing a maintenance person to connect a PDA (or similar computer equipped device) with an interface or preloaded programming to set the programming or operational parameters for the buoy system. It should be appreciated that a PDA, or similar, may be utilized as a convenient user interface to the buoy control system which allows both changing the operation of the buoy and for performing regular maintenance on the system. For example, operational data may be downloaded from the system, such as voltage profiles generated by the power source, loading on the various actuators (i.e. based on actuation current profiles which indicate need for lubrication, maintenance, or replacement), and other aspects of the system. The interface may be configured to allow personnel to connect wirelessly to the buoy, however, a wired connection is typically more secure and it is contemplated that service personnel should regularly inspect the buoy system physically and not be completely reliant on internally detected operating information from the buoy system.

An optional user interface 71 is shown (preferably locked within an access panel) allowing users to control aspects of the system without the need of external equipment, such as the PDA.

1.5 Optional I/O on Buoy System.

1.5.1 Directional Audio Beacon.

A number of optional inputs and outputs may be integrated within the buoy system for increasing utility. An audio beacon module 72 is shown for controlling audio outputs 40 and 42. Sounds, or voiced audio (i.e. spoken data), may be generated from microcontroller 62, or within the audio beacon module 72 subject to microcontroller control inputs. Audio beacon module preferably controls the proper phasing of multiple ultrasonic transducers to create the desired sound pattern at the desired location. In one example the microcontroller may pass a desired audio signal (preferably as digital data) along with direction and distance information, wherein the audio beacon controller encodes the audio information into the requisite number of output streams and controls the orientation of the audio annunciator, if adjustable, to provide the desired audio output.

The sound being generated in this instance could include a voiced direction indication which indicates the angular direction from the buoy that the sound is being generated. This voiced indication mode may be activated by microcontroller 62 in response to sensing fog conditions, such as detecting a high level of reflected energy from the air surrounding the laser beacon. Alternately, or additionally, this audio mode may be activated in response to object detection by remote detection system 92 (i.e. RADAR) detection of ships within hearing range of the buoy.

For example audio may be generated at a compass heading in relation to the buoy to passing ships, such as “one two zero”, “one three zero”, “buoy 155 is due east”, “Sound point buoy is northeast of your position” and so forth wherein the audio for the given angle is generated every ten degrees along the seaward directions. It will be appreciated that this would be far preferably than a fog horn in that position information could be readily obtained.

Furthermore, the technique can be used to generate sounds that can allow a small boat or ship to navigate toward a point from the ocean without seeing the locations. For instance locating a beacon at a mooring station within a small cove. The beacon can be set to mark the preferred channel for incoming, and/or outgoing ships. For example the boat can travel somewhat perpendicular to the direction of the channel until the appropriate audio channel marker is heard, which may then be followed right into the mooring. As a boat moves with somewhat perpendicularly to the channel toward the center of it they could hear sequentially “twenty degrees south of channel”, . . . “ten degrees south of channel”, “incoming channel”, at which time they would preferably turn toward the channel and they could continue listening to maintain themselves along the “incoming channel”—hearing anything else would be indicative that they are off the channel. If they continued forward and had not turned in the sounds would have continued “channel center”, . . . “outgoing channel”, “ten degrees north of channel”, twenty degrees north of channel” and so forth. It will be recognized that two parallel units could be configured which split the channel so that the incoming channel and outgoing channel audio are retained in a parallel non-convergent path, however, this should generally not be necessary, as inner marker buoys may be provided to separate the sides of the channel closer in.

This directional audio may be generated using ultrasonics transducers set in the range of approximately 100 kHz, wherein the desired audio is encoded as the difference in frequency between two ultrasonic outputs whose sounds overlap at a desired location and distance. The beat frequency between the generated ultrasonics being a sound within the human hearing range and localized to the confluence of the two directional ultrasonic beams. It will be appreciated that this directional audio may be extended to provide directed sound any desired angular range with audio messages or sounds that may be generated in response to the direction that the audio is directed.

One preferred embodiment does away with the conventional fog-horn of a buoy system and utilizes instead multiple ultrasonic transducers which are directed out toward the body of water, wherein sound is not directed back over the land where it poses a nuisance.

1.5.2 Buoy Status and Ambient Conditions.

An additional set of optional inputs and outputs 74 is shown with a sensor package 76 comprising buoy status and weather related sensors. The buoy status sensors preferably include sensors for registering a variety of operational characteristics of the buoy system, in particular those which indicate the need for repair or maintenance. For example, collecting statistics on battery voltage, charge current, power consumption of electromechanical elements (such as activators—it will be appreciated that binding within actuators increases current draw, wherein the need to lubricate or clean a mechanism may be determined in response to the changes in the current draw during operation). The transparency of the lens may be determined by measuring the amount of optical energy which is reflected back off of the lens into the housing from the lasers—wherein the need to clean these can be determined. Other forms of status sensors may be provided without departing from the teachings of the present invention.

By way of example, the weather condition related sensor may comprise: a temperature sensor, fog distance and/or intensity sensor, relative humidity sensor, wind speed and direction sensor, wave activity, tide activity sensor, sky obscuration sensor (i.e. using an optical sensor such as a laser transmitter and optical reflection sensor—which may be incorporated within the beacon), and sunlight intensity. It will be appreciated that other forms of sensors may be integrated for reading by microcontroller 62. These sensors allow the buoy to alter its operation based on weather conditions, and when the buoy incorporates means of communication, such as a radio-frequency link, the data may be communicated remotely to provide updates on the weather conditions at the buoy location.

Local inputs and outputs are shown with an audio input interface 78 connecting to microphone 80. Audio at the site of the buoy may be collected based control from the microcontroller, or in response to a VOX mechanism (voice activated switching) or a push-to-talk (PTT) input 82. It will be at the appreciated that the buoy may serve as an emergency communication point, wherein parties in distress can contact the Coast Guard or other party monitoring the buoy system. For example, programming on the microcontroller, or the audio input system, can be configured to detect speech and to communicate that speech over a communication link to a remote location. A push-to-talk system although less sophisticated allows persons at the buoy itself to contact remote parties.

This audio input system may be configured to perform a number of functions, such as registering activity near the buoy, such as passing boat traffic. Homeland security may be facilitated by providing sufficient monitoring of waterways for suspicious traffic.

Similarly, an local audio output system 84 in conjunction with an audio annunciator (i.e. speaker) can be utilized to allow the buoy system, or a remotely connected party or automated system, to communicated with a party nearby the buoy, for example a party in distress. In this way the party can be comforted and give direction while help is on the way. Preferably an image control system 88 and camera system 90 is preferably included having at least pan control, and optionally tilt and zoom control, allowing remote personnel to view activity at the location of the buoy. Furthermore, weather data and images from the buoy may be used to update a coastal weather web site, or similar to allow parties to see the conditions first hand. The camera may be mounted within housing 14 so that panning may be accomplished using the rotating housing, and images could be collected as reflected from mirror 18 through lens 50 wherein tilting is easily accomplished. It is preferably that a separate camera control be utilized such as a muscle wire based actuator as described as a system for “controlling articulated elements” in provisional patent application serial No. 60/394,160 filed Jul. 1, 2002 and a subsequent regular application Ser. No. ______ filed Jul. 1, 2003 which is incorporated herein by reference.

The camera, and/or audio pickup system which is preferably incorporated within the buoy system, collects local information which can be up linked continuously, when desired, or in response to conditions at the buoy (such as a nearby object detected, or the microphone triggered). The camera is preferably equipped with a positioning system, so that it may be used to scan or otherwise be directed at any desired polar direction and angle. The camera may be controlled automatically by the system following a scan pattern, controlled remotely when desired, or combinations thereof. Inclusion of digital signal processing software within the system allows it to operate autonomously wherein it can collect and analyze data looking for particular patterns, which upon being found can be used to trigger the unit to alert a central communication facility for dealing with the situation. This mode may be particularly useful for monitoring an area for drug trafficking, wherein information from a radar and/or the camera may be analyzed (preferably at least partially at the buoy to reduce communication bandwidth) for suspicious activity. The information may then be relayed to a central station, wherein the Coast Guard personnel could then direct the actions of the buoy to collect additional information and take actions as necessary such as dispatching a boat or helicopter to intercept.

Additionally, data may be preferably transmitted from a central station via a communications link to the buoy which contains audio that may be annunciated by a small speaker for communicated with someone that has activated the microphone, or over a high powered speaker system, preferably a directional one, that allows the remote location to hail parties, generate audible warnings, and so forth to persons within a few hundred yards of the buoy.

1.6 Remote Communication Link.

It is preferable that the buoy system be configured with a wireless communication system, such as a radio-frequency transceiver 92 with antenna 94. If programming on the microcontroller is configured to allow the buoy system to be controlled over the wireless communication medium, then it is preferred that the communications be secure using generally conventional means. For example, the communication may be encrypted and require a user logon process prior to sending commands to the buoy. The communication system allows the conditions at the buoy to be monitored, including the detection of distress or other conditions, as well as the status of the buoy system itself. Status information may be periodically communicated over the RF link, or in response to detected events at the buoy, or in response to external control input received over the RF link, or communication received through other interfaces 68, 71.

1.7 Remote Object Detection.

A RADAR, LIDAR, or similar system 96 may be incorporated within the buoy system if it is important to detect the movement of ships, vehicles on nearby land, or even aircraft flying nearby the buoy system. It will be appreciated that ultra high frequency RF RADARs, or optical forms of detection, are known in the art which may be utilized for transmitting a coded beam and recording reflections of the signal for detecting distant objects. Housing 14 of the unit may be adapted for retaining a remote sensor, wherein the rotation and tilt controls can allow directing the radio or optical beam and the registration of the response. Furthermore, the laser beacon itself when coupled to optical detectors may be utilized as a crude form of proximity detection, by detecting the reflected light from objects at sea that matches the modulation pattern emitted by the beams. Additional light sources may be utilized within the lasers, such as infrared or ultraviolet source, that when coupled with appropriate detectors increase the reflected data available from which to discern objects. To increase the recognition of this energy the laser beams may be modulated at a very high frequency, wherein the amount of reflection from that signal, such as from an approaching ship may be measured. The lasers may also be modulated at the slow speeds described above for visual recognition, and text display.

1.8 Large Area Display (LAD).

Status of the buoy system may be communicated visually, by utilizing an inexpensive large area display (LAD) 98, such as a electronic ink sandwiched between programming electrodes. For example, status conditions such as all systems operational “OK”, power system fault “P”, sensor fault “S”, need for maintenance “M” and so forth may be indicated by a letter, indicia, block symbol, and so forth that is displayed when the condition is detected. In this way status of the buoy may be detected simply by viewing it without the need for special equipment. It should be appreciated that an electronic ink panel spanning about two square feet can be produced for about five to ten dollars. One or more LADs may be connected on surfaces of the buoy to convey any desired information, including measured conditions and so forth. The electronic ink can also be configured to cover a portion of the buoy such as a ring of electronic ink between electrodes, for instance 12 inches in height, that covers a circular portion of the buoy, wherein characters displayed therefrom could be seen from any angle using binoculars for up to a mile away. In this way personnel could check on the status of simpler buoys (sound alertive, or beacon buoys) without the need to physically inspect each one.

1.9 Buoy System Monitor.

To increase the reliability of the buoy control systems a separate monitor circuit 100 may be coupled to a portion of the inputs and outputs from controller 62, wherein the operation of the control system is checked by monitor 100 for detecting faulty operations or failure to operate. Monitor circuit 100 is preferably a microcontroller circuit that is configured with programming which can check the relationship between inputs and outputs by controller 62, and which can communicate with the controller for running diagnostics and similar checking functions. Preferably monitor circuit 100 is configured with programming for controlling the communication devices on the buoy 10, wherein faulty operation of controller 62 may be reported by monitor 100, such as by the LAD 98 and remote communication link 92, wherein problems with the buoy may be readily reported. Monitor 100 can also provide fail safe control of aspects of buoy operations, such as shutting down the laser beam system in the case that controller 62 is misdirecting the output or not properly scanning the laser beam over a range of areas, or for controlling power supply related functions.

Furthermore, monitor 100 is preferably configured to shut down the external communication from controller 62 in response to detected errors, in this way problems with controller 62 can not tie up the communication channel.

Programming within controller 62 is configured to periodically check the operation of monitor 100, so that the monitor itself can be prevented from disrupting buoy system operation.

2.0 Buoy Power System.

2.1 Introduction to Buoy Power System.

Power to a buoy system, such as described above, may be provided in a number of alternative ways. Current power systems, however, suffer from a umber of drawbacks, such as low power availability and high maintenance. The resent invention therefore describes economical, efficient, and robust systems and methods of powering floating buoys.

Floating buoys are often used for lighting, audio warnings (fog horns), and as described above may be utilized for data collection and dissemination, such as measurements (waves, temperatures, humidity, wind, etc.), collecting sound and/or image data, as well as providing security and monitoring services.

However, the current methods of powering buoys have a number of shortcomings. For instance, insufficient power may be available for the intended operations of the buoy, such as for a lighted buoy. In addition, the use of solar power can be problematic in that a large surface area is required, which must be positioned facing upwardly to collect the light energy, wherein an accumulation of water deposits, dirt, bird droppings, and such can hamper the energy collection capabilities and require periodic cleaning.

2.2 Wave-motion Power Generation.

One aspect of the present embodiment of the buoy system, is the conversion of the rocking motion of the buoy platform caused by wave action to generate power for charging the battery. This power source is preferably utilized in conjunction other power systems, such as a solar cell power system, wherein power is generated under clear daylight conditions with the solar cells and under overcast and/or stormy conditions (day or night) using the wave power generator. An advantage of having two power systems is that it can be assured that the buoy will continue to provide signaling and/or data collection despite the conditions as the energy storage system (battery or capacitor) will not be depleted.

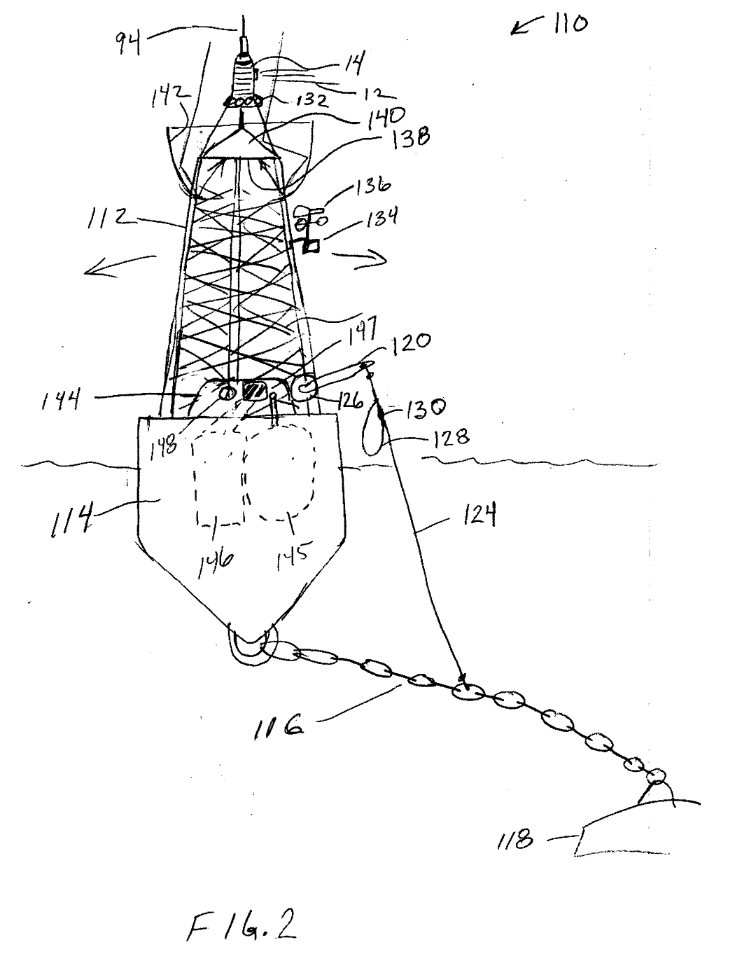

FIG. 2 depicts a buoy 110 with superstructure 112 and floating base 114, connected on a buoy retention cable 116 to a anchor 118 on the floor of a body of water.

A lever arm 120 on generator 122 is shown connected to retention cable 116 (anchor 118, or other point to which base 114 is subject to relative motion) through an elongated member 124, such as a cable, chain, or other durable elongated tensioning member. It will be appreciated that the housing of generator 122 may be mounted to the buoy in a swiveling arrangement wherein it automatically swivels in response to any rotation of the buoy. In buoys having dispersed anchoring (i.e. two anchoring chains attached at separate locations on the base) the swiveling may not be desired. Elongated member 124 connecting from the lever arm need not be to the retention chain/cable and may be connected to some fixed point, such as another anchor location that is physically separated a distance from the connection of the buoy retention chain/cable. It should be noted that the rocking movement of the buoy will induce movement in the lever arm for even short distance displacements. Furthermore, the tensioning on elongated member 124 provides a stabilizing force to dampen the motion of buoy 110.

The connection of lever arm 120 may include tensioning members which absorb excess movement to reduce strain on the lever arm. For example, a tensioned loop 128 is shown wherein two points along the cable (i.e. spaced apart by approximately 1-2 feet) are drawn together using a spring or similar biasing member 130. Under normal loads the lever arm moves in response to the buoy motion, under very high loading (i.e. a strong storm), the lever arm may extend to the end of its travel wherein the force on the cable increases above the bias force of the biasing member 130 wherein it stretches deploying additional cable so that the force applied to the cable and lever arm is kept within operational limits to reduce the chance of damage.

Another method of tensioning the cable which may find application within installations wherein maintaining tension on the lever arm would be otherwise difficult, such as due to a combination of buoy retention chain/cable positioning and the local tides. The lever arm may be fitted with a tensioning member that applies a retraction bias force to a take-up spool to maintain a given cable tension. The bias spool being configured like a seat belt mechanism wherein a tug on the cable causes the spool to latch allowing the force to be transferred to the lever arm for actuation. The bias spool is configured with an overload device, wherein tension exceeding a given threshold releases the spool temporarily to allow more cable to be extended. An arrangement such as this allows for wide variation in the installation and conditions under which the power system may be operated.

2.3 Beacon Mounting.

A light beacon housing 14, emitted directed light beacon 12, such as shown in FIG. 1, is depicted atop superstructure 112. An optional audio output system 132 is shown with a ring of audio annunciators that allow audio to be simultaneous directed in any direction. These audio annunciators, may comprise ultrasonic devices wherein the beat frequency output between adjacent or complementary pairs is configured for being heard selectively at a given direction from the buoy. The audio output for example may simultaneously provide direction information to locations on the ocean (preferably sounds not directed toward land) indicating relative position to or from the buoy. The audio output in this mode may be activated in response to conditions such as inclimate weather (i.e. fog) and/or the proximity of boats or ships in the vicinity. A communication antenna 94 is also shown attached over beacon housing 14. Furthermore, an ambient condition sensor package 134 is shown with a wind speed and direction sensing mechanism 136 as described in relation to FIG. 1.

2.4 Enhanced Solar Power Generation.

The figure also depicts a solar collection arrangement that increases the energy output of a solar collector panel while reducing cleaning needs. A solar collector 138 is depicted mounted in an inverted arrangement within super structure 112. A conical reflector 140 above solar panel in combination with a reflecting ring 142 allows light to be directed over a large area and directed onto solar collector 138. Example light rays L are shown bouncing from the circular reflector 142 up to solar collector 138, and off of the conical reflector 140 in combination with circular reflector 142 to solar collector 138. The solar panel itself in this embodiment subjected to less obscuration from dirt, bird droppings and so forth. In addition the reflector panels are more sturdy than solar collector 138 which is protected within the shroud and less subject to damage and vandalism. The reflectors additionally operate to concentrate the light and thereby increase the efficiency and power output of the solar collector. The top surface of the solar panel may then be configured so that debris does not collect.

2.5 Details of Wave Powered Generation.

Lever arm 120 is connected to generator 126 which preferably comprises a transmission/generator housed on the upper superstructure 112 of the buoy the rocking of the buoy in the waves causes the lever arm to be repeatedly pulled down which operates the generator with each stroke.

Although it may be implemented in a number of ways, the generator is preferably connected via a transmission wherein the slow powerful motion of the lever arm 120 is converted to rapid rotation of the generator which at high RPM can efficiently generated electrical power.

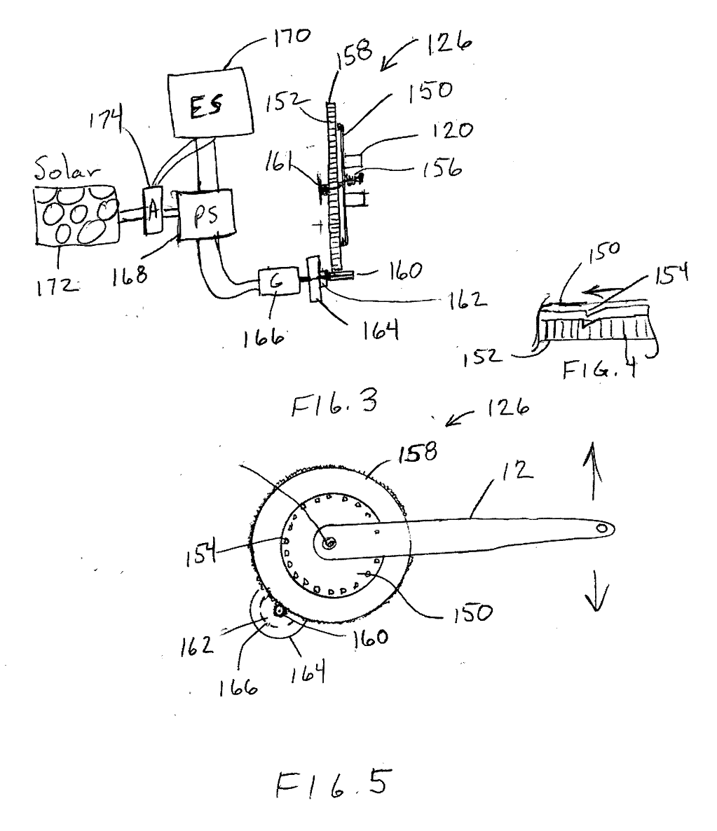

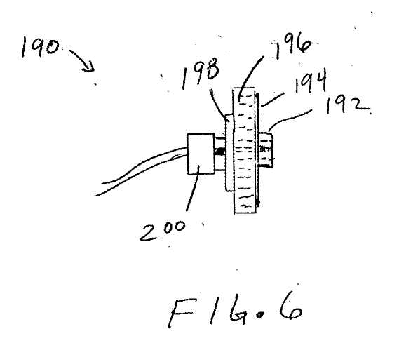

FIG. 3, FIG. 4, and FIG. 5 depict an embodiment of generator 126 with input from lever arm 120. A ratcheting engagement plate 150 within the housing connects to lever arm 120, wherein the lever arm can return to a first position under a biasing force when the movement of the buoy relieves the tension on the connection to the lever arm. Movement of the engagement plate 150 is coupled to the main gear 152 by means of engagement teeth 154, one of which is shown in FIG. 4. Engagement plate 150 is biased toward a main gear (sprocket) 152, such as by spring 156. Back and forth rotation of engagement plate 150 causes main gear 152 to move in a single direction, wherein the gear teeth 158 on main gear 152 pivoting through shaft 161 drive pinion gear 160 through clutch coupler 162 to flywheel 164 driving generator 166. The engagement plate or main gear may connect through any desired form of transmission, gearing, mechanism prior to the energy being coupled to a generator. Each stroke of the lever causes the generator to spin perhaps many hundreds of turns.

Flywheel 164 is preferably attached to generator 166 through clutch coupler 162, wherein the torque supplied by the motion of the lever arm and geared through the gearbox operates to “spin up” the flywheel to keep the generator spinning, although its speed may fluctuate. Clutch coupler 162 applies the input rotation to flywheel 164 without limiting the speed of flywheel 164 to that of the input rotation. This may be performed with a centrifugal clutching arrangement wherein sufficient speed is necessary at the input shaft prior to the energy being coupled to the flywheel. Preferably, the coupling also is configured with a mechanical energy absorber wherein energy can be transferred more smoothly to the flywheel.

Generator 166 is driven through the gearing, with optional flywheel and generates a voltage output that is regulated by a power supply 168 which is preferably a switching form of supply the converts any output voltage from the generator to a fixed power output for storage within the energy storage system 170, such as batteries, capacitors, or similar storage devices. A set of solar cells or panels 172 is shown connected to the power supply through an auxiliary controller 174.

It is preferred that the power system be configured so that should either power input device fail the other system can still provide energy for retaining energy within the energy storage system until the unit may be serviced. They are shown with a power supply which normally handles all power, however, in the event of a failure in that power supply, the auxiliary power converter can route the power form the solar panel to the energy storage device.

FIG. 6 illustrates an example of an embodiment of the generator 190 aspect of the present invention, in which a mechanical energy storage assembly is interposed between the lever arm and the generator. A lever arm 192 is shown on edge connecting to a drive plate 194 that drives an energy storage device in the spring housing 196 whose output is coupled to tension clutch 198 connected to generator 200.

In the present example the motion of the lever arm winds a spiral-coiled spring, however, other forms of mechanical energy storage may be utilized wherein energy is stored until sufficient is stored to provide efficient conversion by means of the generator, or similar energy conversion device. At a predetermined number of turns, or when the spring reaches a given coil pressure, then the energy from the spring is released by clutch 198 to drive the generator, preferably through a gearbox. This system would allow for increasing the efficiency of a generator that operates intermittently, when compared to the system described above without the flywheel. It is contemplated that the conditions and applications may warrant the deployment of both forms of systems.

2.5 Fuel Cell Buoy Power.

The buoy may be provided with a fuel cell 144 in FIG. 2 for generating buoy power. Preferably the fuel cell is safely bolted within a locked steel housing, such as within the base 114 of buoy 110. A fuel tank 145 and conversion grids 146 are secured within the base 114 of buoy 110 and provided with an air intake and a water outlet 147. A hatch 148 provides access to a mechanical fuel gauge and a fuel filler location. Optionally the output from the fuel cell may be directed to a containment reservoir, although many fuel cells generate environmentally safe by products. The system is preferably configured with an electronic fuel sensor, wherein the fuel levels within the buoy can be transmitted over the communications link to remote locations, for monitoring.

The control system is configured to automatically generate a low fuel condition, or to indicate other conditions that warrant maintenance or repair of the power system

As fuels cells can be expensive and in demand, integrating the fuel cell within the sturdy structure of the buoy, such as constructed from steel of up to ¼ inch thick, which protects it from vandalism. It will be appreciated that no lack of storage space exists, and the unit may be configured to supply power to the buoy for a year or perhaps more, depending largely on the stability of the fuel mixture being utilized, and the maintenance needs of the fuel cell (i.e. cleaning of intake filter, replacing grids, metal catalyst electrodes and so forth).

3.0 Shipboard Propeller Synchronization System.

3.1 Shipboard Vibration Problems Due to Synch Loss.

Large ships such as cruise ships still suffer from vibrations that result from temporary mismatches in the speed of the various engines driving the propellers (screws). These vibrations can occur every few seconds or more, depending on the conditions of the water, such as pressure gradients, bubbles, materials present and so forth. Out of synch conditions cause vibrations and shuddering which can be felt throughout the ship.

3.2 Summary of Shipboard Vibration Reduction System.

A system of the present invention provides full damping, to reduce vibrations in large ships that results from temporary synch problems induced by pressure fluctuations, and other water flow conditions as they reach the propellers of the ship. It should be appreciated that the technique may be less preferably applied to any device over which fluid flow is directed by propellers.

The present system can generally be described as an apparatus for preventing loss of synchronization on a vehicle driven by multiple propellers through a fluid, comprising: (a) means for sensing fluid motion along the hull of said vehicle proceeding toward the propellers; (b) means for estimating fluid motion conditions that will occur at said propellers in response to pressure gradient measurements; and (c) means for rapidly altering the rotational speed of the propellers based on said fluid motion estimation to maintain synchronization between propellers.

In addition the sensors may register pressure fluctuations in the fluid depending on the application, to provide an improved prediction on the effects of the developing moving fluid patterns as they reach the propeller.

Another aspect of the present invention is a method and system for rapidly changing the rotational speed of a propeller, which is particularly well suited for use on ships. It will be appreciated that conventional throttle controls for an engine are slow to respond, thereby making compensation for dynamic fluid conditions somewhat impractical. The present invention couples a generator (alternator, or similar) as a load onto each engine to be controlled. Necessary electrical energy is produced from the generator, and varying the field currents in the generator result in a rapid change in the load placed upon the engine. In this way propeller speed may be maintained very accurately even in highly dynamic conditions.

3.3 Detailed Embodiments of Synchronization System.

Running sensors along hull that sense fluid motion, along with any other parameters such as pressure gradients, amount of entrained air, temperature, composition of the water, and so forth. Additionally, static sensors for ambient conditions can condition the system for properly performing the estimates despite the conditions that exist. For example sensor for registering weather conditions, wind, wave heights and composition, wave profiles over which the ship is passing, and so forth. Use of one or more of these additional metrics can enhance the estimation process to improve synchronization accuracy.

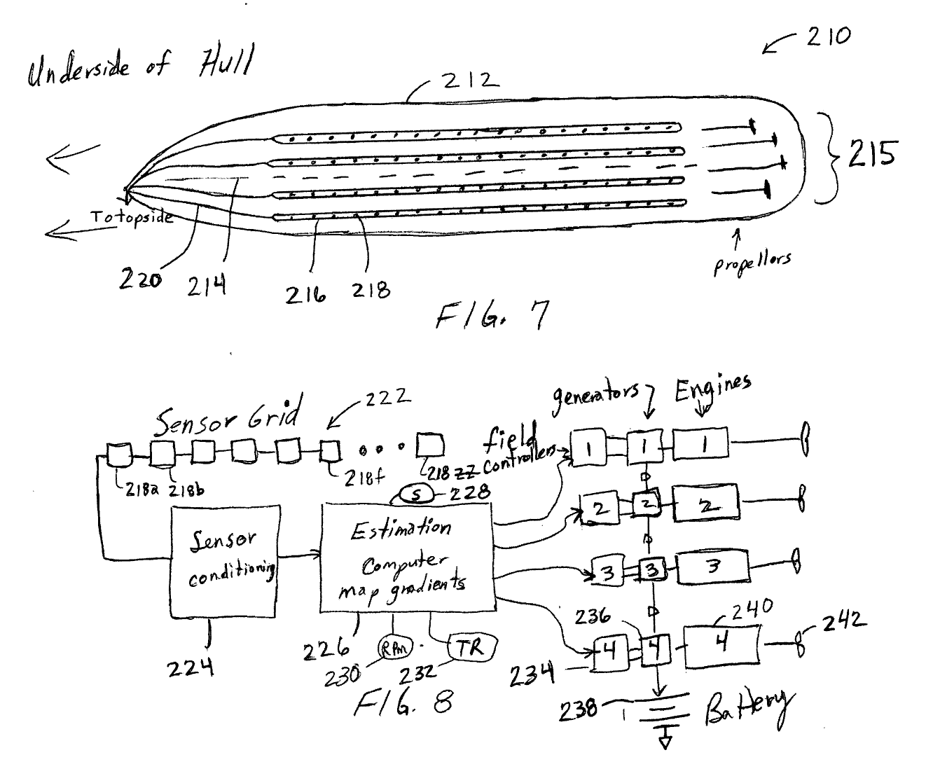

FIG. 7 depicts the underside of a ship 210 having a hull 212 with centerline 214 and multiple propellers 215, four propellers being shown in a staggered configuration. Sensor strips 216 are shown attached to the underside of the hull with individual sensor positions 218 (non-discrete, distributed, sensor forms may be utilized). It will be appreciated that the sensors may be positioned on the underside of the ship in layouts other than a “strip” without departing from the teachings herein. Sufficient sensors are distributed in a pattern on the underside of the hull so that a sufficiently accurate mapping of the temporal water conditions may be mapped to allow for accurate propeller (screw) speed adjustments.

Wiring 218 is connected to each sensor strip 216 which is routed forward of the strips and connected at the top side of the ship. Wiring 218 preferably includes a Kevlar™ or other form of support cable wherein a sensor strip is prevented from being lost or fouling the propellers should it work loose from the bottom of the ship. If sensor strips 216 are totally secure then there is no need for these additional safety measures.

Additional circuits or material may be included within the sensor strips to reduce various growths and accumulation from occurring at the bottom of the hull, for example directing AC voltage profiles, currents, ultrasonics, and the like which have been known to reduce necessary maintenance.

The sensors may comprise any convenient fluid motion sensor, such as implemented with MEMs technology. Alternatively other forms of sensors may be utilized from which fluid motion profiles may be determined, for example, pressure and fluid velocity sensors. These other sensor types may also be utilized in conjunction with the fluid flow sensors to improve estimations.

FIG. 8 depicts a block diagram of the synchronization system with data from sensors 218a-218zz on a sensor grid 222. Signals from sensors 218a-218zz are received by conditioning circuitry 224 which prepares the signals for use in the estimation process. Preparation depends on the type of processing being performed. By way of example preparation may include frequency filtering, normalization, linearization, error correction, weighting, scaling, conversion (i.e. to digital or to a specific format). The fluid flow information from the sensors then passes to a signal processor 226, or neural network, that estimates the forces that will be applied by the moving fluid at time displacement td as the fluid reaches the propellers. It will be appreciated that estimation of wave fronts and fluid motion dynamics in general are known in the art. For example, fluid flow problems with regard to control system design are well documented for high performance aircraft design.

Estimation thereby provides information that may be utilized to begin compensating for the fluid flow before the fluid flow motions begin altering the relative propeller speeds. Estimation circuits, processors, or neural nets, thereby determine the load that each screw will be subjected to, generally based on forward looking motion estimates. In either case the model is calibrated and refined under actual conditions to hone its estimation prowess.

A dynamic model is created within the estimator of the patterns from which data as to forces on the propeller at a give future time are determined. From these estimates signals are generated for modulating propeller speed in compensating for the pressure changes.

Estimator 226 is configured to take other parameters into account, such as vehicle speed 228, the RPM of each propeller 230, turn rate 232 of the ship (or other vehicle). Furthermore, the estimator takes into account the dynamics of the mechanism utilized for speed compensation of the propellers, for instance the delay profiles, and the signal change to response profiles. In this way the estimator can generate signals tuned to the specific vehicle to optimize synchronization. The operation of the estimator can be improved following neural net learning patterns or the storage of learned parameters in a digital pattern recognition system, wherein the estimates produced are compared with results based on the RPM measurements of the propellers, the vibration profiles generated from the propellers, and other metrics indicative of the effectiveness of the synchronization. Additionally, estimates mapped over the sensor grid can provide some estimate correction, in particular if estimates based on data from sensors mounted toward the bow is checked against actual measured sensor data on sensors near the aft of the ship.

Corrective signals based on the estimates are coupled to an engine/transmission speed control device which allows modulating propeller speed based on the estimates. These devices may be implemented by any convenient means, such as drag induction, throttling, spark timing changes (on piston engines), and so forth. For example, if a fully variable ratio transmission is used this may be changed to alter speed or a load imposed on the engine may be varied to adjust the speed of the screws. However, such a system often lacks efficiency and cost effectiveness.

The present invention appreciates that “throttling” an engine to change speed is often a slow process, requiring estimates to be produced too far in advance. A speed control mechanism is described that provides a rapid means of changing engine speed while providing additional advantages.

The present invention couples a variable load to the engines, such as a generator, the force required of the load can be varied rapidly in response to signals generated from the fluid flow estimates. Preferably one generator is coupled to each engine, or transmission, to allow independent variation of speed. The generators provide a source of redundant power generation, and a means for quickly varying propeller speed. It will be appreciated that changing the field current in a generator system increases the amount of load represented by the generator and it electrical power output.

The current in the field winding controls the resistance that the generator places on the attached engine. Each generator is set for a specific baseline winding current that is varied in response to the estimations of screw load, so that the speed of each screw is modulated to be maintained at the desired speed without the periodic fluctuations and resultant vibrations. Therefore if a low load is estimated for the screw, then the winding current would be increased sufficiently to null (compensate) for the reduced load so that the screw would remain synchronized with the other screws.

Therefore, calculations based on sensor data is used to alter the field currents to compensate for upcoming pressure transitions. The engines are therefore sped up or slowed down rapidly in sych with the oncoming known pressure changes whereby all engines stay synched with one another despite the pressure changes.

Load variance compensation signals from the estimator 226 preemptively alter the screw speeds to adapt for the changing conditions. The signals are generated in response to the load variance expected that will arrive at each screw at a given number of milliseconds in the future. The load variance estimate is then used to alter the load on the screw to compensate for the upcoming load variance caused by the water disturbance.

Load variance signals are shown being sent to a bank of four winding current controllers 234, connected to four generators 236, with one being coupled to each engine 240. The power from each generator is preferably used to power ship systems and it is shown for simplicity as being connected in series to a battery 238, although the multiple power sources would be connected through a power controller before being collected in a bank of batteries or similar energy storage system. These energy storage systems are well known in the art. The system thereby eliminates the vibrations and shudder that can result from changes in water conditions.

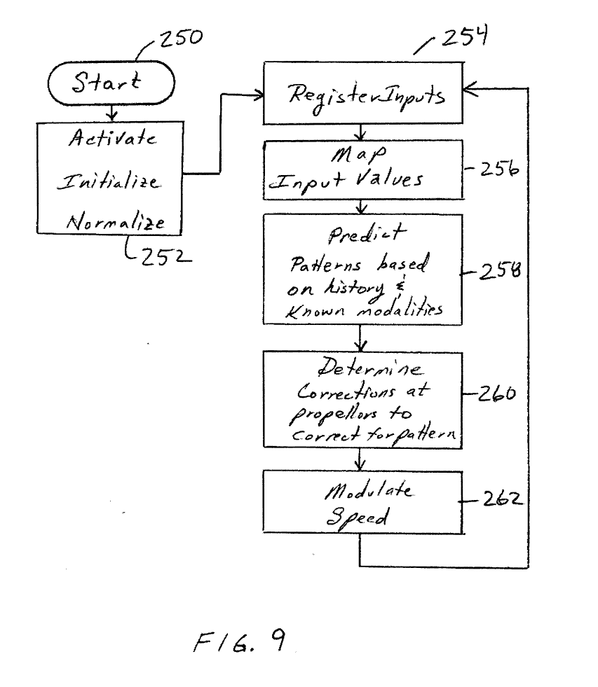

FIG. 9 illustrates an example of signal processing according to the present invention. System is activated as per block 250, assuming it has been trained and with compensation parameters stored in memory. As represented by block 252 the sensor grids and systems are activated, and initialized, with any calibration or normalization parameters being properly loaded for use. The effects of current conditions such as water temperature, water conditions, weather conditions and so forth may be registered to determine what parameter to load.

The generation of load compensation signal from the sensor data is represented as a programming loop for the sake of simplicity, however, it will be recognized by a programmer of skill in the art that the structure and operations of the associated programming may be configured in a number of alternative ways.

Inputs are registered at block 254 and corrected. These inputs are mapped by location at block 256, wherein flow motions can be discerned. Prediction at block 238 is performed by modeling the historical changes in flow over the surface and taking into account what is known about flow conditions over the this particular hull surface. The predictions preferably extend the patterns detected from historical data into the near future. The prediction phase preferably still generates map formatted data.

Corrections are determined at block 260, such as generating load compensation signals for modifying propeller speed. These corrections are determined based on reading the map estimates and determining what compensation is necessary at the propellers at a given time to minimize synchronization errors, as evidenced by vibration and such.

Load compensation signals are received in a speed controller which begins to modulate propeller speed as per block 262 sufficiently in advance of the fluid flow conditions which make that change necessary to compensate for the delay profile in changing speed.

The above process operates continuously to produce an output signal that keeps the propellers operating synchronously.

The estimation system can be automatically switched off in conditions that are not readily estimated, such as during docking.

The load estimation system may utilize a variety of sensors such as laser sensors such as Lidar and so forth for performing the necessary estimates.

4.0 Clock Synchronization within Ships and Institutional Settings.

4.1 Introduction.

It is often difficult to maintain synchronization between clocks or other devices within a ship (i.e. cruise ship) or other institutional setting. This can pose a particular problem when activities are scheduled based on the clock.

The present invention retains all clocks, electronics that include clocks, and electronics based on clocks, within a ship or institutional setting with a controlled source of power at the correct time.

Particularly well suited for use on large cruise ships, or other institutions whose power is received from a local generator, or otherwise controlled by a local power control facility.

4.2 Description of Embodiments.

The power is modulated according to a specific schedule that is known to the clock based items that connects to the local power grid. One advantage of this approach is that the clock operates normally from the power source, and only the synchronization feature relies upon sensing a selected signal or transient condition. This is an advantage over the use of pulse clocks or similar that rely on receiving pulses to advance the clock each minute or hour.

These items perform internal clock synchronization in response to registering the signal, wherein each of these electronic items is synchronized to the correct time automatically. The signal on the power line should provide short power transitions, such as voltage excursions, phase changes, and so forth following a pattern that may be readily recognized but which could not be confused with power transients and other non-signal lines disturbances.

The devices on the line are configured to register the power line transients and to compare them with a predetermined or selected “signature”, wherein upon a match being made the data that follows is used by the system, for example to reset the time on the clock to a specific time (for example 3 A.M.).

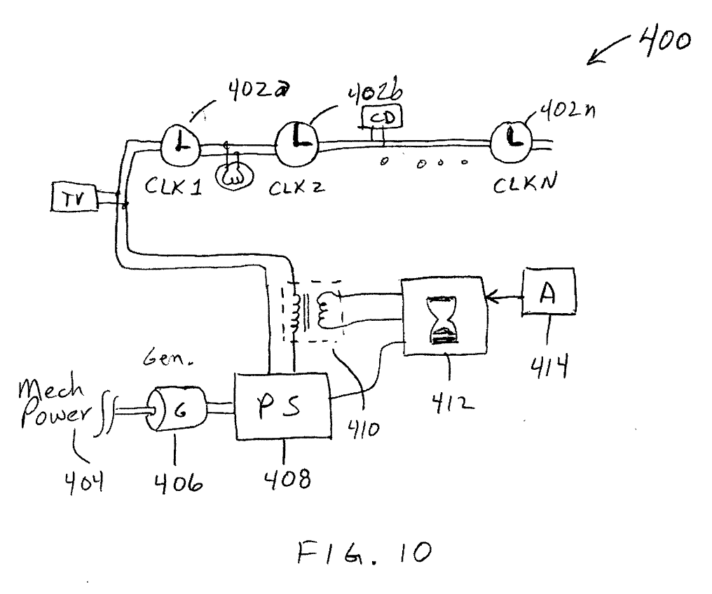

FIG. 10 depicts the system 400 with an arbitrary number of clocks 402a 402n, along with other device such as lights, television sets, and so forth connected to the line from which they draw power.

The power generation system of a ship is shown with mechanical power 404 coupled to a generator 406 and a power control system 408 for driving the AC voltage (or less preferably a DC system). The power supply may be modulated directly or by means of a transfer device, such as the transformer 410 shown for AC power, by a clock synchronization driver 412. The clock synch driver periodically generates a signal which changes the power line voltage as seen by clocks 402a-402n. These clocks have a detector circuit which registers the transition and adjust their own clock settings accordingly. Clock setting may be adjusted by changing the actual displayed time, or more readily by adjusting the counter frequency of the clock, (i.e. adjust preload on a count ladder, or change loading capacitance on a crystal time base), wherein the clock knowing how much ahead or behind of the actual time it is can determine the correction factor to resynch and keep in synch.

The clock synchronization driver 412 is preferably kept at the proper time itself by a calibration module 414, preferably a master clock that receives signals from an atomic based clock.

4.3 Additional Aspects.

The synchronization signals may be generated by a device connected on a power-line control system within a home or business setting, wherein clock synchronization is passed by piggybacking signals over the AC power bus.

Power agencies may adopt the generation of synchronization signals embedded within their power output, wherein devices may make use of these periodic signals to readjust timekeeping.

Additional signal may be sent via the power transients to signal special conditions and events, weather conditions, as well as emergency information. This additional information is to be displayed on devices having a display (preferably for emergency information one that is always active), or generated as audio strings.

The invention can inexpensively provide all cabins, rooms, with the same time reference, wherein comfort in the setting or voyage is increased.

5.0 Flight Forward Comfort Pillow.

5.1 Background.

It is often very difficult for persons on a flight to get comfortable, in particular on a long trip. Many persons find it difficult to stay in a seated position for a long period of time.

5.2 Summary.

The present invention makes it easier to comfortable rest and/or sleep on flights. Presently the individual must attempt to sleep while retaining themselves substantially erect. Which often makes sleep, or at least comfortable sleep difficult. A more comfortable upright position is slumped forward, however, this is not currently possible within commercial airline seating.

The present invention provides the user with an additional sleeping/resting position, wherein they may slump forward into an inflatable pillow positioned on the try table in front of them. This position providing greater comfort as the body need not be maintained erect and is supported at the head by the pillow, and optionally a set of arm rests which are positioned for use with the Flight-Forward Comfort Pillow. The arm rests being preferably padded and adjustable, such a slidable rest pad slidably attached to an adjustable cinch strap.

5.3 Description of Preferred Embodiment.

FIG. 11 depicts a resting situation 500 within an airline. A pillow 502 according to the present invention is shown upon which an individual 504 is resting on seat 506 having backrest 508 and arm rest 510. The tray table 512 on the rear of the seat ahead of passenger 504 is in the down position upon which pillow 502 is supported.

Pillow 502 comprises a face ring 514 attached to a body portion 516. The body portion is formed with a large central cavity providing space for the face of the user to extend with sufficient air space remaining in front of the face. Air vents 518 in the body portion allow air to reach the face of passenger 504. Optionally one or more article holders 520 are joined to the device. An optional hand holder 522 extends from body portion 516 to provide support for the hands and arms of the passenger beneath the level of the tray table. Preferably the hand holder 522 has an adjustable length.

The body portion 516 of the device is preferably inflatable, allowing the unit to be easily stored when not in use. An inflating stem 524 is shown by which the passenger may blow up the device to the desired size. By way of example the horizontal cross section of the device is generally circular with an enlarged non-slip base.

The portion of the pillow where the individual's face rests is preferably covered in a foam material, gel material, conformal cushion, or other compliant materials that are preferably covered in a comfortable cloth material. Preferably at least the outer portion of cloth for the unit can be removed for laundering.

The air vents 518, openings from the interior of body 516 to the exterior, which allow the user to breath without restriction, may be adapted with air filter devices wherein the air reaching the user has been first drawn through the filter structure. Many persons are concerned with inhaling airborne pathogens from the recirculated cabin air, for example cases of tuberculosis and other dangerous diseases have been known to have been picked up during airline flights.

The filter may be a simple filter built into the unit, such as the cloth coverings over the vents, which can provide a similar ability as a cloth surgical mask, or a more complex filter may be employed, such as utilizing a HEPA certified filter. The use of more complex filters may be provided with or without a breathing valve, wherein intake air may take a different path (through the filter) than output air, exhausted into the surrounding air. These are preferably options that the user may select when ordering the device.

Furthermore, a small fan with self contained power source, and a speed control (ON/OFF, or adjustable speed) may be provided within the unit to increase user comfort. The unit may also be provided with ear muff style, or other forms of sound attenuation devices.

The unit may optionally be sold with or have integrated within it a sleep timer device, or software, such as described by the inventor in another application entitled “Externally Controlled Ear Alarm”, which may be separate or used with a PDA, Phone, or similar device.

The body 516 may be manufactured from any convenient air tight material, typically thermoformed plastics as use with a variety of inflatable devices. An inner and outer flexible shell of plastic are preferably joined to form the shape having its interior cavity. The material thickness should be sufficient to provide for long life and have a matte finished exterior to reduce glare for other passengers. The unit may be manufactured in a variety of colors, however, a single conservative neutral color such as tan, or gray should be amenable to most users.

An optional clear holder slot 520 is shown on the exterior of the pillow within which the user may place instructions for the flight attendants, such as “Awaken for meals”, “Do Not Awaken For Meals”, along with any additional instructions, such as for example when to awaken, or what is their final destination. It is preferred that a number of preprinted cards be included with the unit for standard situations. A clock face having an hour hand and minute hand pivoting at the center of the clock face, which are mechanically adjustable may also be included for use in combination with preprinted (or other) messages, such as “Please Awaken at:”.

The underside of the unit may be configured with material, or feet, that reduce slippage between the unit and the top of the tray table. For example, silicon, or other compliant polymeric materials.

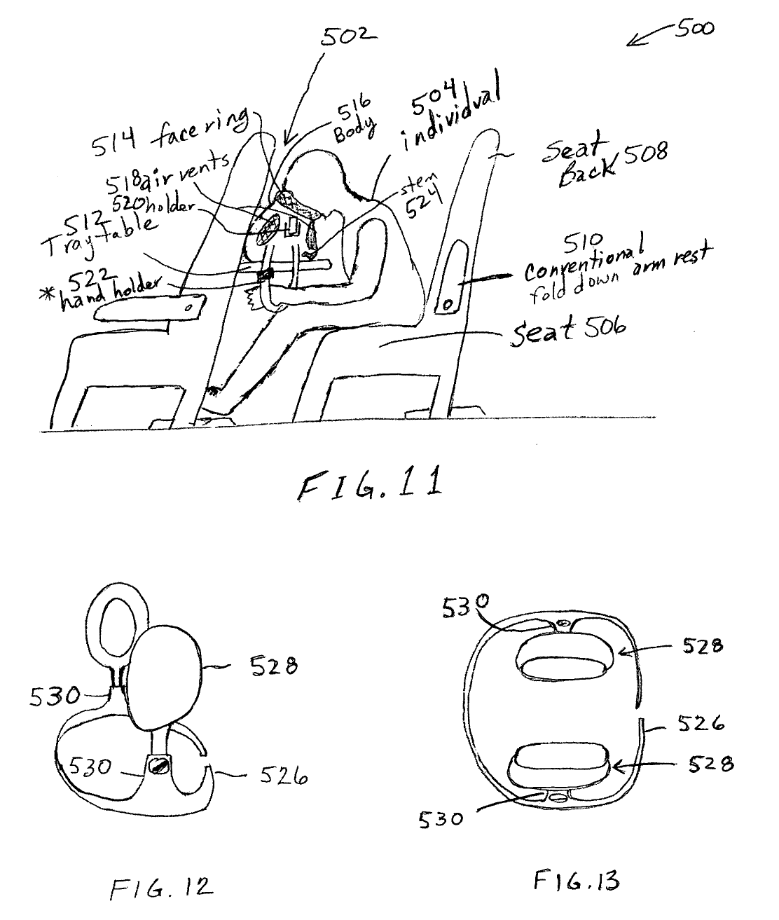

FIG. 12 and FIG. 13 exemplify a set of ear muffs 528 style hearing attenuation devices for use in reducing the cabin sounds. It is preferred that pillow 502 and face ring 514 be configured to allow for the optional attachment of adjustable ear muffs. Shown in the figures are a ring 526 that can be optionally attached between the face ring and the inflatable body of the unit, from which the ear muffs, shown on adjustable stems 530 are attached. It will be appreciated that it is beneficial to provide adjustability as to width between the muffs, and height from the ring, wherein the muffs may be comfortably adjusted for various head sizes and shapes. It should be appreciated that the ear muffs may be attached to the unit using alternative attach mechanisms. Alternatively the earmuffs may be provided as a separate unit, such as modeled after conventional over the head retained headsets, or the more recent behind the ear and back of the head style of headset mounting. Using separate muffs has the advantage that the user may retain them for use in while maintaining an erect position against the chair, or with the flight forward comfort pillow.

6.0 Common Mapping Interface.

6.1 Introduction.

Use of moving map displays is on the rise, in vehicles, in portable GPS units, and other display equipped vehicles. In addition, maps are retrieved for later use from a variety of computer based devices, such as from dedicated map applications having an internal data base, and from network driven applications, such as the internet, in which maps may be retrieved and printed.

A user of these maps has many instances where they must coordinate the map with the modes of transportation, such as between points on the map.

Currently, IF the mode of transport provides a map of routes times, etc. the user is required to run that application, instead of the mapping application of choice.

6.2 Summary.

The present invention provides a general mapping interface wherein data for a given form of transportation may be retrieved without leaving the mapping application of choice. The user can remain in the application with all their information and utilize the extended information as overlays, tables, etc. wherein an integrated form of trip planning may be performed. Preferably the information from the transport company is provided by an internet link. The system preferably also provides links wherein the user can automatically hail cabs, and other on demand transportation, from their map equipped cell phone, PDA, or other map equipped digital device.

Aspects of the invention include the following:

Combining info from various sources (i.e. means of transport) to arrive at a transport meeting target criterion (i.e. proximity to destination, cost, time table, ease of use, speed, and so forth). The information may be combined into a single ordered table.

List of transport “resources” in hierarchical order based on a user selected metric (described above). These resources may be displayed on the map, along with other pertinent data.

Storing information (with an update time) on device. Checking for updates of given information in background (to assure that schedules have not changed and so forth). Autoverify of a route taken from memory for which additional info is desired (preliminarily selected?) to verify that routing has not changed.

6.3 Description of Embodiment.

A program for displaying a map on a computer, PDA, or other dynamic display device may be configured for operation according to the present invention. Maps are displayed on the system in response to data which represent the position and type of streets and so forth. Landmarks, such as restaurants, as well as meeting locations and so forth are similarly represented as iconic element placed over the background of the map displaying streets and optionally terrain information.

The present invention incorporates an interface into the mapping program which allows a user to retrieve information for display on the map from one or more other sources of mapping information. To provide the most standard interface which may be utilized within a variety of mapping programs the items to be shown on the map are preferably represented using a conventional coordinate location (latitude and longitude), with an icon represented as a vector graphic that is scalable to the zoom range of the map and the preferences of the user.

Information is preferably also uploaded in relation to the items which can be accessed such as during cursor over detection. The standardized information may be translated by the routines in the mapping program into a native format for the mapping program so that the same display routines may be utilized for overlaying the external content onto the map.

An animation mode is also preferably supported wherein a route is depicted moving over a map display. The external information in this case indicates that it is an animation and contains a series of points and possible street name directions (as the scale may prevent seeing the actual turns on the map wherein they can be indicated on the animation. The icon, such as a car, bicycle airplane or whatever is shown moving point to point along the route. The user can preferably pause the map at any time wherein the turn is read out, and may unpause to continue the animation wherein a subsequent direction is provided.

Scene mode is another optional feature wherein a graphic and or image can be displayed in response to a position being achieved in the animation, or selection by the user. This allows landmarks, storefronts, and so forth to be depicted as they are seen to the traveler, thus simplifying finding their way. Furthermore this mode can be utilized for narrating travel logs on a map program compatible with the present invention.

It will be appreciated that any standardized formatting of position and element can be supported within the mapping program.

The system may be utilized in a number of alternative ways, the following being provided by way of example.

6.4 Use Examples.

6.4.1 From a Non-Map Web Site.

User visits a first web site that would not traditionally support a map. The site however is configured with data compatible with the standard mapping interface, wherein the user can click a link to a compatible map program, such as located on a second web site. The map program is activated and receives the additional map data, and use parameters, from the first web site, and displays the desired information to the user. The map program can generate revenues by its own use of advertising when the map is displayed. In this way the first web site need not purchase or support a whole map program which requires updating, and whose controls may be unfamiliar to the user.

As an alternate, the user may have a specific map program that they prefer to use, wherein they may click an icon wherein that program is brought up and collects the information from the selected page, or page portion of the first web site for display.

6.4.2 From Multiple Non-Map Web Sites.

Data may be collected from multiple sites and displayed on a single map, for example a user may be interested in certain hotels in a given area, wherein they can save the data from the hotel web sites and display all this information with location in the map display. Furthermore directions to the hotel from an airport or other user specified direction can be displayed as animations indicating the freeways, turn-offs, roads, to be taken to arrive at the hotel from another location.

Another example of this use, allows a user wants to take a bus to a certain restaurant to overlay map information and pickup times received from a regional transit web site and information from the restaurant. In this way the user can readily determine the closest bus stop, the walking distance and so forth. The map forms a bridge between data sets provided by entities that need not directly support map software and the updating thereof.

6.5 Apparatus External Data Mapping.

The invention may be generally considered an apparatus for displaying positions and routes on a map display in response to data received from web sites, comprising: (1) a map database containing street and roadway information; (2) a map display program configured for displaying portions of said map database in response to user control or data received from a web site; and (3) an interface for collecting location specific information from a web site and displaying the information over the street and roadway information generated by the map display program.

The information collected from the web site contains information on location, such as coordinates, and information about what is at that location. Icons or other representations may be passed for display.

The invention may be integrated within existing map display programs. To facilitate creating the information for display on the map, map program configured for displaying the external information according to the invention, should preferably support a mode wherein the web host authors the location content in a section of the mapping program and downloads the information to their own web site. In so doing the web site associated with the map display program buries a link for their own mapping program, wherein if the user has not specified a map program the map site of the authoring program will be utilized.

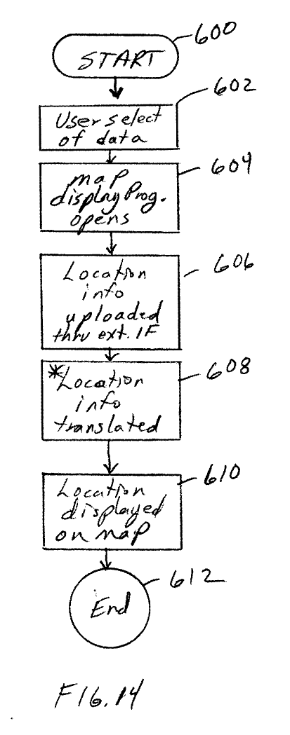

FIG. 14 illustrates an example of program execution for the invention based on a user internet session which already started 600. The user selects map compatible data from a first web site as represented by block 602, the user may select their own specified map program to view the information or an external program, wherein the map program opens as per block 604 from a second web site. Information is downloaded from the first web site to the second web site as per block 606. If necessary the information from the first web site is translated for use by the mapping program as per block 608. Then the location and information are displayed on the map as per block 610, and the user can later exit the mapping program as per block 612 returning to the first web site. It will be appreciated that the data passed to the mapping program extends far beyond what is provided by a mere address, allowing interaction, overlays of multiple sets of information, and the use of graphical content supplied by web sites external to the mapping web site.

7.0 Active Automotive Lighting.

The display elements (LEDs) utilized are preferably capable of being addressed according as universal synchronous LEDs as described in the application “A system and method of driving an array of optical elements” Ser. No. 09/924,973 filed Aug. 7, 2001 and provisional application serial No. 60/223,659 filed Aug. 7, 2000, which are included herein by reference. Although conventional LEDs may be utilized, they would lack the ability to be controlled individually or in segments.

To increase driver recognition of automotive lighting. Typical automotive lighting, such as turn signals, are turned on and off as an integral unit. This may be largely due to the historical reliance on large incandescent lights to generate the light output. The present invention provides for the control of two dimensional multi-element LED lighting arrays for use on automobiles.

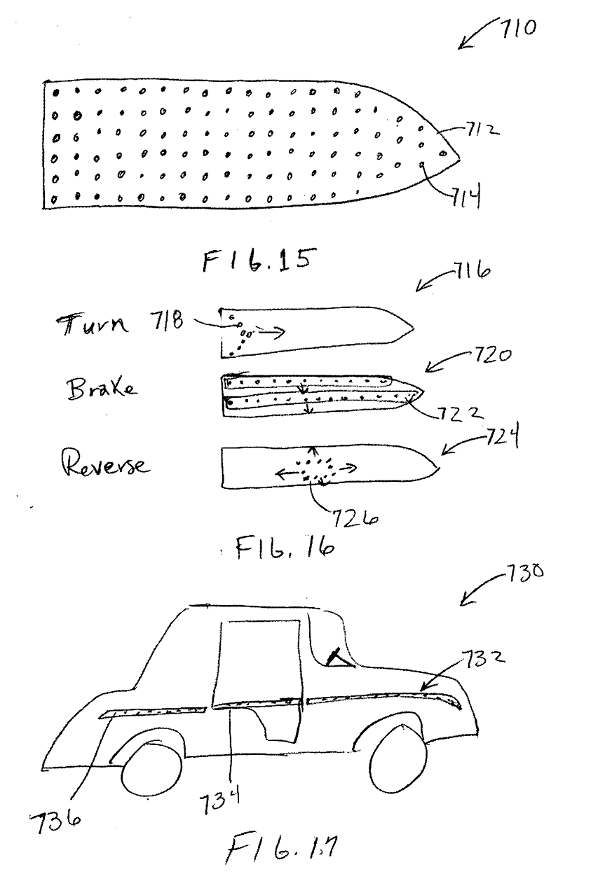

FIG. 15 depicts a rear light cluster 710 for an automobile that provides multiple function output, such as turn signals, brake signals, reverse signals, and running lights.

These LEDs are connected to a controller so that the state of each LED may be controlled to effect a desired lighting pattern. Note that a conventional rear lighting of an automobile is divided into separate distinct elements, whereas the present display need not be divided in this manner and preferably is not.

To enhance the recognition of the displays the LEDs are turned on and off in a pattern, preferably a two dimensional pattern. The patterns may be used to indicate the state of the vehicle in relation to braking, hard braking, turning, reversing, or just to provide exterior lighting for night operations.

Although the LEDs may be connected to a conventional Row and Column form of controller it is preferable that they be connected using the USLED technique described in the referenced patent application.

The controller is preferably equipped with an interface such as CAN controller wherein the automotive may pass control information to the display to command the mode that it should be in at any time.

FIG. 16 exemplifies a few of the patterns that may be adopted to indicate different conditions. By way of example and not of limitation, turning may be indicated as shown by 716 with an angled chevron shaped row of lights 718 being activated that traverses across the light section to indicate a turn. Braking may be indicated as shown 720 by one or more rows of light 722 traversing downward indicating the followers should slow down. Reverse can be generated in a second color of light for compatibility with present systems or may follow a pattern such as indicated by 724 by the enlarging rectangle 726 which simulated the typical small rectangular reverse light on a conventional vehicle lighting system.

Running lights are preferably implemented by operating the LEDs at a low intensity, simulating the effect of conventional running lights. Furthermore, special effects, text, icons, and so forth may be displayed according to indicating vehicle status or just to provide a novelty action. For example when operating as running lights the LEDs may be “twinkled” in a muted random pattern or may display a scrolling low intensity message, in similar manner as a bumper-sticker, except that the driver is preferably allowed to set message contents using the auto electronics systems.

The typical lighting cluster of the automobile may be replaced by a single elongated lighting panel on the rear of the automobile that conveys the status information as described while making it easier to display text messages and graphics.

It will be appreciated that the LEDs within the light cluster may be of a single color, two color, or multicolor, according to implementation preferences. Furthermore, sections of the light cluster may be configured with different types and colors of LEDs to increase the flexibility. For example full color LEDs may be used in portions, such as centrally, for providing the white color output desired to indicate a reverse gear engagement.

The panel of LEDs can be utilized for indicating hard braking and other conditions detected by an anti-collision system, as described in patent application describing an anti-collision system Ser. No. 09/730,327 filed December 2000, which is incorporated herein by reference.

It should be appreciated that a number of different patterns may be adopted for these functions without departing from the present invention.

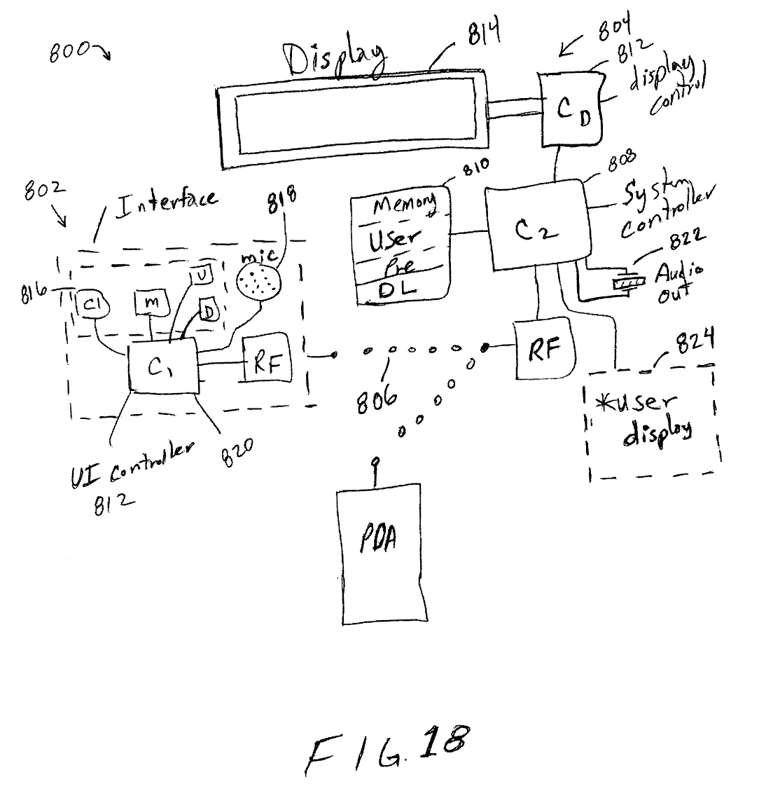

FIG. 17 illustrates another form of automotive lighting 730 that may be facilitated using an array of LEDs that are either controlled conventionally, or preferably using the USLEDs with a controller configured to receive commands from a automotive system controller, such as over a CAN bus.

Three sections of light array 732, 734, 736 are shown which include a one or two dimensional array of LEDs, or similar light elements. The lights on these bars may be used to indicate a turn towards a given lane or braking, to increase visibility, and/or to provide enhanced esthetics.

One aspect of the light bars is that they may be housed in a trim strip that has a transparent exterior. The transparent exterior may be further configured with liquid crystal material, or similar electrically controlled transparency material, wherein the trim strip can be darkened and appear conventionally, but may also be selected to allow any amount of light to be transmitted out from the underlying display elements. It will be appreciated that an organic LED (OLED) strip may be produced for use within a trim strip that does not require a housing.

Additional Aspects of Invention:

Sparkle the LEDs to increase recognition.

Patterns of LED lighting as novelty and increased recognition.

Eliminate the segmentation of lighting.

8.0 Vehicle Scrolling Displays.

The application entitled “A system and method of driving an array of optical elements” Ser. No. 09/924,973 filed Aug. 7, 2001 and provisional application serial No. 60/223,659 filed Aug. 7, 2000, are included herein by reference.

To allow drivers to communicate a live, or user selected, message to other motorists or pedestrians. The system may be utilized in a variety of messaging applications wherein the message should be communicated with little manual intervention on the part of the driver, or party posting the message.

Display arrays, such as described in the application on USLEDs are generally set to display a given pattern by downloading information to controller, or by selecting the items to be displayed from a user interface, which may include the user typing message contents, or pasting text from a file for inclusion within the display.

It will be appreciated that traditional display arrays are typically utilized for advertising of a fixed message or series of messages. The use of such as display for a temporally relevant message, however, would not be amenable to such cumbersome methods of controlling a display. The present invention provides an interface to a scrolling display with a view toward this temporal display situation. The present invention describes an interface for directing the operations of a scrolling display located on the vehicle for external viewing by other motorists, and pedestrians.

FIG. 18 illustrates an example embodiment 800 of the vehicle display lighting invention. A user interface controller comprises an interface module portion 802 for entering user commands, such as at the steering wheel and a control portion 804 connected into the vehicle systems for controlling a scrolling display connected on the vehicle. The interface module 802 and control portion 804 are shown communicating over an RF link 806.

Control circuits 804 are configured with computer processor 808 with memory 810 for storing predetermined messages, and messages created, downloaded, or otherwise entered into memory. The output of processor 808 controls a display controller 812 configured for generating information to be displayed on a display 814. It should be appreciated, however, that the user interface controller and display controller functions may be integrated into a single controller without departing from the present invention.

The input module 802 is shown comprising four selection buttons 816, a microphone input 818, as inputs to a controller 820. User inputs are communicated to the control section 804 which feedback may be provided by audio on annunciator 822, and optionally, on a small display 824 which may be included. The display has particular relevance for displaying a rendition of a message prior to its being displayed on the display array. Consider that the four buttons may comprise Clear, Menu (context specific selection), Up, and Down.

The action of the “Menu” key changes and the action performed by it is preferably output as a spoken text string—example—“voice display”, “verified”, etc. Microphone 818 of the system is preferably operably connected to the controller and passed through a speech to text conversion algorithms (which are known in the art).

Aspects of the invention include.

Display/scroll a voiced message—User may press “Menu” to arrive at first selection which is “voiced message”, the Menu key becomes a select key to by pressing the “Menu” key again the controller enters voice mode and preferably emits an identifying sound, letting the user know they may “voice” the text they want displayed. User voices a given message, for example: “Blue Cadillac—Get OFF my tail!!” wherein at the end of voicing the text they press the “Menu” key again (now an End key). The system converts the voiced speech to text. Optionally, the system performs a text to speech conversion and plays the audio back to the user for verification of the message prior to its display, or allowing its quick canceling if incorrect. If verification is performed then the user can press the “Menu” key (now a “Yes” button, No being selected by “Clear” or using the “Up” or “Down” key). The text of the converted speech is then formatted for the display and sent to the display array wherein it is communicated, such as to the driver following the vehicle.

Control of multiple display—if multiple displays are being controlled the user interface provides a display selection process, for example a scrolling function wherein user selects one or more displays upon which message is to be displayed. The selection of display may be optionally performed according to a voiced command.

Selection of predetermined message—The user can load various messages into the controller for display at a later time. These messages may include text, graphics, animations, and so forth. To simplify user selection within the invention, each of these possibly complex displays are accompanied by a descriptive name that facilitates user selection. For example a waving flag could be named as “waving flag”, and so forth. The user can then press the “Menu” key to select mode, wherein “voiced display” is generated as audio by the controller, pressing the “Up” key allows the selection of user programmed displays, wherein the controller may generate audio “User”. The user presses “Menu” to select the “user” display mode, and can then scroll using the up and down key through a list of available messages, the name of each being voiced by the controller. On pressing “Menu” (select), the system generates the message to the display.

Preprogrammed and downloaded messages—Similar to the above the controller through the user interface may be utilized for selecting other forms of messages, such as “preprogrammed”, “downloaded”, and any other categories defined in the system or by the user for categorizing their messages for speedy access.

Default message—the controller may be set to generate a default message, or a sequence of messages associated with a default message, wherein should no other message be displayed the default message will be displayed. For example, after the system first starts up the display begins with the default message. If the user programs a display setting, such as voice to text on display, then after pressing clearing the display, such as by pressing the clear button twice (first clears menu to beginning, second clears the display itself), the display is cleared and the after preferably a short pause to avoid confusion of watchers, the display returns to the default mode.

The system may added as an aftermarket device to a vehicle (aftermarket). A display array is seen connected to a controller, such as described in the USLED application, which is a generic controller for the display.

Although this controller may be augmented with the functions herein, a separate application controller (C2) is shown connected to the display controller as this would be a preferred configuration to support a variety of input devices. The application controller is shown connected to a memory of sufficient size to store display messages, such as user programmed, preloaded, and downloaded; which may be text and or graphics. The application controller is shown connected to an audio output device for communicating with the user with sounds and voiced information. An optional user display is shown, this preferably comprises an existing display such as a moving map display, heads up display, or similar.

An RF input module for communicating with a remote user interface module which is similarly equipped for transmitting information. Although not necessary the use of the RF link facilitates adding user interface buttons in a convenient location without the need to add wiring. An RFID form of system may be utilized wherein the user interface is coupled to a RF transponder device that receives RF power or inductive power and communicates collected information to the challenges from a remote transceiver. The user interface module is shown with a small controller for receiving inputs from the four control buttons and for controlling an RF transceiver module, which can also be used to direct the sounds (voiced command, text) from the microphone over the RF link to the application controller. It should be appreciated that the vehicle may already be equipped with a general interface including voice and other command inputs wherein the application controller may be implemented to take advantage of these systems, or even be provided as software only for execution on an existing controller within the vehicle.

Programming and downloading information to the application controller is facilitated by a device such as a PDA (laptop, phone, etc.) which can communicate with the application controller. For example the user may program different display renditions on an application running on the PDA, or a computer whose output is downloaded to the PDA, wherein the display messages may be programmed into the application controller, which preferably includes the memory as non volatile so that messages are not lost in response to battery disconnections and so forth. The present invention would preferably be augmented with an application program for use on a PC, PDA, or other GUI based device, or a web served application; that would allow the user to generate messages for a display array and to download messages and other selections from the application or over the internet for use by the application controller.

A number of features of the invention have been described according to a specific embodiment, it should be appreciated that these may be implemented individually, or in combinations thereof. Furthermore, variations of the features available to one of ordinary skill in the art do not depart from the teachings herein.

9.0 Auxiliary Systems Cutout on Acceleration.

To increase acceleration within automobiles by turning off auxiliary systems, in particular the air conditioning system (i.e. deactivating the clutch coupling engine power to the A/C compressor), the alternator, and optionally other power robbing equipment, when the user attempts an acceleration that is above a predetermined threshold.

Small vehicles are often “acceleration challenged”, and the extra horsepower required to drive the A/C pump can significantly lower the already meager rate of acceleration. It should be appreciated that when the vehicle is stationary, the power taken for the A/C system is being driven by an idling engine, and a fixed torque is required to operate the A/C compressor in its active state.

The present system senses the attempted acceleration and deactivated the clutch to A/C wherein compressor operation is temporarily suspended so that acceleration is not unduly hampered. The “attempted” acceleration may be sensed by detecting the absolute amount of accelerator pedal deflection in relation to speed and conditions, or by sensing changes in the depression of the acceleration pedal deflection.

It will be appreciated that the power to drive the A/C may be alternatively reduced by other means for a specific vehicle and A/C system, such as lowering he A/C compression. These alternatives would be known to one of ordinary skill in the art and their practice does not depart form the teachings of the present invention.

Furthermore the system also preferably reduces the field current for the alternator wherein the charging load it places on the engine is lowered, or preferably minimized. The loss of charging current for a short period of time associated with acceleration will be made up for when the vehicle is up to speed. In addition the load posed from any other systems that are drawing power from the engine during acceleration should be disconnected or their power draw reduced, if this can be performed safely.

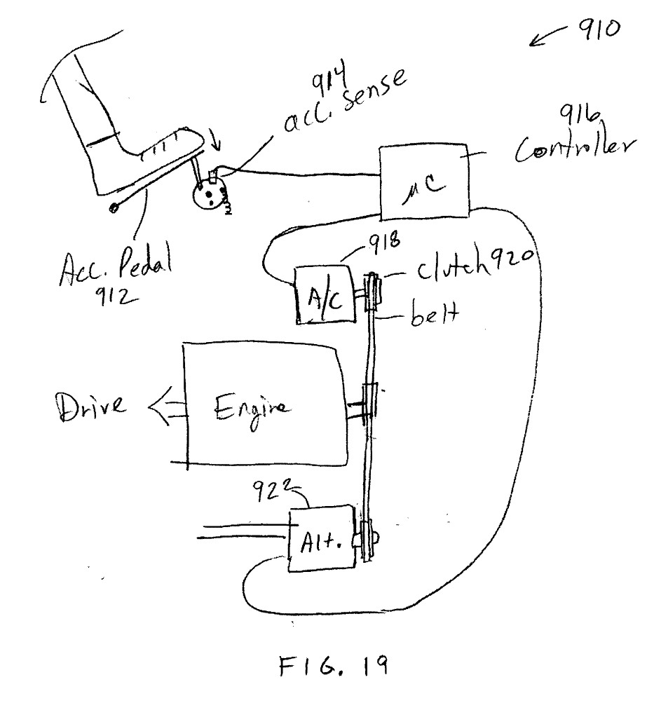

FIG. 19 depicts the present system 910 wherein an accelerator pedal 912 that is electronically sensed. The position of the pedal is sensed 914 and an electronic control system 916 then generates the control signals to the engine to set the throttle. In this application the control system is configured with programming to also control the activity of the air conditioner and other auxiliary system in response to the amount of acceleration desired by the driver as indicated by the extent of pedal depression under the given conditions.

An output from controller 916 is coupled to the A/C 918 for controlling the activation of the clutch 920 determining how much power is taken from the engine by means of the drive belt. Similarly, an output from controller 916 connects to alternator 922 to alter the field current and/or a clutch engagement if it is provided.

10.0 Parking Registration.

10.1 Purpose.

Numerous instances exist wherein information about a vehicle, or vehicles, must be found so that the status of the vehicle may be determined. The primary method of initial vehicle identification is by means of manually recording “taking down” the license plate number and state, and then entering the information into a computer. In the case of parking garages, the license information is usually written down and then physically taken back to a central computer. In either case the license information must then be entered into the computer for the identification to be performed. In the case of remote operation, if an action should need to be taken in regard to the subject vehicle, such as in a parking garage, the attendant generally returns to the vehicle, if it is still on the premises, with the printed ticket. The following being but a few of the applications:

Parking garages—periodically the identification of each vehicle must be checked to verify if they are a tenant, and furthermore if they are parked in the correct area according to their tenancy agreement. In certain cases vehicles found in violation are then ticketed and perhaps towed.

Parking meter enforcement—when a parking violation occurs, it is preferably to identify the subject vehicle and to check if any outstanding parking violations exist.

Highway Patrol Enforcement—During a patrol shift it is necessary for an officer to check the status of dozens of both moving and stationary vehicles is checked constantly.

10.2 Description.

The present invention provides a system for the automatic checking on vehicles utilizing parking spaces, loading zones, handicapped parking spaces, metered spaces, parking lots, and reserved parking areas.

An image collection device (camera system) is adapted for being directed at the license plates of vehicles for electronically registering an image and converting the image into a set of electronic information about the license plate by a computer on which is executed a software application, such as utilizing digital signal processing techniques or neural network processing. The information preferably includes the state and the license plate number and may optionally contain any or all of the following information: current year tag yes/no, make of vehicle, model of vehicle, year of vehicle, condition of vehicle, color of vehicle, missing plate (y/n), existence of special tags such as parking stickers, and so forth.

In addition, the camera may be optionally equipped with an infrared sensor, or imaging, that can register the infrared heat signature of the vehicle, wherein the time that the vehicle has been located in the space can be estimated based on the thermal map for that particular vehicle. It will be appreciated that the ability to discern a textual characters such as found on a license plate number and other such printed information is known in the art, therefore this signal processing step will not be described.

The computer is connected to a database having at least one field which indicates vehicle information, such as license plate number, car make and model. The computer, or a network of computers, looks up the vehicle identification in the database and extracts the information about the subject vehicle. This information may be made available through the computer to other systems, and/or be redirected back to the point of registration. The information may be compared absolutely, such as to determine if a subject vehicle is not authorized to park in the reserved space, or to determine temporal aspects of the parked vehicle (when parked, how long parked, and so forth).

10.3 Preferred Embodiments.

The camera may be mounted with a DSP chip for processing the signal to extract the license number and additional metrics, and a communication device (such as RF transceiver). When directed at a license plate (or the vicinity of license plate), the software analyzes the image, (optionally at a first lens configuration, such as wide angle) and detects the location of the license plate, optionally changing toward a close up view if necessary) and extracts the information for the plate which is processed to register the number and any desired additional information. Once extracted, the information is communicated (such as via RF transmitter) to a remote second computer device equipped for receiving the transmission (such as computer with RF receiver input). The second computer device is connected to a database having one or more fields of vehicle information such as license plate number and so forth. The system may be used to provide a number of functions, which may be provided separately or in combinations thereof, the following are provided by way of example:

alert for any vehicle parked without a current parking sticker.

alert for any vehicle not registered for monthly parking.

alert for any vehicle parked beyond the allowable time.

alert for vehicles subject to warrants and so forth.

alert if the vehicle make, model, and color do not match license plate number

additional information on the alert.

printing of warnings/citations/tickets.

including user created messages

including photos of vehicle.

entering status as to what has been done to respond to alert

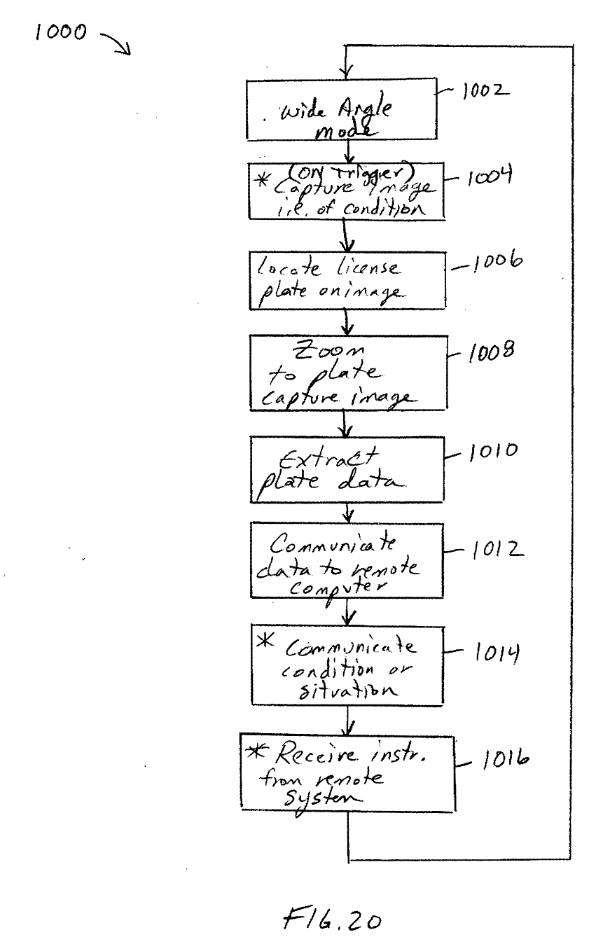

FIG. 20 illustrates an example flowchart of system operation 1000 according to an embodiment of the present invention. Camera is set in wide angle mode at block 1002 when target initially identified, such as by a person patrolling a parking area. In response to a trigger, such as a key press by the user, image capture is performed as per block 1004. (Alternatively, image capture may operate continuously.) Image processing is performed to locate a license plate in the subject image as per block 1006. Upon detecting the plate the camera is zoomed (physically, or by electronic enhancement) as per block 1008 and license plate data is extracted as per block 1010, which is known in the art, from the image. The collected data is transmitted to a remote database and recording system as per block 1012. Conditions relevant to the image may also be communicated, such as directed by the user or the environment as per block 1014. For example, speech notation may be captured from the user to note in the file, while user selections as to offense (i.e. selected from a menu), may be communicated to the remote system. External environment conditions may also be detected from the image processing routines, which can detect information such as handicapped parking spaces, time limits, parking meters, no parking markings and so forth. Additionally information as to the location where the image was capture, such as given by a GPS system, and the camera direction, such as provided by an electronic compass. The data is processed against the data base which checks information about the vehicle, situation, and prior problems. After being processed, the remote system can return data about what is to be done about the subject vehicle as represented by block 1016, such as writing them a ticket or having the car towed.

In some applications the camera unit is preferably configured with a ticket printer, that can automatically print out tickets for a vehicle in response to the data returned from the remote computer.

It should also be appreciated that the camera unit itself may be configured to retain a sufficient database for processing the data about the vehicle wherein remote communication is not necessary.

Alternatively, the data may be downloaded from the camera to a system for processing violations, such as utilizing a USB on the camera. If performed in this way, then the image data may be processed for extracting license plate and other information from the raw images.

The parking registration system may be configured as a RF equipped handheld camera device, or it may be mounted to a vehicle, such as a parking enforcement vehicle, wherein the camera may already be oriented toward the position of license plates.

10.4 Video Stream.

Furthermore, the system may capture the necessary images from a digital video stream, which is particularly useful for a camera mounted to a vehicle. The information from the moving camera may be automatically registered and checked without the need of user intervention or focusing of the camera, as the license plates and related information may be automatically extracted from the video stream. In addition if additional resolution is desired, the system can automatically utilize artificial aperture techniques wherein multiple images having a generally known displacement from one another are combined to increase image resolution.

10.5 Dual Camera Elements.

A dual camera unit may be utilized, such as a wide angle camera whose images are analyzed to find the ends of vehicles using digital signal processing techniques. Once located a second camera with a different lens, such as a zoom, is directed (i.e. with an x-y positioner) toward the location of the license plate, wherein the second camera captures the image in greater detail. It will be appreciated that the cameras may capture either still images or video streams. If the vehicle is moving then the time differential between camera is taken into account wherein the first camera leads the second by a distance determined by vehicle speed and the time required for locating license plates in the given image frames. The second camera may provide for example a close up view of the license plate without the need to stop and focus on that element.

10.6 Integrating Location and Camera Direction Information.

The system may include a GPS system and/or an electronic compass, wherein the location for each image may be tagged with a GPS coordinate and an orientation signal indicating which direction the camera is facing. This information may be particularly useful for identifying the locations of subject vehicles identified in the processed images.

Alternatively, the system can extract information about the parking space from collected image data, such as signs indicating “10 Minute Parking”, painted curbs, handicap signage, and the like. The system performs extraction of these features within the image to qualify the data being communicated to the remote system. The user may also input information as to why the data is being sent to the remote system.

10.7 Automatic Patrols.

In a camera system according to the present invention that includes GPS and direction information, a system of automatic patrols may be established for checking parking violations and checking for wanted vehicles, or vehicles with outstanding violations. During regular patrols the controller within the present invention operates the camera to automatically process images of vehicles “looking” (extracting data from image into text, doing search in a database) for vehicles that are “wanted” for some reason, for illegally parked vehicles, and for vehicles parked for excessive periods of time. The inclusion of the location information allows a determination be made as to the type of parking allowed at the images locations, while it further allows the persons to be dispatched to that vehicle should a citation be necessary or to speak to the owner of the vehicle. Image feature extraction can also be use to detect other aspects of the parking situation such as handicapped spaces and so forth. It is contemplated that the system may be utilized as a data collection system to allow automatic issuing of parking citations which are then mailed to the offenders that have parked illegally or for excessive time, with the system saving images of the time span between which the subject vehicle has been parked. The collected images along with timestamps and so forth being preferably printed with the citation as irrefutable proof to encourage payment of the ticket.

10.8 Additional Aspects of Invention.

Detection of non-tagged, or non-invalid persons, using a handicapped space. If a surveillance camera operating with software according to the invention is located in a position wherein vehicles parking in the vicinity of a handicapped space may be observed, then a number of advantages may be provided. By way of example:

The system commences a recognition program whenever the space transitions from unoccupied to occupied. The system preferably discerns the orientation of the vehicle, (normal or parked in the reverse direction), and then checks the license plates, and/or window tag, for the handicap sticker or symbol which indicates that the vehicle has a handicapped owner. The system may optionally monitor the vehicle and determine whether the persons exiting the vehicle are doing so under their own power or with the aid of a wheelchair. Signal processing software such as this is known in the art, such as for determining if persons being monitored by a camera are accosting one another. The system may generate an alert to enforcement officials or others if the space is being used incorrectly. Furthermore, the license plate number may be registered and checked with the DMV data base to determine if the person is listed as handicapped although no indicia was found, or alternatively that they are not listed as handicapped yet are displaying one or more indicias.

11.0 Parking Sentry.

11.1 Problem.

To protect parking spaces from use by non-authorized parties. Reserved parking spaces are often taken by other than the intended person. This is a problem especially at apartment complexes, but is also a problem at many companies. This device provides an alarm to allow persons to protect their spaces.

11.2 Summary.

An alarm to protect parking spaces such as those in an apartment complex. A small unit is mounted to the hard surface comprising the parking space near the center. This unit contains a radio receiver, a means of sensing if a vehicle is occupying the space (Coil or Hall-effect sensor), an audio alarm and batteries.

The housing is tamper proof and portable. Housing preferably shaped as a square about 8″ across with rounded corners. Side view the top housing exterior subscribes an arc while the bottom side is substantially flat.

A mounting plate is attached to the parking space with either adhesive and/or fasteners. This flat mounting plate contains integral female threaded fastener locations for the mounting of the housing.

The main housing is preferably fabricated from high impact plastics. It contains a lock on top, such as of the circular variety. Access to the interior of the device is provided by inserting and turning the key. Once the device is opened, users can replace the batteries, and even unscrew the units from the mounting base to attach it to another mounting base. A circular cap covers the externally exposed region of the lock to prevent grime from getting into the lock.

11.3 Alarm Output.

Device is armed via a coded radio transmitter—when armed the receiving unit preferably emits a sound that uniquely identifies that the unit has been armed. If a vehicle parks near the sensor (over it) then the alarm will sound until the vehicle has been removed.

When the transmitter disarm button is pressed, the receiving unit emit a sound to correspond with disarm. If the alarm has sounded one or more times during the period that it was armed, a unique sound will be preferably emitted for each occurrence, thereby notifying the authorized user of the space of the transgressions.

11.4 Power Drain.

Power must be provided for the receiver unit, the sensing of vehicles, optical output, alarm output, and for the controller in orchestrating these circuits.

Receiver unit—Can be turned off about 90% of the time. When it sensing any signal it would stay on longer to verify. User can tolerate waiting a second or two in order that the batteries could last longer.

Vehicle sensor—this can be a wire loop, hall effect, or other sensor. It must sense for cars in an apparent continuous fashion, although in fact is it may perform one sense function only every 1-4 seconds to conserve battery power.

Optical output—LED or other device to signal device in operation. The LED can be set to flash periodically. The shorter the ON period the longer the battery will last.

Audio output—audio transducer emits various sounds in response to conditions. These are non-continuous and thereby the average power draw is low.

Processor and circuitry—the microprocessor should be monitoring the receiver and the sensor. It goes into a sleep mode the bulk of the time to reduce power consumption.

11.5 Example Embodiment.

FIG. 21 illustrates an example schematic for an inexpensive space alarm 1100 according to the present invention. A car sense means 1102, depicted as a low power inductive sense loop coupled from an output of a microprocessor 1104 to an analog input of uC 1104. This may be implemented with other forms of sensors for detecting the mass of metal associated with a vehicle, such as hall effect sensors.

A challenge signal may be generated over the inductive loop which can be automatically responded to by an RFID tag attached to the vehicle of the owner. In this way the owner would not even need to turn the unit on or off. The alarm unit is preferably configured to generate challenges in response to detecting the arrival of a vehicle and to detect responses from the users RFID tag and deactivate automatically, preferably generating a beep indication.

An RF circuit 1106 allows the unit to be programmed from a remote control device, such as turning it on or off and setting parameters. The RF circuit may be utilized to receive the RF response from an RFID unit as well as from a transmitter (two separate RF sections may be required).

Alarm output from uC 1104 is shown controlling an audio circuit 1108, such as an analog or digital amplifier (i.e. class A, B, or D) to a piezoelectric transducer 1110 (or speaker).

Power is provided by battery 1112 the status of which is sensed 1114 by uC 1104. If the power is low, then the unit can notify the user by audio output or by a light output.

An indicator 1116 is shown for indicating conditions, and to augment the alarm. The LED can be configured to generate bright flashing in response to unauthorized vehicles parking over the unit. It also can be used to indicate status to the user, such as battery condition and so forth.

11.6 Additional Aspects of Invention.

Can identify the correct vehicle using a coded transmitter (used by the correct party as they park their vehicle), such as for locking/unlocking of doors or opening a garage door.

Can identify the vehicle using an RFID mounted to the vehicle (passive or active) wherein the device issues a challenge when a vehicle approaches over the unit and checks the response to ascertain if the correct vehicle is being parked over the unit.

12.0 Tape Measure Enhancements.

This application includes by reference the additional electronic ink embodiments described herein.

Included herein by reference is the application entitled: “A System and Methods of Maintaining Consumer Privacy During Electronic Transactions” Ser. No. 10/066,495 filed Feb. 2, 2002 and provisional application entitled “Display Systems and Methods Utilizing Electronic Ink” serial No. 60/267,115 filed Feb. 7, 2001.

12.1 Purpose.

To enhance the utility of a tape measure with extended functionality to simplify use in a variety of applications. A number of embodiments are described herein.

12.2 Notepad Retention-Enabled Tape Measure.

A simple enhancement for a tape measure involves the inclusion of a recess configured for receiving a notepad, such as a block of Sticky-notes™ from 3M®) corporation. Preferably the recess is adapted to be of a size to fit a specific size of readily available notes, such as 2″×1.5″, or 3″×3″, and provides only a minimum clearance around the notes. A finger slot which extends the recessed portion along one edge may be provide to simplify the removal of a sheet of notes from the pad.

Furthermore the unit is preferably configured for receiving a writing implement such as a mechanical pencil, so that the user has ready access to both a measuring device and a means for recording measurements. This writing instrument may be received in an aperture, or chamber within the housing, or any convenient form of clip or other attachment.

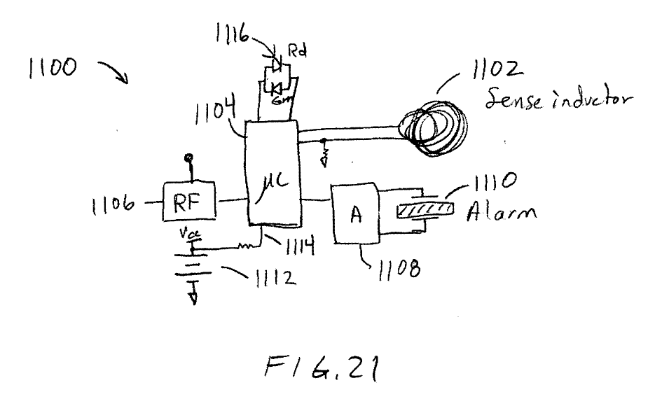

FIG. 22 and FIG. 23 depict a tape measure 1200 having a housing 1202 a recess 1204 for retaining a writing pad 1206 and a preferably a retainer 1208 for a writing implement 1210, such as a chamber, aperture, clip, or so forth into which a mechanical pencil, pen, or other form of writing implement may be retained.

12.3 Electronic Ink Dad Tape Measure.

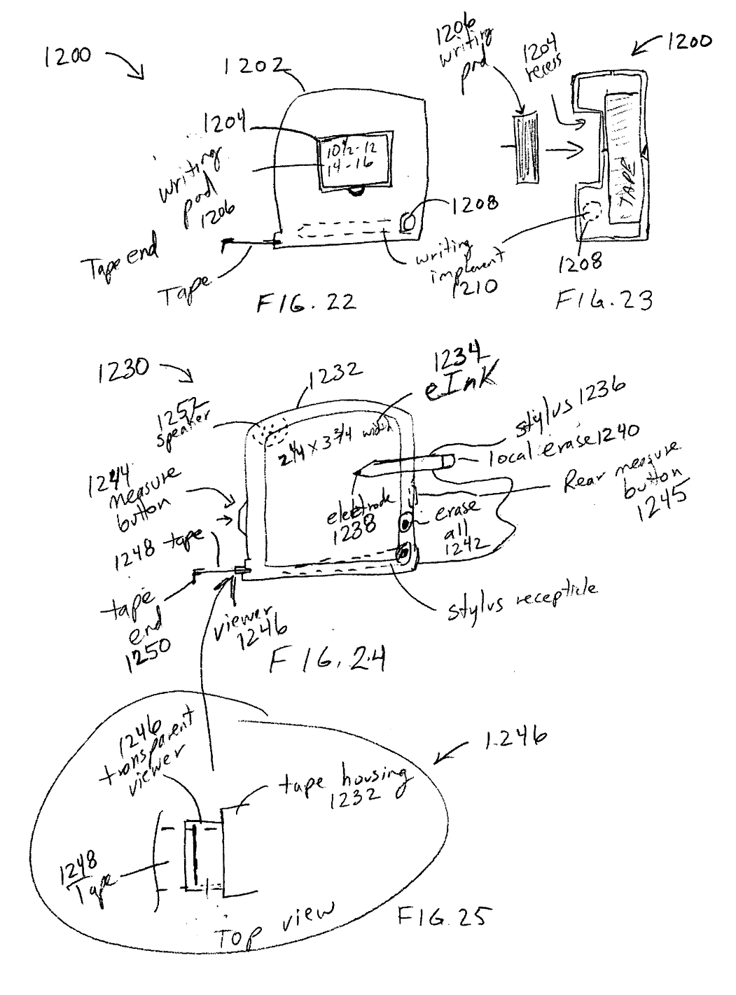

FIG. 24 and FIG. 25 depict an embodiment 1230 of a tape measure with a body 1232 having an electronic ink writing pad section 1234, that may be included on one or both sides of the tape measure with an electrode stylus 1236 being provided to allow writing on the electronic ink for recording measurements. The electronic ink may be deposited over any or all portions of the tape measure surface, beneath which one electrode is provided wherein the electronic ink sandwiched between the fixed electrode and movable programmable electrode can set the state (color) of the electronic ink to display writing. The eInk technology is known in the art.

The stylus 1236 is wired to the tape measure and provides a voltage at the head electrode 1238 for setting the eInk to a first state. The opposite end 1240 of the stylus preferably contains a wider electrode of an opposing polarity for resetting the state of the electronic ink to provide for erasing a portion of the data. An erase button 1242 is preferably provided on the unit coupled to the background electrode and a overlapping electrode grid for erasing the entire area of electronic ink in response to pressing the button.

Although the eInk may be configured in a number of ways it is preferably that the eInk section be deposited on a first electrode and be overlayed by a second transparent electrode. Having the first electrode biased to a first voltage, then the display may be written to by a stylus, having an electrode that applies a voltage which exceeds (or is below) the bias voltage by an amount at least equivalent to the threshold activation level of the electronic ink spheres. One written upon, the electronic ink remains in current state needing no power to retain its setting. An electrode on the back of the stylus, or other location, is configured with a voltage that is opposite to the stylus electrode in relation to the bias voltage on the first electrode. Resetting the entire eInk surface may be performed by setting the second electrode to a voltage opposite the writing voltage in relation to the first bias voltage. This all being in keeping with the use of electronic ink circuits. Tape measure 1230 is shown with a magnified viewer 1246 (alignment guide), for viewing tape 1248 retraction of which is stopped by tape end 1250. FIG. 25 details a top view of magnified viewer 1246 to increase visibility of the measurement reading.

12.4 Electronic Reading Tape Measure.

Tape measure 1230 optionally includes speaker output 1252 for use with an optionally electronic reading feature, for example activated by pressing a front measure button 1244 or a rear measure button 1245, depending on whether the reading should be annunciated for the tape extending from the tape measure or the measure of tape including the length of the tape measure housing. This version of the tape measure is equipped for registering the length of tape which has been extended. The measurement being preferably selectable, such as by a selection switch, as being from the end of the tape to the front of the tape measure, or to the rear of the tape measure.

Preferably the tape measure device renders a distance measurement by reading data from the extendable ruled measure which extends from the unit when needed. It will be appreciated that the measurement may be read from a single location of the tape, such as a dot code which spans the width of the tape, wherein a binary code is represented on the dots for the given measurement accuracy. Obtaining 1/16″ resolution on a 12′ tape measure requires 12 bits of data. Fewer bits may be encoded if movement of the tape spool is registered to provide a rough estimate of location, such as within a few inches so that less bits would be required along the tape. The movement of the spool itself from a closed position may provide sufficient accuracy, however, slack and wear during use can effect the measurements whereas reading of the tape is not prone to those same sorts of error introduction.

The position of tape extension may also be determined by incrementally reading out the distance as the tape is extended or retracted, for example a bar code could be used with a 1/16″ pitch wherein the sequential reading of coded information can indicate the foot and inch while the position of each marker can be used to register the position within the inch. Alternatively multiple strips of bar code could be utilized, such as one for the feet and subfeet (such as down to 4″ sections), and a second bar having a series of strokes on it which are sequentially registered on extension or retraction from the feet and subfeet marking to provide an accurate registration down to the desired resolution. Additionally the dot markings (or elongated bar markings) could be used to indicate down to an accuracy of about an inch and a set of tick marks for registering down to the finest resolution provided, such as 1/16″, 1/32″, and so forth and/or the use of metric resolutions. The device should provide a conversion selection wherein measurements may be converted into any desired format for use on the associated device.

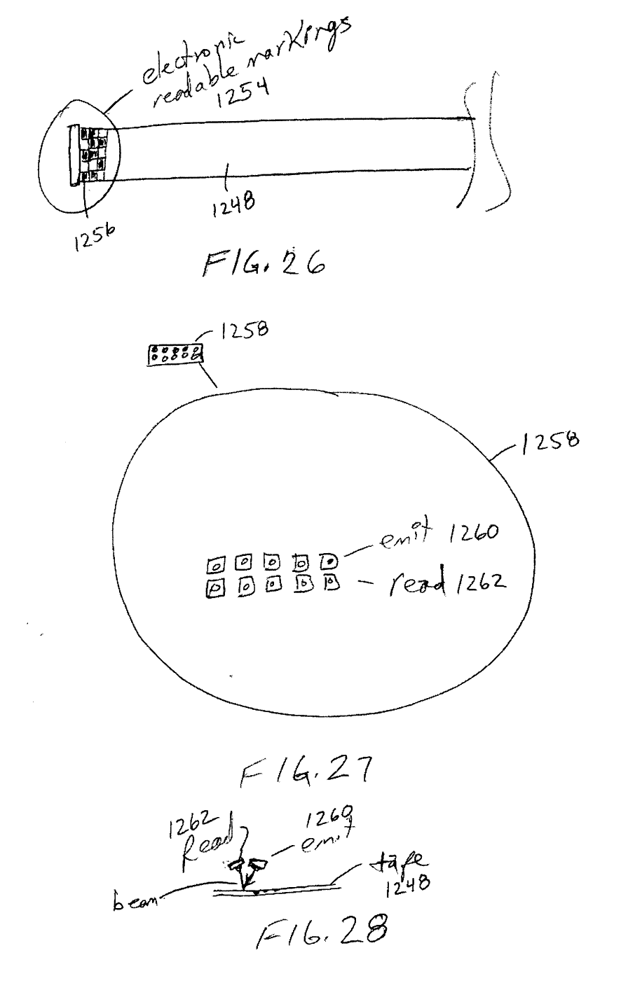

FIG. 26 through FIG. 28 exemplify a mechanism for reading the backside of the tape to determine the length of tape which has been extended. FIG. 26 illustrates encoded region 1254 on the backside of the tape which are configured with contrasting (monochrome or multicolor) bits 1256 to be read electronically. It will be appreciated that the reflectivity difference on painted sections of tape is sufficient to discern the bits of information. Camera speed is registered from film canisters by reading a few bits of information from them. The regions may comprise different colored regions, such as dark and light for encoding a binary pattern or colored regions may be used such as following an 8 color pattern wherein each bit represents an octal digit. It will be appreciated that color receptor diodes are becoming less expensive wherein a single region encoded with one of eight colors contains the same amount of information as 3 regions of dark or light as encoded in binary.

FIG. 27 depicts a five pairs of sensors 1258 for reading a five bit sequence, wherein an array of optical emitters 1260 are shown adjacent a row of receptors 1262 configured to register the pattern of light reflections intensity and/or color from the tape surface. FIG. 28 illustrates emission and registration from the optical system on an edge view.

One preferred way of encoding the information is to provide a coded pattern on the back which is augmented by the reading of the hash marks on the front side of the tape to increase resolution. For example the small hash marks may be to a resolution of 1/32″ inch wherein a short mark indicates a 1/32″ boundary a longer mark a 1/16″, and a longer mark a ⅛″ boundary. Four optical sensors directed toward the front surface of the tape can determine the passing of the tick marks for precise location which is accumulated in relation to the registration of information on the backside can determine the rough location. For example presume a back side encoding with a resolution of ⅛″; if the tape is extended to 10′ 2⅛″ during a measurement the back side emitters and readers have read the location at 10′ 2⅛″, wherein as the tape is extended beyond this value the front emitters are being read and detect the extension with an accuracy of 1/32″ to be added to the 10′ 2⅛″ already registered. Conversely, retracting the tape from a read position causes the read markings to be subtracted from the reading. The tape preferably includes a tape movement sensor that detects which direction the tape is moving whether in extension or retractions.

The electronic tape reading may be output from the tape in the form of a display, or an audio output such as voiced readings. FIG. 24 illustrates a front measure button 1244 and rear measure button 1245 which may be depressed by the user when the tape has been extended to the desired setting. The measured extension of the tape is then output in audio or by a display. For example, as a measure button is pressed the measurement is annunciated in audio such as “eleven feet, seven and thirteen sixteenths inches”. With a conventional tape measure the user views the location of the tape that corresponds with the location to which the measurement is to be taken. The present invention provides a transparent viewer with a fine mark that the user can line up with the desired location of the measurement prior to pressing the outside measurement button.

The circuitry reading the tape location takes into account the offset from the viewer location and the location of the emitters and readers. A rear measure button 1245 is also depicted wherein the unit responds with an inside measurement that includes the length of the tape measure housing. It will be appreciated that the viewer need not be utilized since the span is defined by the length of tape extended plus the size of the housing.

12.5 PDA Format Electronic Reading Tape Measure.

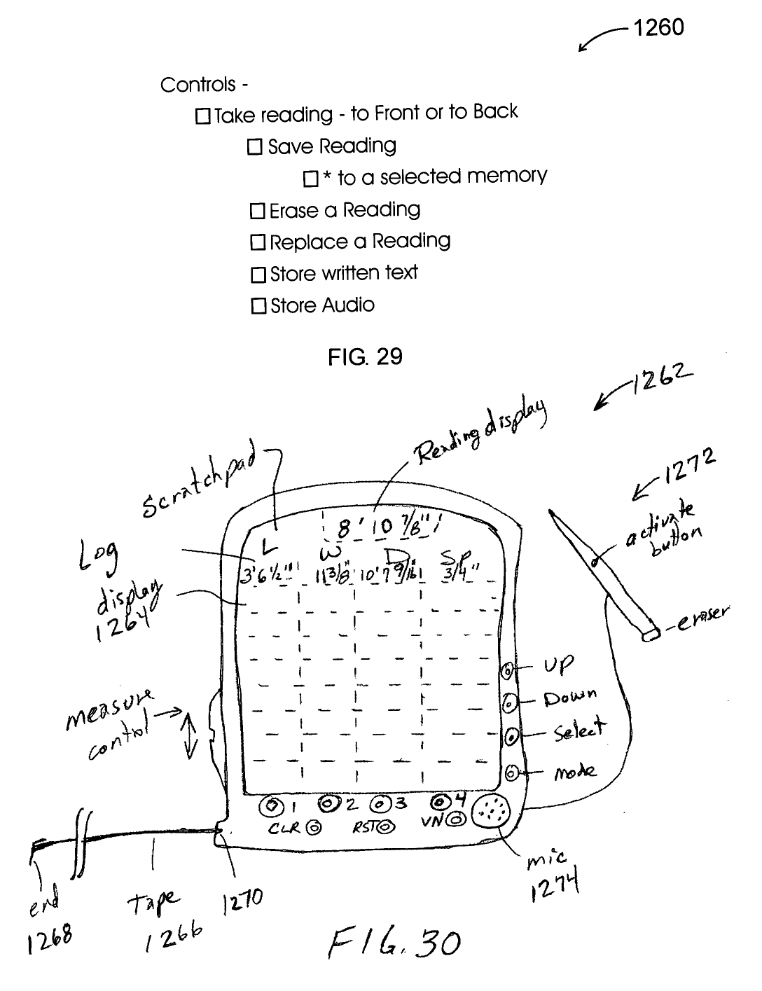

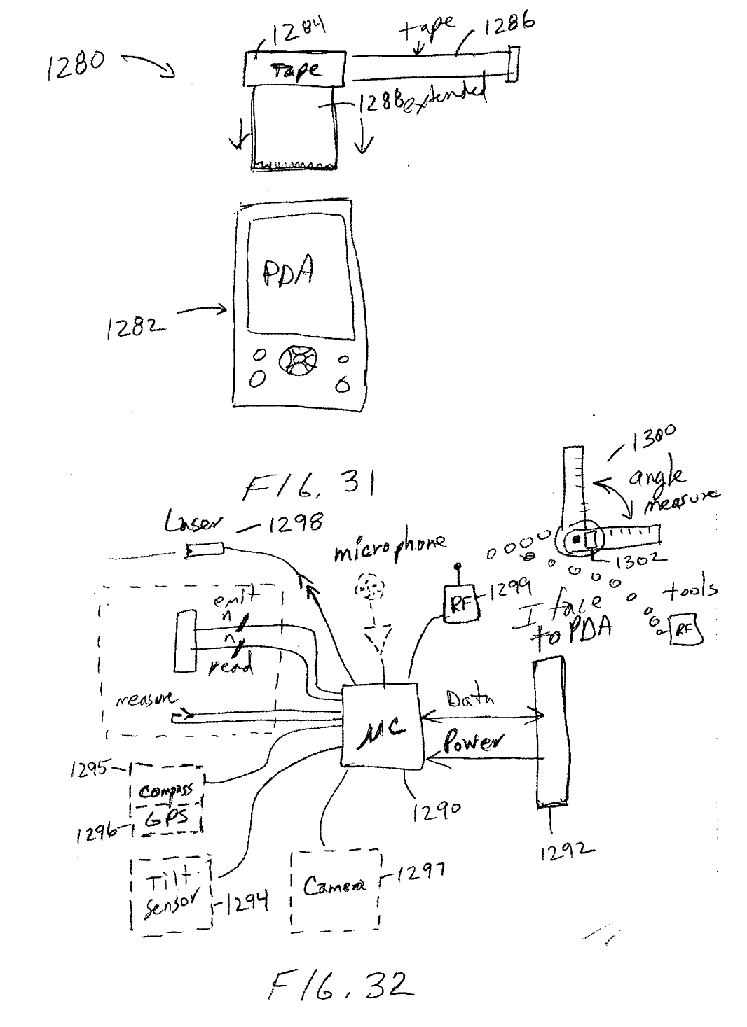

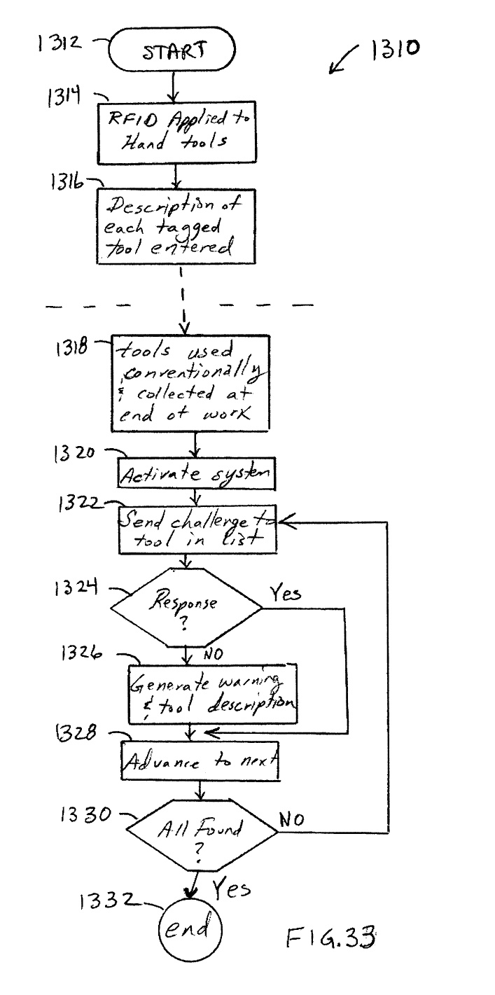

FIG. 29 and FIG. 30 illustrate an example of an electronic reading tape measure configured in a form factor and similar functionality to a PDA. FIG. 29 lists an example of user function selections 1260 for the device 1262 shown in FIG. 30. The computing power of a PDA allows the unit to calculate area and volume forming a DAV (distance/area/volume) measuring device. A display 1264 is shown in the face of the device, such as LCD electronic ink or similar. An electronically readable tape 1266 with end 1268 extends through slot 1270 in the housing of device 1262. The extension of the tape being electronically registered as described previously. Distance readings captured by the device in response to user commands are printed in a list on display 1264, and list selection controls are provided. A mode can be selected wherein a portion of a spreadsheet is displayed which can be automatically populated by the measurement values taken, wherein results according to the spreadsheet can be performed automatically. It is contemplated that a number of templates would be stored within the unit for handling the majority of user circumstances, and other templates may be created or downloaded from the web depending on the application. By way of example the display shows locations for recording length, width, depth, and spacing, such as for a specific application.

A set of user controls are shown in the unit including by way of example, “up”, “down”, “select”, “mode”, “clear”, “reset”, “vn”, “1”, “2”, “3”, “4”. These controls allow the user to control the taking of measurements and the use of those measurements. A stylus 1272 is shown to allow the user to take notes on the display surface, and to perform menu selection and so forth.

Voice may be recorded through microphone 1274 to comment on cells on the screen or for the operation in general. Templates may be created for use with the device in a number of industries, such as for making estimates and ordering materials when laying carpets, installing window coverings, planning sprinkler systems, and so forth. The user takes the measurements, preferably in sequence so no cursor selection required, wherein the spreadsheet is automatically populated. The data then has been collected without human error and job costing and ordering of material may be performed automatically if the template is setup to do so.

12.6 DAV Embodied as a PDA Plug-In Module.

A Distance/Area/Volume measurement module may be implemented with the tape measure attachment for connection to a PDA or other display enabled computing device (will be referred to herein as PDA for simplicity). The module in conjunction with application programming on the PDA allows for rapidly taking measurements and documenting the results. The integration of the DAV module with the PDA allows the craftsman to bring their drawings to the worksite, such as CAD generated drawings, material lists, scanned sketches, and so forth for reference while measurements may be taken for facilitating customization, custom installations and so forth.

FIG. 31 depicts a tape measurement accessory 1280, such as a DAV module, configured for insertion within a card slot of a PDA 1282. A housing 1284 for tape 1286, shown partially extended. The tape housing includes electronics for registering the extension of the tape and performing other measurement related functions. A microcontroller in tape measurement accessory 1280 controls the operation of the tape accessory and a plug in connector 1288 extends for connection to the PDA to form a measurement-capable instrument.

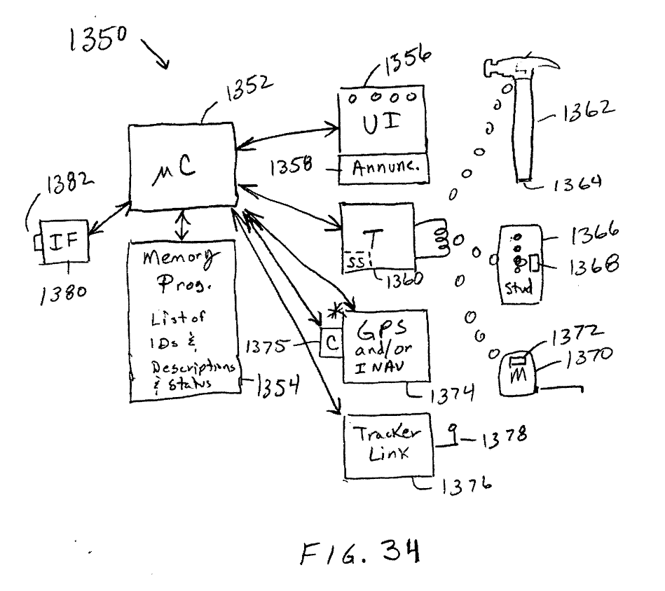

FIG. 32 depicts a controller 1290 connected for communicating with the PDA over the slot and for controlling the reading of the tape extension, as well as additional functions that may be provided within the DAV module.

An electronic reading tape measure unit is adapted 1292 for attachment to an intelligent device to which measurements may be communicated. The PDA, or other device, preferably executes an application program for receiving and storing the measurements along with any additional information for a given application of use. The application program may also have computations and other features that make use of the measurements. For example a program for generating price quotes for window treatments, floor coverings, painting, and so forth. By integrating the measurement functions a craftsperson can more readily execute a job. Furthermore, the unit can be sold cost effectively as it may be used with off the shelf or custom programming. The custom programming is easier to create than an embedded system as the applications may be developed in Basic, C, Java, or any other programming interface language associated with the operating system for the display enabled device.

The unit may be optionally configured with additional sensors that facilitate the use of the tape such as for craftspersons. The following aspects of the invention may be incorporated within the electronically read tape measure.

A tilt sensor 1294 for registering an inclination angle, the angle is preferably selectively referenced to the either the vertical or the horizontal. The tilt sensor may comprise an accelerometer or a conventional tilt switch preferably along with software executing on a controller for generating a stable consistent tilt value that is not subject to vibration, spurious movement, and related noise sources a compass 1295 wherein the direction of a particular measurement, such as in reference to a building may be indicated, i.e. south facing window. This information can aid in determining what each measure is to be used for with fewer written notes.

A GPS system 1296 may be utilized in conjunction with or as an alternative to the compass, wherein the actual location where the measurement was taken from may be registered along with the measurement. Optionally an inertial navigation system may accompany the GPS to increase the precision of the measurements, generally in reference to a given reference location, such as from the front door, or some other reference, which may be indicated by activating a control for the unit. It will be appreciated that inertial nav systems are capable of generating signals in response to positional variation and angular variation with very high precision and with the advent of MEMs technology the cost of implementing these devices is rapidly decreasing.

A camera 1297, such as preferably a low resolution unit, may be included to allow the user to take images to accompany the measurements. These images may be preferably associated with a set of measurements, or audio information optionally recorded by the user into a microphone on the PDA or on the tape unit.

It is preferably that software on the PDA allows the user to capture an image for display on the PDA, wherein the user can annotate the image using the stylus. The system should also preferably allow the user to insert measurement annotations onto the image, by first selecting the measurement annotation mode, then marking the drawing as to where the measurement is taken, and indicating a position for the measurement value to be inserted. The user then takes a given measurement or retrieves a measurement from a log of measurements previously recorded, wherein the measurement value is generated as text in the position and orientation designated by the user. The software on the PDA should preferably be configured to store the image separately from the annotation file and to link then, such as locating annotation markings according to the pixel position on the image. This allows the image to be used with or without the annotations.

A laser alignment guide 1298 may also be included in the unit for providing alignment assistance. It is preferred that the laser marker generate a series of parallel lines at a predetermined separation, which may be preferably set by the user according to the application. For example such as adjusting the spacing of four alignment beams from ⅛″ spacing up to a maximum of ½ spacing, so that the relative excursions from a base line may be easily seen according to the disruptions of the beams in the emitted pattern. The laser unit may be provided as a detachable unit or be attached to this unit by a cord. Having the laser alignment guide separate allows the user to take measurements based on the laser alignment, such as the distances from a fixed location where a structural element departs from a baseline by a given amount. In addition it allows the user to capture images of how the materials align.

The DAV module may be configured for communicating with other items for the collection of information or for status purposes. For example, the DAV may be provided with a remote communications means 1299, such as an RF transceiver, Bluetooth RF transceiver, RF transceiver associated with transponder use, infrared transceiver, and so forth.

An angle measuring device 1300 is shown as an example of a tools which communicates with the DAV module and/or attached PDA, wherein a first elongated element is rotated in relation to a second elongated element, the relative angular position of the two elements being registered with a angular position sensor, such as employing a contact grid on the first element making contact with a set of electrode pads on the second element to register the angular relationship. Alternatively it will be appreciated that optical methods and MEMs sensors may be employed for registering an angular measurement. The angular measurement device is preferably adapted with a button to allow the user to select whether an inside angular measure or outside angular measure is being taken wherein the unit adjusts the reading as registered by the hardware to compensate for the variations. The angular measurement may be transmitted continuously or on command from the angular measurement device or the DAV. As the PDA with DAV modules are expected to be located close to the angular measurement device (or other tools 1301 using the interface), the remote tool may be configured with a transponder 1302 form of communication link. The transponder in an inactive state is awakened by the receipt of inductive or RF power from the PDA or DAV module, wherein it enters a measurement mode for communicating with the PDA or DAV. If the measurement circuits can take a measurement with very little power consumption then the remote tool will not require battery power but can be powered from the received energy as stored on a capacitor. However, if greater power consumption is required, the unit can enter an active mode in which power is drawn from a battery supply, and the unit automatically deactivating after a period of non-use, or in response to a command from the PDA or DAV.

A variety of tools may be adapted to interface with the DAV unit, such as the laser module described earlier, wherein the software on the PDA can be configured by the user or automatically for accommodating the use of these devices. Furthermore, the unit may support a tool tracking feature described below to allow the user to keep track not only of tools that generate measurements to the DAV unit (or PDA) but from other tools, such as hammers, wrenches, and so forth that may be used on the job that the user does not want left on the job.

13.0 Tool Tracking with RFIDs.

13.1 Purpose.

Tools utilized in various trades are expensive, and yet they are often inadvertently left at work sites. The present invention describes a system and method for preventing these losses utilizing a tool tracking system wherein an

RFID device is placed on each tool, the presence of which is tracked by the system so that workman can assure no tools are left behind. The system may be utilized by construction workers, installers, computer technicians, doctors and medical technicians, and by other parties in various industries that have a need to keep track of a number of items, such as tools, utilized in their trade. Although the following descriptions relate to construction work it will be appreciated that the tracking unit of the invention may be utilized in a number of alternative fields.

13.2 Description of Embodiment.

The system utilizes a tracking device which executes programming that is capable of annunciating the tools being tracked. The annunciation of the device may be by means of a display or an audio annunciator. The tracking device may be implemented as a separate unit, integrated within other electronic devices (i.e. phone), or implemented as programming executing on a PDA or similar device capable of running application programming.

The tracking device generally comprises: (a) an RFID transceiver configured for challenging RFID units having a specific coding that are within range and detecting a response from those units which includes a unit code; (b) an annunciator (display and/or audio) for indicating the status of tools being tracked; (c) memory for retaining a list of tools and status for each tool; (d) a computer processor configured to execute programming for, (i) attempting communication with RFID units associated with each tool, (ii) annunciating tools from the list of tools from which a response to the challenge is not received.

Additional optional elements which may be incorporated within the tracking devices include: (a) a positioning system for registering the location of the person wearing the tracking device, such as a GPS, INAV, other system or combination of devices; (b) a communication channel configured for communicating with other tracking devices wherein tool information may be shared between tracking units.

13.3 RFID Tool Tags.

These tool tags may be fastened to a tool using adhesives or fasteners. Passive RFID units being preferably configured as substantially planar tags with an adhesive backing, which are the easiest to attach to any tool. Active RFID (containing an energy storage device such as a button cell battery) should be enclosed in a small housing for attachment to a tool. If an RFID tag uses a form of rechargeable energy storage, such as a capacitor or secondary battery, they can charge (i.e. inductively) while stored in their storage case or on the truck of the user. While stored (and receiving power) they are preferably held inactive being already accounted for. Upon being removed from that inductive field they activate to detect RF and respond accordingly. Generally, the use of active RF provides an increased range over passive RF. Passive-active unit can utilize passive for receiving RF and storing small amounts of energy which can then be used to generate responses to challenges (pings) at a farther range from which little energy is received. The type of tag used may be selectable by the user, such as based on the desired range and difficulty of retaining a tag on the tool.

Each RFID placed on a tool is associated on the tracking device with the specific tool. These RFIDs can be configured with a removable “deactivator”, such that the RFID does not become enabled until the deactivator is removed. The deactivator may be for example a shorting strip that is removed to allow the RFID to respond to challenges. Keeping them inactive before attaching to a tool, prevents any problems during setting up the device, wherein unused RFIDs respond as if they were tools.

An aspect of the present invention comprises integrating RFID units into tools for detection by user tool tracking systems, such as described. The tools can be provided in a deactivated state, and activated after purchase when the user wants to use the RFID feature. The RFID is preferably incorporated on the tool so as to maximize range, such as on the base of the insulated handle of a hammer rather than on the metal head. Alternatively, the tool manufacturer according to this aspect of the invention can provide a protective slot, recess, opening, threaded receptacle, or the like into which an RFID for use a tracker system of the invention and supplied by the user (matching their tracker unit) may be inserted.

It is preferable, but not necessary, that the tool associated with each RFID be identified to the tracker unit by a user supplied name, such as entered as a text string or a spoken name, as opposed to a generic unit ID for the RFID. For example, each RFID code can be associated with a voiced name of the article. This may be performed by articulating (voicing) a name for the article during user initialization of a tool list after applying a tag to the article. Alternatively, tool names may be entered as text strings for display on a tool list.

The RFID units utilized are coded to respond to a particular tracking unit, wherein multiple tracking units may be utilized at a given site without overlapping. Typically transponder transmissions are coded for addressing. For example, if each RFID has a unique code then the tracking unit can attempt communication with each RFID in its list of devices and each in turn responds if within range. It will be appreciated that other forms of addressing are known to those of ordinary skill in the art.

13.4 Locating Tools.

When the user wants to determine which tools are missing, they can activate the tool tracking system to list tools. The tracking unit checks for each tool and annunciates any missing tools from the list. It will be appreciated that “missing” in this context constitutes any tools not within range of the tracking unit.

The unit also preferably includes a search mode wherein the tracker continually polls for one or more missing tools allowing the user to walk about the site, wherein upon coming in range of a lost tool, the unit will alert them with audio that a tool has come into range. Furthermore, a signal strength indicator is preferably incorporated, although not necessary, which can generate indications as to whether the user is coming closer to the tool or is moving farther away. The use of positional systems for more accurate tracking of position are described below.

13.5 Flowchart.

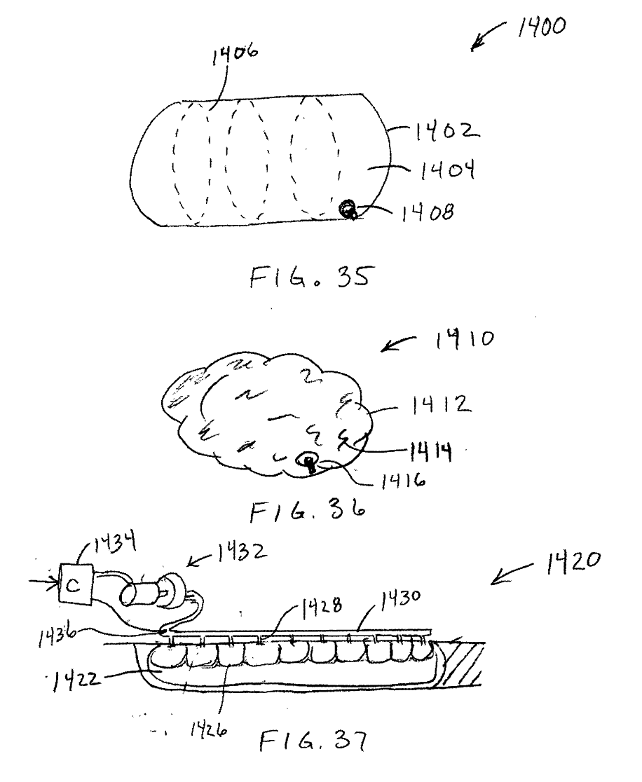

FIG. 33 illustrates an example of tool tracker operation 1310 according to an aspect of the present invention. The process starts at block 1312 when the user purchases the system and applies the RFID tags as represented by block 1314 to the tools they want to be tracked by the system. The user activates the tracker unit, selects it to scan all tools, from which a list of responding RFIDs is generated wherein the user describes each tool as per block 1316 with a textual and/or spoken name (depending on implementation). Alternatively, a description can be associated with each RFIDs as it is activated and prior to attaching to the tool. Once each tool is entered in the list then the system is ready to track the user's tools at the job site.

In use the tools are utilized conventionally per block 1318 and the user collects them at the end of their work session. The tracking system is activated as per block 1320 during tool collection process wherein the unit sends challenges out to the RFIDs on the tool list as represented by block 1322. The tracker checks for a response as per block 1324 and generates warnings as per block 1326 (display and/or audio) giving the description of the tools which are “missing” as determined by it not being within a short range of the tracker unit. Each tool is checked in succession as per block 1328, and the loop continues until all tools are found as per block 1330, when the user is satisfied and can leave.

It is preferable that the tracker unit perform a first scan (or set of scans) through the tool list locating those tools within range, wherein if it has a multiline display it can list those tools found, or alternatively those missing. If audio only then it can indicate how many are missing. On subsequent scanning, it preferably provides the warnings and allows the user to select a search mode, wherein it continues polling for the missing tools and alerts the user to their detected presence.

The signal strength returning from the tool-mounted RFID is preferably registered, so that each time a lost tool responds to the challenge transmission the relative signal strength is compared, wherein trends are reported as to whether the user is getting closer or farther from the RFID. Optionally, the antenna can be configured to provide directionality wherein the relative direction of the unit can be detected (i.e. extend an antenna, shape it for directionality, switch from a small omnidirectional antenna to a directional antenna, use a phased array of antennas in a directional mode).

13.6 Tracker Hardware.

FIG. 34 illustrates an example of a tool tracker unit 1350 shown with a computer processor (i.e. microprocessor) 1352 connected to a memory 1354 for storing programming as well as IDs on RFIDs of tools populating the tool list and associated information. A user interface 1356 is provided allowing the user to select modes of the device and control activation, selection of search mode, initial description of tools associated with each RFID, and so forth. These selections are preferably made by pressing buttons, although other inputs may be registered to control operations. The user interface is provided with at least one form of annunciator, either audio and/or display, and preferably has at least a small display and supports an audio output. The user interface also is configured to allow the user to enter a description of each tool associated with an RFID on the list, for example using keypad for entering text or a microphone for recording tool name descriptions to be used in the audio output in reference to the tools (preferably both modes are supported).

A transponder transceiver 1360 is provided for generating energy (for passive RFID tags) and a challenge signal to which RFIDs on tools within range respond which is registered. Transceiver 1360 preferably also includes a means of detecting signal strength from RFIDs that are in range, this may alternatively be performed by detuning the transmission frequency or reducing output power, wherein relative distance is related to the signal power used before a response is returned.

Examples of a few tools are shown with attached RFID tags, a heavy framing hammer 1362 with RFID 1364, studfinder 1366 with RFID 1368, twelve foot metal tape measure 1370 with RFID 1372.

Additionally, the tracker unit can be configured with a positioning system 1374, such as GPS, INAV, other positioning, or combinations thereof. The unit allows storing positions at which the status of a tool changes (i.e. range changing, out of range, etc.). This allows the user to return to a location to find the tool—as is described in the next section. Furthermore an electronic compass 1375 is preferably included wherein the unit can annunciate (display or voice) convenient directions to the user in response to the orientation of the tracker unit.

Additionally, the tracker unit can be configured with a communication link 1376 shown with antenna 1378 configured to communicate with other tracker systems, thereby allowing cooperative tool use and locating—as described in a subsequent section. This wireless interface may be utilized in other ways such as over a wireless internet connection, such as for accessing information from a web site, downloading new programming, and so forth.

Furthermore, a wired electronic interface 1380 is shown with connector 1382 (i.e. USB) wherein the tracker unit can be connected to a personal computer, PDA, or similar for transferring information and programming.

It should be appreciated that the tracker unit may be implemented as a separate unit or integrated within the functionality of other units. For example, the tracker unit can be integrated within the DAV (tape measure) described previously, wherein it forms a central tool that monitors the presence of the other tools. The present invention may be integrated within a PDA, phone, or other electronic device having a user interface and which can be configured with a transceiver for challenging RFID units and registering their responses. For example a module can be attached to a PDA for performing this functionality.

13.7 Tracking Where Tools were Laid.

Another embodiment (option) of the system utilizes a positioning system, such as a GPS unit and/or an inertial navigation system, within the tracking unit for recording where tools have been left. As a craftsman utilizes their tools they pick up the tools and lay them down at various locations over the job site. When the user finally wants to collect the tools they may leave certain ones behind. The present system stores the last location where the tools went out of range of the owner. In this way a “last known location” is stored for each tool, whether it remained in the tool box or has been picked up and moved many times at the job site.

Optionally, the unit can store locations where a change in state for the tool occurred, such as when the range to the tool began to diverge (person walked away from the tool). Also paths taken by the user carrying the tools can even be reenacted wherein the unit generates a short segment for the user to follow to find the tool, the unit having located the tools based on the last position where the user utilized the tool. A path is preferred in that the tool may not be accessible from any direction, considering the walls. By storing the path prior to the tool beginning to go out of range, the user is vectored according to their original walking path to where they utilized the tool.

The unit preferably describes the location using a display with direction arrows and short diagrams of paths, although verbal instruction could be utilized. The compass output can be utilized so that the directions are given in relation to how the tracker device is positioned, allowing the tracker to be used as a pointer to the location where the tools was last placed by the user.

It will be appreciated that current GPS accuracy is limited, wherein utilizing an inertial navigation system or a combination of GPS with inertial navigation can provide accuracy to with less than a foot. MEMs based INAV and compass systems are becoming readily available at this time at low cost while the size and cost of GPS has dropped significantly.

13.8 Cooperative Tool Management.

Another mode of the system is a cooperative mode, wherein a number of workers at the job site are utilizing compatible tracking devices, which are configured to communicate with one another. The tracking devices then communicate with one another, such that if a tool owned by a first user and entered on their tracking list, is picked up used and moved by a second user, then the tracking device will communicate the sharing, and alert the borrowing party and the lending party, preferably by means of their tool list. Furthermore, when tools are collected, the location and use by the second user is noted to the first user wherein the tools can be collected from the location of use by the second user.

By way of example this cooperative mode may be implemented as tracking units generating periodic challenges detect one another, wherein they check a list of “current neighbors”, if the other unit is not yet on that list, then the tracker units share their tools lists with one another and the associated codes of the tools for their users. Then the units track the use of tools for their owner and other owners for which they have shared a tool list. When a first user searches for a given tool, then the other tracker units are queried and return information about any of the tools that have been used or for which their tracker unit has information. By way of example, if the user walked by the tool, then the tracker unit registers that fact and informs the original user where the tool is located.

Alternatively, the tracking unit can be configured with generic challenges, allowing RFID tags from other user tools to report their presence wherein a tracking unit can track tools before obtaining an ID code list from the tracking device of the owner.

14.0 Article Retention for Auto/Plane/Boat.

To provide a means for securing articles within a moving vehicle, such as an automobile, aircraft, or boat. Two versions are described, a portable version and a integrated version.

14.1 Portable Article Retention.

This provides for the retention of articles in small spaces, such as glove boxes, drawers, storage slots and so forth.

A sealed bladder is fabricated to surround a compressible structure or material. A valve mechanism is integrated on the sealed bladder to selectively allow air to pass into or out of the bladder. The compressible structure may be a foam material, a structure such as following a spring shape, or the like, which applies a bias force on the bladder toward expansion. Unless the unit is being compressed, when the valve is opened air enters the bladder and the unit expands to the full size of the bladder. The user compresses the unit to a smaller size to insert new items into the storage compartment, and then can open the valve to expand the unit to fill the void.

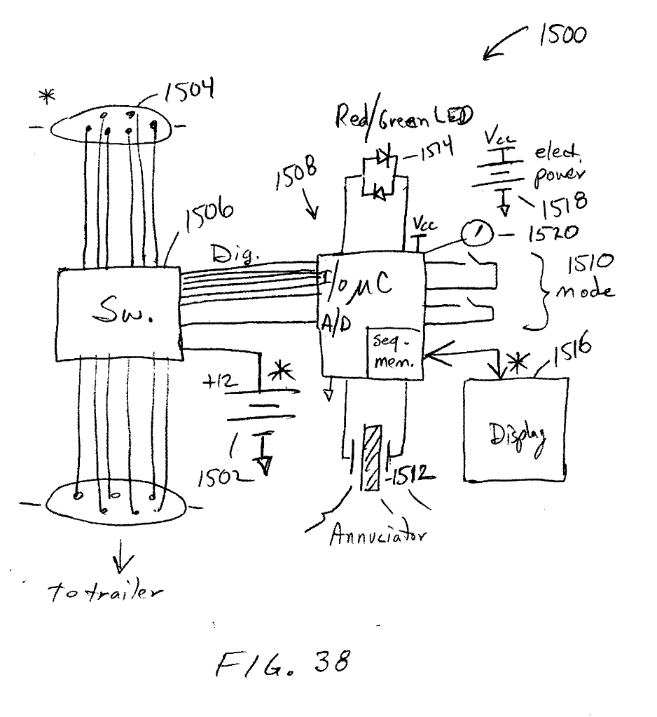

FIG. 35 and FIG. 36 depict portable article retention devices 1400 and 1410. FIG. 35 depicts an article retention device having a plastic outer layer 1402 (bladder) is sealed over a means for providing an outward bias force 1406 (i.e. such as springy plastic loop, compressible foam, or other compressible structures) which defines a volume 1404. An air flow valve 1408 can be opened so that the volume may be compressed against the bias member 1406 so that the volume taken up by the device is controlled. Valve 1408 is preferably configured to provide controlled expansion of volume 1404 wherein various number of articles and shapes can be retained. FIG. 36 depicts another portable article retention device having a flexible shape sealed exterior 1412 with a compressible interior foam 1414 and a volume control valve 1416.

14.2 Integrated Powered System.

A bladder is affixed within the portions of a storage compartment, such as a door compartment, glove compartment, trunk, package storage hold, and so forth. With the bladder is deflated, the user can load items conventionally into the storage area. Once the items are loaded, the bladder under the control of the control device, is filled wherein the bladder fills the void within the compartment and applies a slight retention pressure on the contents to prevent shifting and such. The technique may be equivalently utilized for storage containers to be loaded for shipment.

The control device is configured to operate filling and emptying of the bladder in response to user command or conditions. Preferably a fill and empty control are available for directing a filling/emptying means, such as a reversible electric pump. The fill/empty control may be implemented using switches. The pressure supplied in filling the bladder should be limited to a predetermined mount as depends on the application. The pressure limit may be an inherent characteristic of the pump wherein the controller need only activate the pump for a preset interval to fill the bladder. To empty the bladder the pump may be reversed and the air pumped from the bladder for a period of time.

The pressure may also be regulated within the bladder by the control device so that different loads or different applications may be suitably retained. This may be accomplished by measuring the air pressure within the bladder and disengaging the pump motor, and closing a seal valve to prevent leakage. An air pressure sensor may be coupled to the bladder and its electrical output received by the control device. A pressure setting limit is preferably provided, although the pressure applied may be responsive to conditions or other external parameters. For example, the pressure applied may depend on the altitude of an aircraft. The bladder pressure during filling of a bladder is checked against the pressure setting limit and the pump is deactivated to stop pump operation when the pressure reaches the user, or condition, selected pressure setting.

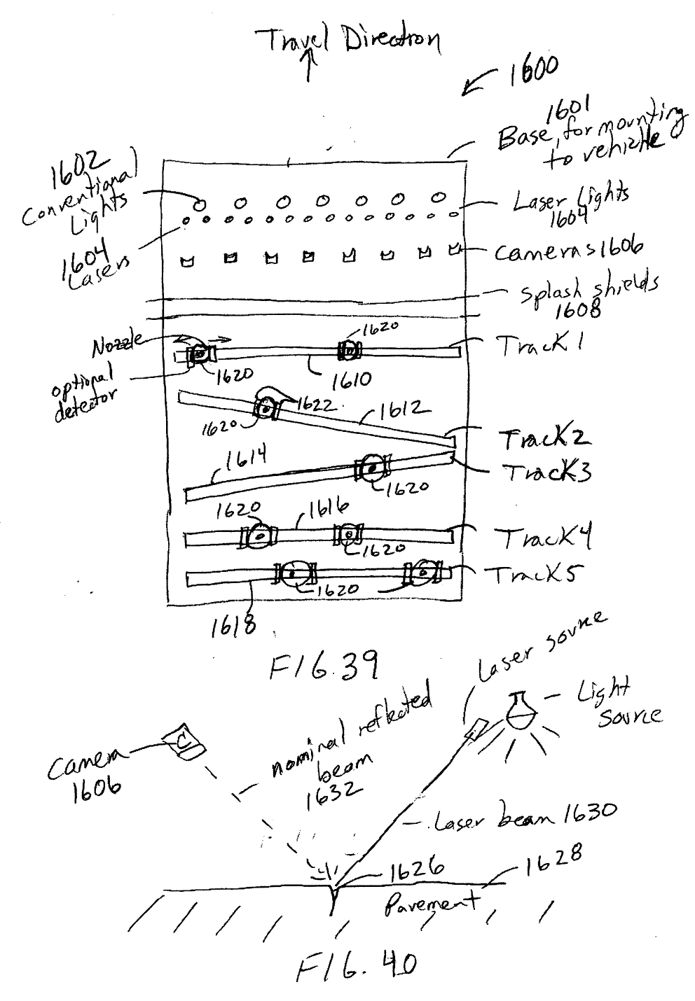

FIG. 37 depicts retention system 1420 built into the storage compartment 1422, wherein one or more inflatable cells 1426 are retained. Each inflatable cell 1426 is connected through a fluid flow passageway 1428 (i.e. tubing) with a pressure distribution manifold 1430 that connects to a small air pump 1432. A control system 1434 directs the inflation of the bladders by pump 1432 in response to user direction, or the opening and closing of a compartment, such as glove box, trunk or similar. An optional pressure sensor 1436 is provided to allow the control system to properly regulate inflation pressure.

15.0 Miniature Trailer Light Testing Device.

5.1 Purpose.

To verify the correct operation of trailer lights from a connection with the trailer power connection. It is difficult to verify the operation of the lights on trailers that are attached to a vehicle to facilitate towing. Conventionally the user has had to perform a visual inspection wherein a second party is generally involved to check each control as it is activated by the user.

15.2 Description of Embodiments.

The present invention allows the correct operation of the trailer lights to be verified more readily and with the ability to detect small changes, intermittent connections and the like. Four different embodiments are described:

15.2.1 Battery Powered Signaler.

A battery powered portable device that upon detecting no shorts between signal lines, generates lighting signals sequentially through license plate light, running lights, braking lights, backup lights, right turn signal light, left turn signal light, and any other selected light output.

This unit is a portable battery operated test unit having a power receptacle into which trailer lighting is connected. The unit provides for quickly checking trailer lighting without the need to connect the trailer to the automobile, and allows testing to be performed readily by a single individual. Upon activation power is sequenced through the trailer lights, preferably with a steady state and fast blinking on each to assure visibility even in sunlight. The power is preferably turned up from a low amp state, after detecting that no shorts exist, to a high amp state supplying conventional levels of current to the lights.

15.2.2 Battery Powered Lighting Tester.

A battery powered portable testing device that generates test pulses for driving the lights, but prior to which and during which it measures aspects of the operational lighting and reports problems. Tests can be performed without the need of the vehicle.

The light verification unit is provided in a handheld housing which provides a receptacle (connector) into which the plug from the trailer may be connected. Preferably the unit has a generic adapter into which modules that adapt the generic adapter to the specific configuration for a particular trailer (allowing different modules to be provided to suit different trailer connectors).

The unit switches a voltage across the different lighting elements and verifies that a proper amount of current flows through the wiring for each element. The unit preferably generates a low level signal voltage and checks for short circuits before generating a high current signal for testing the current flow through the light. Furthermore, the system preferably checks for shorts between the different wires to diagnose the problems that arise when wires are worn through to the respective conductors or to ground, or otherwise shorted to ground or other elements. The tests are performed and an annunciator indicates if the current for each light falls within a predetermined range of current. So that multiple conduction paths may be checked, a switching device can connect the voltage source to any of the conduction paths. A controller may be utilized for automatically switching the switching device so that all lines may be checked without manual intervention. The tests may be left operating at low speed, wherein lights are successively activated, (i.e. alternating steady output and blinking allowing the light output to be readily recognized even in bright sunlight), wherein the user can go back and visually monitor the light patterns on the trailer.

15.2.3 Light Repeater Module.

15.2.3.1 Plug-Between Light Repeater Module.

A plug-in repeater module which when plugged between the vehicle and trailer connectors detects a pattern of light activations applied by the user. And upon the user switching the mode of the device it continuously repeats that sequence of lighting drawing power from the vehicle running light output (headlights set to on) which is directed to each of the lights following the pattern input by the user. Allows user to plug in the unit, press the vehicle pedals, get out, switch the unit into repeat mode, then keep walking to back of trailer where they can see the repeating sequence of lighting. The unit tests the vehicle light outputs indirectly because it will not repeat signals which are below the lighting voltage threshold, wherein the lack of certain lights is indicative of a failure in either the trailer or vehicle. When done testing the user simply removes the unit from between the vehicle and trailer. The unit preferably provides periodic audio signals and optional LED outputs from the unit while connected as a reminder to users that the unit is still connected.

15.2.3.1 Integrated Light Repeater Function.

The functions of the above repeater module may be incorporated into a vehicle receptacle, wherein a repeater mode is accessed, such as by means of activating a switch on the device to enter repeater mode to accept inputs, and then another position wherein the inputs are repeated to the lighting system.

Alternatively, the unit need not actually “repeat” the sequence when in a repeater mode but may be configured to generate its own sequenced output on each output when placed in the correct mode. The sequenced output can be made to only output power to those connections for which power was recently triggered by pressing the associated pedals in the vehicle.

15.2.4 Integrated Light Sequencer and/or Tester.

15.2.4.1 Sequencing Lights.

A light testing unit built into the vehicle power connection receptacle which can autonomously outputs lighting signals to trailer lights in response to user selection.

15.2.4.2 Testing of Light Signals.

In this embodiment, the unit tests the outputs from the vehicle, tests the circuits to the trailer, indicate problems with the lighting system thus detected, and generate outputs to view trailer lighting, and is preferably adapted for checking the current levels being supplied to said trailer and storing values for current for future comparison to detect corroded connections and so forth. Unit can determine the connections and establish baselines and thresholds for current flow for each path, against which future measurements may be compared.

15.3 Generalized Embodiment.

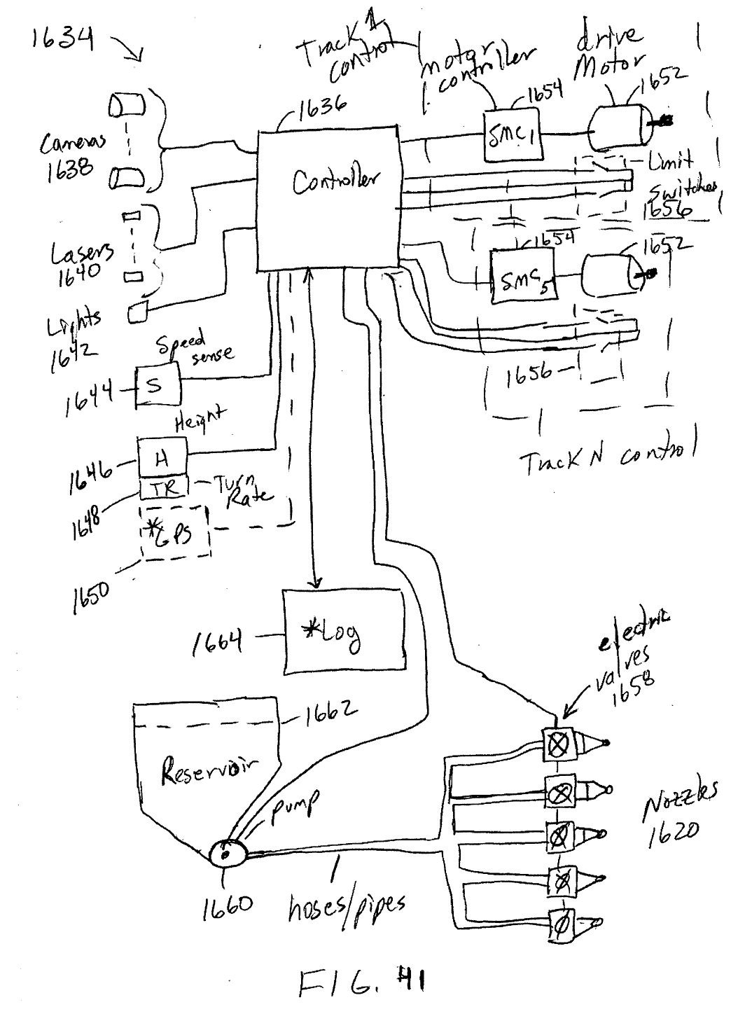

FIG. 38 illustrates a generalized embodiment 1500 of the invention, which can be reconfigured to fulfill the functions of any of the embodiments described above. Although the system may be implemented by one of ordinary skill according to the functional descriptions above, the schematic provides a basis from which these embodiments may be created.

Light test unit 1500 can be powered by a battery source 1502 or from a connection to the receptacle on the vehicle lighting system. A switching matrix 1506 is configured to allow the signals to be passed through directly, or interconnected under the control of microcontroller 1508. To perform more sophisticated testing the switching matrix 1506 is further configured for routing signals through a resistance for measuring current, connecting high impedance power between connections to detect shorts, and so forth depending on the application. Microcontroller 1508 preferably contains memory for storing sequences and parameters regarding operation. User inputs 1510 allow for selecting the mode of operation for the unit, while an audio annunciator 1512 can generate error indications, reminders of unit still plugged in and so forth. A simple Red/Green indicator is shown 1514 for indicating some status conditions when a more complex display is not utilized. A more complex display (LCD, eInk, OLED, etc) is shown 1516 upon which measurements and full details on operating details may be displayed in response to control from microcontroller 1508. A battery power source 1518 is preferably provided for powering the microcontroller and optionally to retain memory on the microcontroller in the case where measurements on the system are compared from one time to another. A selector 1520 is optionally provided wherein parameters for different vehicles may be stored for comparison purposes.

15.4 General Description of Invention.

An apparatus for verifying that the lights on an automobile trailers are operating correctly, comprising: (a) a housing; (b) a connector adapted for establishing an electrical connection with the lighting receptacle plug from a trailer; (c) a voltage source adapted for generating a voltage across selected connections; (d) a current sensor adapted to sense current flow through said connections in response to the voltage generated by said voltage source; (e) a controller connected to said current source and adapted to sense if said current flow is within a predetermined range of current; and (f) an annunciator operatively coupled to said controller and adapted to indicate if the current draw through said connections is within a predetermined range.

Some additional aspects of the invention being listed in a hierarchical order as follows:

Wherein said apparatus is portable and sufficiently small as to be easily held in one hand.

Wherein said apparatus is powered from a power source within or connected to said apparatus.

Wherein said apparatus is powered from power retention devices within said housing.

Wherein said power retention devices may be selected from the group of power retention devices consisting of batteries, fuel cells, capacitors, or combinations thereof.

Wherein said capacitors may be charged from an external source of power.

Wherein said external source of power comprises the charge current supplied from a vehicle power connection.

Wherein said vehicle power connection comprises a cigarette lighter receptacle.

Wherein said voltage source comprises the voltage supplied from said power source.

Wherein said voltage source comprises the voltage from said power source after passing through a voltage regulator.

Wherein said current sensor comprises a sense resistor from said voltage source, wherein the voltage drop across said sense resistor is indicative of the current flow.

Wherein said current sensor comprises a current sensing element that provides an output in response to the level of current flow.

Wherein said current sensor comprises an inductive sensor.

Further comprising a switching device wherein said voltage source may be connected to any of a plurality of trailer lights.

Wherein said switching device is operated manually.

Wherein said switching device is operated by said controller, in response to user input to said controller.

Wherein said switching device is operated by said controller and automatically switches said voltage source between connections on said lighting receptacle.

Wherein said switching device is adapted to perform said automatic switching sequentially through a series of connections to apply said voltage source to trailer lighting elements.

Wherein said series of connections comprises each of the available lighting circuits within said lighting receptacle.

Wherein said trailer lights may be selected from the group of lighting elements consisting of: running lights, brake lights, turn signals, reverse lights, left turn signal, and right turn signal.

further comprising non-volatile data storage operatively coupled to said controller for storing configuration information for said apparatus.

Wherein said configuration information includes information as to which connections are to be tested.

Wherein said configuration information includes current values for selected connections.

Wherein said current values comprise nominal current values that may be read by said controller when determining if said current flow is within a predetermined range of current.

Wherein said controller comprises one or more digital circuit elements selected from the group of digital circuit elements consisting of microcontrollers, microprocessors, gate arrays, programmable logic elements, custom circuitry containing digital circuitry, discrete logic circuits, and combinations thereof.

Wherein said controller comprises a processing element and programming for,

operating said switching element to select which trailer light connection said voltage source is to be applied,

registering said current from said current sensor,

comparing said current value with a predetermined threshold current value,

activating an annunciator in response to the result of said comparison.

Wherein said annunciator comprises a display adapted to provide visual indications of whether said current falls within said predetermined range.

Wherein said annunciator comprises an audio annunciator adapted to generate indications of whether said current falls within said predetermined range.

Wherein said display comprises indicator elements which light up or change appearance to provide visual indications as to whether said sensed current has fallen within the predetermined range.

Wherein said display comprises a display adapted for displaying icons, numbers, textual information, or combinations thereof.

Wherein said display comprises LED indicator elements.

Wherein said display comprises an LCD display.

Wherein said display comprises an electronic ink display.

16.0 Automated Pav m nt Crack Sealing.

A system for speeding the repair of cracked pavement. The apparatus detects and automatically dispenses paving material and sealants, such as tar, onto pavement cracks as the apparatus travels along a section of roadway, or other area covered with a pavement. The system may be mounted under a truck bed or on a separate towed platform. The apparatus eliminates the need for having a crew that manually applies a sealer, filler, or similar liquid repair material to the cracks and small voids found in the roadway surface.

The pavement that the apparatus is considered to operate on are those such as asphalt, concrete, and other forms of paving material that are subject to cracking and voids which should be filled, for instance to prevent further damage from erosion and freezing damage. These paving material are generally referred to as pavements, which is the term that will be used herein to describe the above materials as applied to roadways, walkways, bikeway, steps, paths, driveways, and similar applications.

The apparatus may detect the cracks and voids, and other disruptions in the roadway surface using mechanical or optical elements, or a combination thereof. An optical means is generally preferred as it is not sensitive to the vibrations and movements of the base of the apparatus as it moves over the roadway surface. The optical means may comprise cameras or photosensitive arrays that can detect one or more sources of light. Combining a collimated source with a traditional spread light source can increase discernment of cracks and voids if the collimated light is positioned to reflect from an unbroken surface toward the camera, or other optical elements.

An electronic controller, such as a microprocessor or other computer device, is configured to interpret the signals from the optical element, and/or mechanical feelers, wherein it uses signal or image processing techniques to ascertain if and where cracks and voids exist along the pavement, as well as estimated the amount of material per unit length of a crack or in a void, which are mapped within the memory. It will be appreciated that large voids, such as potholes, should be filled with other forms of material, wherein the apparatus recognizes that the amount required would exceed a predetermined threshold and does no dispense material into the large void. Preferably the unit maps the location of the large voids, which may be communicated to other maintenance workers immediately or at a later time.

Nozzles are mounted on moving translation stages following the crack/void detector and may be positioned to intercept and follow the pattern of the crack, or to otherwise fill voids. The translations stages may provide Cartesian or polar movements of the nozzles, for example the nozzles may be adapted to move along tracks, or to be connected along single or multi-jointed arms along which one or more nozzles is coupled. The use of tracks is preferred as it may be easier to follow a crack using a track that is oriented substantially laterally in relation to the longitudinal direction of travel over the pavement. The controller can position the nozzles and activate a flow control assembly to control the location and amount of liquid repair material being dispensed. The controller receives inputs as to any critical determiners that affect the placement and amount of material dispensed. The determiners preferably comprise velocity, height (above roadway surface, curvatures etc.), and turn Additional information may be optionally utilized to improve dispensing such as outside temperature, pavement temperature, wind speed and direction. The apparatus preferably logs all work done on the roadway surface so that the condition of all roads over which the apparatus has been utilized may be maintained in a central database. A position recognition device, such as a GPS, inertial navigation unit, or preferably a combination GPS inertial navigation unit, can provide position information to be recorded in a data base with particulars about the repairs performed. It is preferable that data concerning the repairs be logged, such as coordinate mapping of the repairs along with quantity values for dispensment (a three dimensional data set). Logging of mapping data allows the conditions of roadways to be maintained in a database. The apparatus also preferably maps out any other elements of the pavement that need attentions, such as the pot holes described earlier. This data may be used to alert personal to other conditions of the roadway. Images taken by the cameras on the apparatus of these other conditions may also be stored to aid personnel in evaluating the need for the work or for determining what is needed to repair the problem.

One or more optional sensors may be located at each nozzle to assure that it properly tracks the center of the crack, wherein the accuracy of the camera and computer computations can be relaxed. For example a dual channel sensor can be used wherein the nozzle, once generally set to the position to intercept the crack locates maintains the crack on the centerline of dispensing material by moving the nozzle to maintain equal lighting situations on either side of the crack. This may be performed with a camera, with optical elements, or with mechanical feelers.

The unit may be optionally configured to additionally dispense other materials, such as sand for covering the repaired spots.

FIG. 39 depicts a preferred embodiment 1600 of the underside of a base 1601 containing sensing, positioning, and dispensement. A set of conventional lighting 1602 lights up an area of the pavement which is augmented by collimated (laser) lighting 1604 to aid in crack edge detection. A set of low resolution (inexpensive) cameras 1606 registers the locations of cracks and voids, preferably creating a three dimensional data set of both location and an estimated amount of material to be dispensed.

Two splash shields 1608 are shown to reduce the chances for the dispensed material to splatter or be carried by the wind to the crack/void detection sensors, exemplified by the optical elements.

A plurality of tracks 1610, 1612, 1614, 1616, 1618, are depicted upon which nozzles 1620 may be moved. Inclusion of a plurality of nozzles and tracks allows a number of complex cracks on a pavement surface to be simultaneously repaired. The use of two nozzles on the lateral tracks increases the ability of the units to track a crack. For example, suppose a crack crosses the roadway and either diverges or converges, the dual nozzles are positioned by the controller to intercept where the crack starts as the unit travels along the surface and to track the convergence (nozzles moving from the outside toward inside), or divergence (nozzles moving from some inside position toward the outside) of the cracks. The slanted tracks facilitate the repair of a crack that may be aligned substantially laterally across the roadway, wherein the slant allows time for the nozzle to move laterally as the apparatus is moving longitudinally so as to maintain sync with the crack. Each nozzle unit is shown with optional sensor heads 1622 to maintain positioning on a crack, or void, as mapped out by the sensor elements and controller.

The nozzles may be driven along the track with individual motors and may receive power and signal from the track or control cables therein. It should be appreciated that any convenient method may be utilized for positioning the nozzles relative to the apparatus.

FIG. 40 depicts the use of the collimated light source 1604 generating a beam 1630 in helping to detect the edges of cracks or voids 1626 on the pavement 1628. The reflection 1632 of the collimated source are interrupted by a crack or void which aid in discerning the presence and depth of the crack.

FIG. 41 depicts an embodiment of the electronics 1634 within the apparatus. A controller 1636 is shown such as a computer processing system with program and data memory, A/D inputs, I/O, programmable interval timers, and image signal processing capabilities that may be provided on an auxiliary DSP processor. Controller 1636 is shown connected to a plurality of cameras 1638, laser lights 1640, and conventional lights 1642, and also receives a speed signal from a speed sensor 1644, height signal from a height detector 1646, turn rate signal from a turn rate sensor 1648, and optional GPS/INS information 1650.

Based on interpretations of the images, controller 1636 operates a set of motors 1652 through motor controllers 1654 such as stepping motor controllers for moving the nozzles along the track. Shown along with the motors are optional end track switches 1656 for detecting if the nozzle has reached the end of a track or has contacted the other nozzle. Controller 1636 is shown connecting to individual valves 1658 proximal to the nozzles 1620 for regulating the dispensing of the fluid repair material. Controller 1636 may adjust the flow rate of material from the nozzle as well as turning it on and off. Optionally the controller may control the operation of a pump 1660 so that the pressure of the repair material may be regulated from reservoir 1662. Optionally the controller can control a heater to regulate the temperature of the repair material so that it is kept at optimum temperature.

A log 1664 is shown into which data may be retained about the repairs. Preferably this data is immediately or periodically uploaded to a central system, wherein statistics about the roads may be automatically maintained in addition to the roadway surface itself.

The present invention may also be practiced in less expensive embodiments, wherein the sensing portion of the device can track fewer cracks. The system may be implemented to provide the full automatic use as described or to augment manual operations.

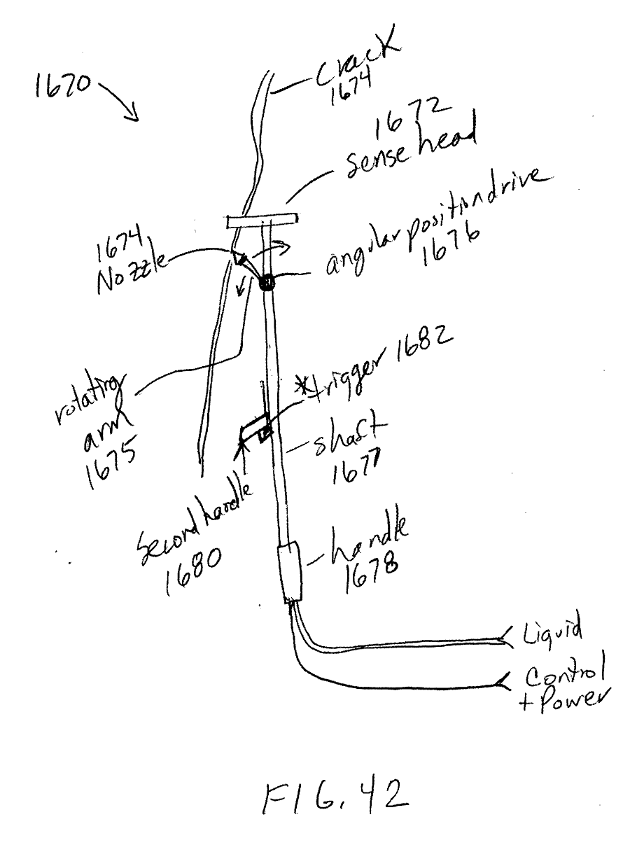

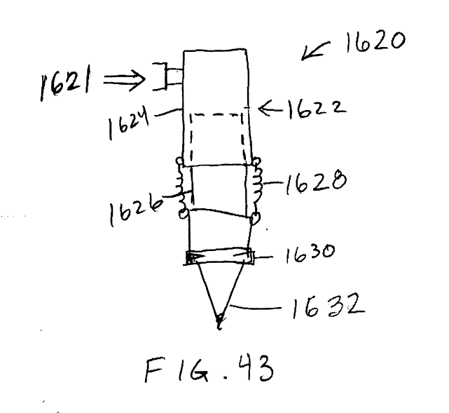

FIG. 42 depicts a manual applicator 1670 being supplied with liquid sealant, such as from a reservoir, and operating power. The manual applicator is enhanced according to the present invention. The user applying sealant to the crack need only move the sense head 1672 over the crack or void wherein the nozzle 1674 will be automatically aligned with the center of the crack by a rotating arm 1675 driven by angular position drive 1676 whose position is modulated in response to sensing the location of the crack by sense head 1672. The sense head can preferably detect the location of the crack optically, such as utilizing the array of lasers or other optical elements and detectors for detecting changes in reflected light associated with the presence of the crack.

Optional replaceable cover sheets preferably are retained over the optics of the sense head, wherein should the area of the sense head be splattered, a simple swap of the cover sheet removes the material. Covers sheets may comprise a transparent plastic held in a frame that slides into slots retaining the cover over the sense head optics. Alternative means of cleaning may be additionally or optionally provided.

A sense head 1672 is shown on the end of a shaft 1677 adapted with insulated handles 1678, 1680 for being held by the user. An insulated first handle 1678 and second handle 1680 are shown with second handle 1680 including a trigger 1682 to allow the user to control the amount of material dispensed into the crack. It should be appreciated that the dispensing control may be controlled by the system itself, or modulated in response to user input, or provide full user control. The device is shown with a liquid hose connecting to a source of liquid repair material and one or more cables for the routing of power and signals to the unit.

It should be appreciated that the user need not hold the unit with much precision as the nozzle position will be automatically retained along the crack in response to information from the sense head. Alternatively, the sense head itself may be connected to the nozzle itself wherein the nozzle retains its own alignment. The sense head can process the data locally, or remotely, for determining crack location. The processing is similar to the described previously, however, on a reduced scale.

It will be appreciated that the embodiments were shown by way of example and that one of ordinary skill in the art may provide a number alternative implementation details without departing from the teachings of the present invention.

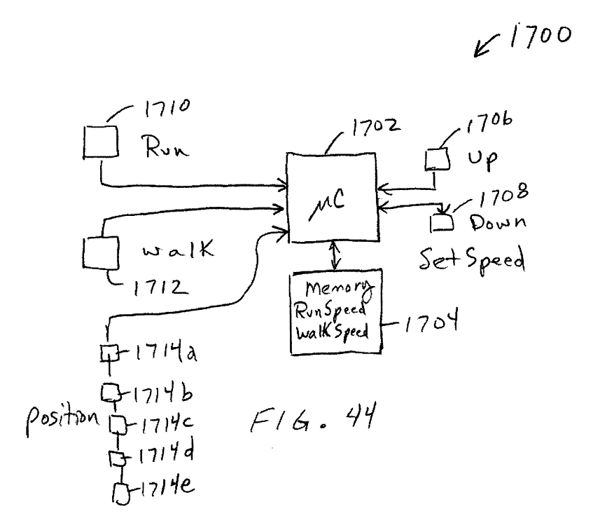

FIG. 43 depicts a nozzle 1620 with a receptacle 1621 for receiving sealant and configured with a variable volume reservoir 1622 comprising an outer cylinder 1624 slidably engaged over inner cylinder 1626. The variable volume reservoir is biased by means 1628, such as a spring, or an actuator controlled by the microcontroller. Biasing means 1628 applies pressure on the retained fluid so that the pressure is maintained during dispensing the sealant. The fluid in the reservoir is available to be switched through control valve 1630 for passing through nozzle 1632.

This adaptation allows for maintaining a more constant pressure of sealant at the nozzle. It will be appreciated that the sealant supply lines have a significant resistance to the flow of sealant, wherein the pressure at the nozzle when open and dispensing fluid drops as a result of this fluid resistance. The variable volume reservoir acts in a similar manner as an electrical capacitor to retain a volume of fluid at the point of use to reduce fluctuations in pressure and dispensing rate.

17.0 Treadmill Run/Walk Controller.

When using a treadmill the user may want to alternatively walk and run. Current treadmills, however, require that the user change the speed of the unit, such as by pressing and holding down an “up” speed button. This is very inconvenient for alternating between running and walking.

The unit stores multiple speed and incline values, such as for running and walking that the user may select immediately with a single button press. The user can run and then hit a walk button and the device slows to the programmed walking speed. The user may program a number of profiles that are immediately accessible, such as for hill climbing, catching one's breath, or flat out running.

FIG. 44 illustrates an example embodiment 1700 of the invention, wherein a processing element 1702 with memory 1704 for controlling the operations of a treadmill is configured with controls for setting speed of travel, depicted as up button 1706, and down button 1708. The present invention adds buttons to allow the user to quickly switch between run and walking speed via run button 1710 and walk button 1712. The device preferably starts on the default walk speed, wherein the user utilizes the up controls to set the desired walking speed. After warming up, as the user decides they wish to run they press the run button 1710. The lowest speed for the run setting is equal to the current setting for the walking speed, wherein no speed change occurs immediately. They then press the speed up button 1706 until the desired running speed is attained. Two speed values are retained in memory 1704 one for the current user selected running speed, and one for the current user selected walking speed.

The user can quickly switch between the two speeds at the press of a button. Preferably processor 1702 is programmed to make non-abrupt speed changes between the running and walking settings so that user can adapt readily.

Another aspect of the invention is the automatic sensing of speed based n the position of the user on the track. If they start slipping towards the back of he unit it slows slightly and continues to slow so long as they are in that area. If hey are at the extreme forward position then the device speeds slightly so long as they remain in that area. This provides a more natural speed changing without user having to attempt button pressing. Also it increase the safety of the unit. A set of position sensors 1714a-1714e are shown coupled to processor 1702 whose programming is configured to reduce the programmed speed as the user position drops farther toward the rear of the unit, and conversely speeding up as the user moves forward. In this way the user is less prone to falling from the rear or striking the front of the treadmill.

Another aspect of the invention is the sensing if a user is still active on the treadmill. If user pressure is no longer felt for a sufficient period of time, such as 1.5 seconds, then the unit enters pause mode and the treadmill is stopped immediately. This reduces the chance of a user falling and getting caught the mechanism or of leaving the machine on and attempting to remount the machine when it is operating at speed.

Position sensors 1714a-1714e also detect if the user is still on the treadmill. If no user is detected then the machine should quickly come to a pause, allowing the user to restart if desired. Light sensors may also be used to detect if the user has left the treadmill. For example a light sensor at chest level can detect a fallen user, wherein even if pressure is applied to the moving deck the treadmill action is paused.

18.0 M tered Output Sports Bottle (MSBs).

To provide a regulated amount of fluid for the athlete during a run or other use. The runner can more accurately control liquid intake to reduce problems with bloating or getting too little liquid to replenish themselves. Furthermore, the device does facilitate the conservation and/or sharing of a beverage between individuals (in particular siblings).

A metered quantity of liquid is provided with each use. The metered amount may be provided per tip, or is preferably controlled using a regulating selector input, such as a push button, wherein a metered amount may be received in response to each press of the button.

May be implemented on conventional sport bottles that require tipping for gravity feed of liquids or with sport bottles having a straw device from which liquid is received.

18.1 Embodiments of the Metered Sports Bottle.

The following exemplifies a number of embodiments that may be implemented for the MSB—it should be appreciated that a number of alternative embodiments may be implemented by one of ordinary skill in the art without departing from the teachings of the present invention.

18.1.1 Pull-Stem Valve Metered Sports Bottle.

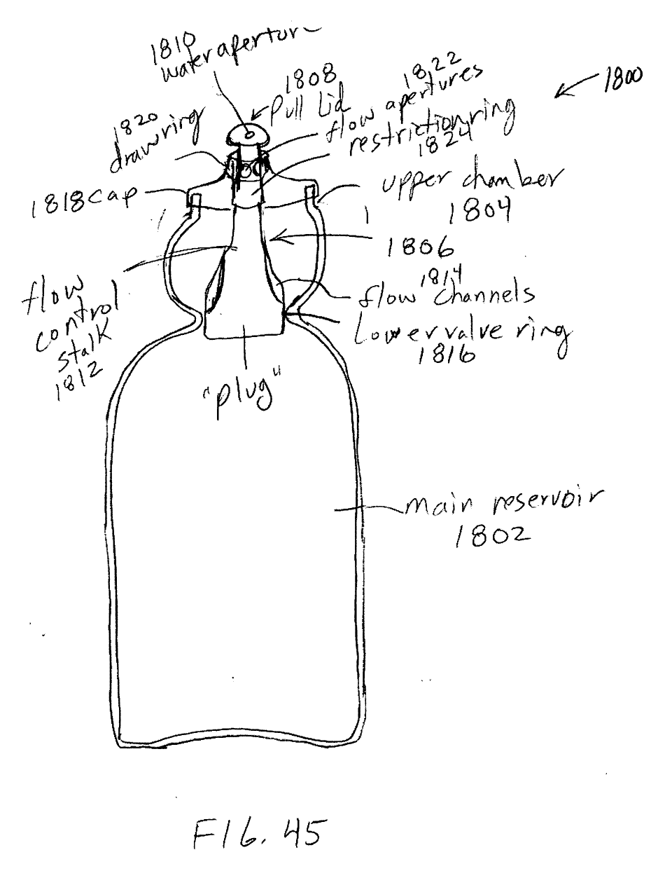

FIG. 45 illustrates an example embodiment of a metered sports bottle 1800, having a main reservoir 1802 upper reservoir 1804, containing the metered quantity. A valve 1806 is shown within upper chamber 1804 which controls the flow of liquid from the lower chamber 1802. Valve 1806 comprises a pull lid 1808 with fluid aperture 1810 that connects to a flow control stalk 1812, the lower portion of which has flow channels 1814, and a lower valve ring 1816 for sealing the upper reservoir off from the lower reservoir. Valve 1806 passes through a cap 1818 that attaches to the mouth of upper chamber 1804, having a draw ring 1820, flow apertures 1822 to let air into the unit and restriction ring 1824 to control stalk travel.

To receive metered quantities of liquid, the user tips the bottle up which fills the upper reservoir by means of the flow channels. Then the user extends pull lid 1808 with water aperture 1810 which seals off lower chamber 1802 wherein water may only be drawn from the upper chamber. The user is thus limited to drinking the amount of fluid retained in the upper reservoir. If the user wants another metered quantity the close the valve with the water bottle inverted which quickly refills the upper chamber so when opened another quantity is ready for consumption. It should be appreciated that this design when closed is as leak-proof as a conventional sport bottle, preventing sticky sports drinks and the like from staining clothing, or vehicles when the bottles are transported.

Valve 1806 may be configured with detents in the open and closed position wherein the user can not achieve intermediate positions wherein water could leak between the upper and lower chamber.

The embodiment of the figure can be readily manufactured. When in the closed position, the flow apertures within the cylindrical section connected to the pull lid slide into a restriction ring which blocks water flow through the water aperture. The flow control stalk extends down from the pull lid into a valve mechanism. The valve is here shown as deep flow channels on the exterior of the stalk which are engaged in the lower valve ring.

When the pull lid is in the down position the flow channels bridge the main reservoir and the upper chamber allowing water to flow down into the upper chamber and air to flow in the opposing direction. When the pull lid is extended the upper valve opens flow through the water aperture while the plug portion of the stalk prevents water from flowing from the main reservoir to the upper chamber, thereby metering the quantity of water to the liquid in the upper chamber. The user must close the pull lid for the upper chamber to refill before again opening it to receive another metered quantity of liquid.

It will be appreciated that the closing and opening operation is generally performed by the users teeth once the bottle is inverted and placed to the mouth wherein the opening and closing is a natural operation with conventional sport bottles. The large size of the lower plug allows the water to readily be transferred to the upper chamber without delay, so that the user will get a fill metered quantity of water.

18.1.2 Bladder Style Metered Sports Bottle.

A bladder may be utilized within the sports bottle with a structure (exterior or interior) that is biased toward a full position. The user presses the valve to open output valve and close the valve to the bladder from liquid below. Liquid is drawn from bladder, which contains a metered amount. Upon release of the button, the top valve closes and the bottom one opens whereby the bladder refills automatically. This structure may be utilized with sport bottles, such as those having a straw which need not be tipped for gaining access to their contents.

18.1.3 Other Embodiments of Metered Sports Bottle.

The metering of fluid from the sports bottle may also be controlled in a number of alternative ways without departing from the teachings herein. For example, the metering may be controlled electronically wherein a flow sensor is coupled to an electronic controller which regulates the operation of one or more valves. For example biasing a fluid valve a closed position and energizing a section of muscle wire for pulling the valve open only until the metered quantity has been output, whereafter the current through the muscle wire is relaxed and the valve under the bias force closes. The unit may be set for any amount of fluid to be dispensed per operation. Furthermore the unit can provide alerts to remind the user when to take additional liquids, and can track fluids that have been metered out.

It should be appreciated that the present invention may be implemented in a number of alternative ways without departing from the present invention. Specifically the valve and valve control mechanisms may be implemented using any convenient form of valve controls for metering the liquid from the sport bottle.

18.2 Additional Aspects.

The MSBs can support selected, or even variable chamber sizes. Variable chamber sizes allow the user to set the quantity metered with each use by adjusting the chamber size. This may be facilitated by the selective inclusion of one or more sealed-volume members being retained within the upper chamber to reduce the available liquid. For example, on simple method of accomplishing this is to include an air fillable bladder in the upper chamber to displace a desired amount of liquid to reduce usable chamber volume.

19.0 Sports Bottle with R s rve.

To provide sports bottles with a reserve capacity for emergencies. The present invention incorporates a reserve of water within a sports bottle. This feature may be utilized separately or in conjunction with the metering feature described above. It will be appreciated that in various sport bottle uses, such as competitions, the fluid in the sports bottle may be emptied to quench thirst whereas the user later may have a dire need for water and have none available.

It is important to pace one's drinking, to meet with the circumstances, but one should also have some small quantity of water in reserve for emergencies, (i.e. something flies in your mouth, severe dry mouth, etc.). The present invention incorporates a reserve of liquid that can not be easily accessed by the normal drinking process from a sports bottle. The reserve feature may be configured for providing access to the capacity by any desired procedure. Two embodiments are provided by way of example, although a number of alternatives may be implemented by one of ordinary skill in the art without departing from the teachings of the present invention.

19.1 Embodiments of a Sports Bottle with Reserve Capacity.

FIG. 46 depicts a sports bottle 1900 with reservoir 1902, cap 1904, and exemplified with a conventional pull-top lid 1906. A lower chamber 1908, beneath main chamber 1902, provides a reserve quantity of water which is accessible through valve 1910. The user opens valve 1910 for filling the sports bottle and then closes it. Lower chamber 1908 is rotated in relation to upper chamber 1902 to open valve 1910. Additional impediments to opening the valve may be provided to dissuade use under any but dire circumstances, for example requiring a complex motion, taping over the seam between the sections, and so forth. During use the normal contents above the reserve may be utilized first as accessed through the spout-nozzle, but the user must rotate the lower portion of the unit to open the valve to gain access to the reserve. Accessing the reserve is a two handed operation and can dissuade overly quick use of the reserve.

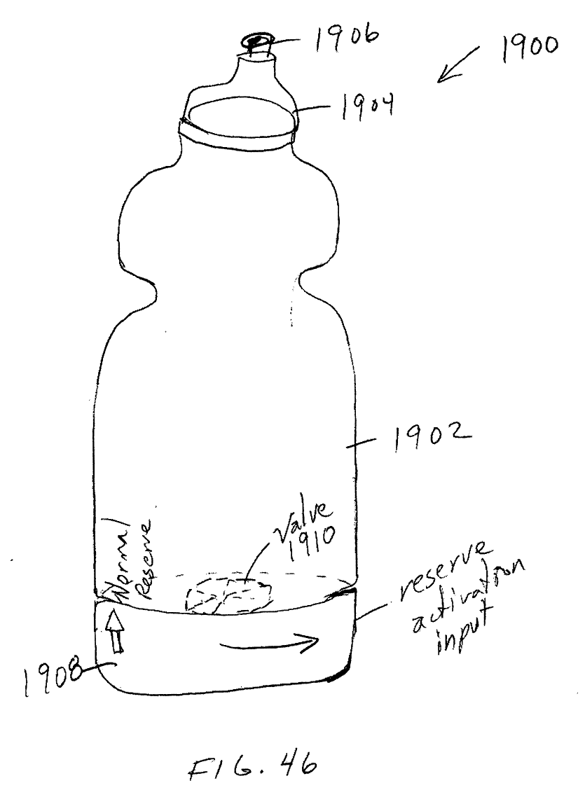

FIG. 47 depicts another embodiment 1930 may be readily created by providing a screw on lower chamber/base that the user can fill with water. A top sports bottle 1932 is configured with threaded base 1934 and preferably a seal 1936. A lower reservoir 1938 with threaded upper portion 1940 is configured for filling with fluid 1942 prior to being sealably joined to the upper portion 1932. In this way the user can decide if they want the extra contents. While access to the extra contents is difficult in that it is partaken off from the “cup” portion itself. This provides an additional advantage though, in that the user may share the lower cup portion to someone else that is in need of emergency water without the fear of passing germs to one another. The reserve capacity may be added to sports bottles that also provide the metered feature described above.

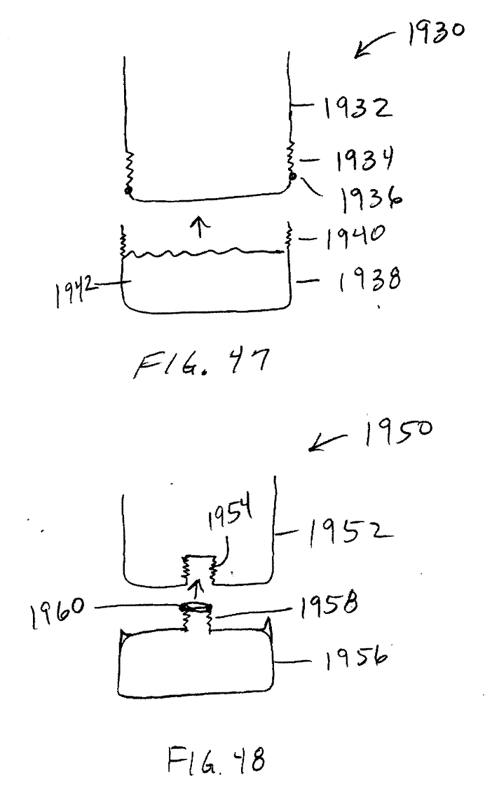

FIG. 48 depicts another embodiment 1950 having an upper reservoir 1952 with a threaded recess 1954. A lower container 1956 having a threaded neck 1958 and preferably a seal 1960 is configured for threading into the base of upper portion 1952 to retain the reserve water for use by the person or someone else. It will be appreciated that it is easier to drink from the spout herein without spilling the contents.

The above embodiments were provided by way of example and it should be appreciated that the reserve capacity for the sports bottle may be implemented in a number of alternative ways without departing from the teachings of the present invention.

20.1 Suspension Visor.

20.1 Purpose.

To provide a visor (or mount for other head worn devices) that provides one handed tension adjustment with enhanced ventilation and movable pressure pads.

20.2 Background.

Typical frames for visors, face shields, and so forth are constructed of a stiff material that applies pressure to the sides of the head so that the associated head worn device (visor, glasses, face shield) may be properly retained in a precise location. However, these frames provide little ventilation and the area where the frame is being retained is subject to becoming overheated.

Often when using a conventional frame, the pressure being applied to the head of the wearer may be excessive causing discomfort, or too loose wherein it may fall off or correct positioning may be compromised. Some visors therefore have incorporated adjustment mechanisms such as locking hinges that allow the extended support arms to be adjusted according to size or comfort. The sizing of these frames may be adjusted according to a set number of predetermined positions. The tension is adjusted by altering the geometry of the frame thereby increasing or decreasing the tension pressure generated at the ends of the frame. It is difficult however to find a comfortable sizing and what is comfortable at first often becomes to tight or loose as time goes by and conditions, such as wind change. In order to change the adjustment, the user must remove the frame and take one more notch tighter or looser and hope for the best. The discrete nature of such adjustments based on ratchet engagements makes finding a comfortable setting difficult, while the dynamic nature of conditions that lead to swelling or to counteract wind make it troublesome to change the settings often.

20.3 Summary.

The present invention provides solutions to a number of problems associated with current visor frames designs. The suspension visor frame utilizes a structural visor frame that preferably provides a head pressure that is toward the maximum tension required for retention under any condition for any sized head. The actual tension applied, however, is controlled by a suspension system of elongated tension members, such as belts, cords, wire, line, string, and so forth, whose tension opposes that of the structural frame. The pressure applied to the head of the wearer is thereby continuously adjustable without the need of removing the visor frame from the head of the user.

A structural frame is configured with, or for insertion of, bridge supports at selected locations along its length. Elongated tension members are connected near the distal ends of the frame that pass over the bridge supports. It will be appreciated that the tension in the elongated tension members operates to increased radius of curvature and thereby lessons the pressure applied by the ends of the frame. A means for adjusting the tension in the elongated tension members thereby allows for continuous changes to the frame size and fit.

Another aspect of the invention improves ventilation by providing a suspended strip of material on the inner arc of the frame with an air gap between it and the structural frame. The strip of material may be lightweight, breathable, and air is allowed to circulate to the head of the wearer. This aspect of the invention may be utilized within the present invention or may be combined with conventional frame designs to increase ventilation.

Another aspect of the invention provides for movable pads on the inner arc of the frame so that the user may adjust these to regain comfort as time elapses. It will be appreciated that most head worn devices has substantially fixed geometry wherein the pressure on the head of the wearer is also fixed.

Over time with the pressure applied to the same locations, the nerves get sensitized and discomfort increases. The present frame, however, allows the user to move these pads so that different locations on the head are subject to the retention forces. The pads may be constructed of conventional compressible materials, such as foam pads, although the use of memory foam is preferred in that pressure may be substantially equalized at the point of contact while the material is porous and capable of wicking up moisture. This aspect of the invention may be utilized within the present invention or may be combined with conventional frame designs to reduce wearer fatigue and the soreness that may result from extended wear of the head mounted device.

Another aspect of the invention allows the sizing of the frame to automatically adjust to conditions. By utilizing an elongated tension member that contracts in response to increases in temperature the headset can decrease the applied tension as the head swells as temperature increases. Alternatively materials may be incorporated at other areas to autoadjust the headset, such as changing the tension applied at the adjuster. It is contemplated that the tension may also be adjusted in response to the wind speed. It will be appreciated that the optimum tension for which a visor is adjusted is dependent on the weight of the head worn device to be supported and the force being applied by the wind to the visor. The tension of the elongated tension member may be adjusted in response to wind speed by coupling a wind driven vane element with a tensioning member, or by electronically sensing the wind speed and adjusting tension accordingly. It will be appreciated however, that a conveniently mounted tension adjuster as provided within the present invention allows the user to very readily adjust the tension in response to changes in wind conditions, wherein the exotic wind responsive tension adjusters should not be necessary.

Another aspect of the invention allows for reversing the direction of the bill of the visor. With a conventional visor this would not provide any benefit, however, if the user has distributed the soft supports asymmetrically, then filling the cap and reversing the bill portion allows the pressure being applied to be changed without even moving the soft supports. This may be implemented by fastening the bill at its two outer edges and then flexing the frame support to open the visor frame (larger) wherein the interfering portion of the bill can then be flipped to the opposite side of the frame. This aspect may be utilized with visor, and is particularly well suited to visors that have, or can be set, asymmetrically about the head, wherein a different pressure pattern is created by reversing the visor and flipping the bill to the opposing side.

It is also contemplated that the visor may be equipped with a periscope that is integrated within the bill, so that a simple flip down of a first mirror assembly directs the users gaze up to a second mirror assembly from which the scene is reflected down the periscope to the user. The periscope may be implemented, or adjusted, for viewing straight-ahead, but on a higher lever or canted upward for viewing areas of the sky without neck strain, such as would be desirable at an air show.

20.4 Description of Example Embodiments.

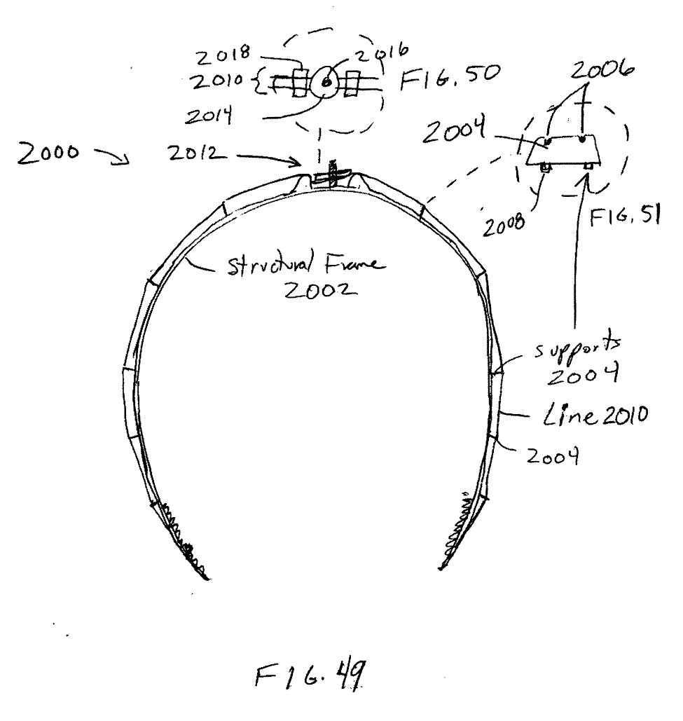

FIG. 49, FIG. 50, and FIG. 51 illustrate an example of an embodiment for a continuously adjustable visor frame 2000. The visor frame comprises a structural frame 2002, such as fabricated from plastic, metal, or other form retaining springy material. Supports 2004 extend from frame 2002 at intervals about a large portion (at least approximately 50%) of the frame circumference and more preferably close to 90%. Supports 2004 are shown configured for supporting a string, cord, band, or similar elongated member which is compliant in at least one axis.

In a preferred configuration support 2004 is configured with two grooves 2006 (apertures, slots, channels, etc.) as seen in the detail view of FIG. 51, for retaining a pair of elongated tension members. The supports are depicted in a configuration wherein they separate from frame 2002, and attach by means of stubs 2008 protruding from the bottom sides for insertion into the sides of the structural member, allowing the supports to be repositioned as desired, and so that optional adjustable pressure pads are not constrained in their movements.

The elongated tension members 2010 preferably comprise a non-conductive material, such as monofilament line, Kevlar thread, or similar material having a breaking strength in excess of about 10-20 pounds. The elongated members are attached near the ends of the structural frame, such as by tying, by fastening, by clamping. One or more elongated tension members 2010 may be utilized although the use of at least two can reduce the material of the structural frame by applying a balanced tension.

Changing the tension on tension members 2010 changes the pressure applied by the frame 2002 against the head of the user. The tension members operate in a similar manner to the principles of a suspension bridge. It will be noted that the shape of the frame can change in response to the tension changes and that modifying the amount of flex along the span of frame 2002 that the shape change can be controlled.

The tension applied by tension members 2010 can be adjusted with an inline means like a turnbuckle, an end connector, or any other convenient mechanism. The adjusters may be located anywhere along the span of the line. However, it is preferred for many applications to provide an easily accessible tension adjuster wherein a single control allows adjusting the tension on both tension members. By way of example a front adjuster 2012 is shown which adjusts the tension in both lines simultaneously by rotating a single control knob 2014 as readily seen in FIG. 50 that moves along a shaft 2016 to increase or decrease tension on the lines 2010 underneath supported on supports 2018, shown having an enlarged width for strength. Preferably the knob is configured with left hand threads so that the conventional nut tightening direction of clockwise will actually loosen the knob to increase the pressure applied by the visor frame.

The tensioner may be implemented in a number of alternative ways, such as twisting the wire on a bellcrank or similar, or in any manner changing the length of the path of the elongated tension members.

Another unusual benefit of the design is that the tensioned elongated members can be strummed to produce musical notes in a similar manner to a guitar. To enhance this guitar use feature the center span may be made with a large gap between supports, a plurality of strings may be included, and the tensioning member may be offset so that different notes may be played on either side of the tensioning member.

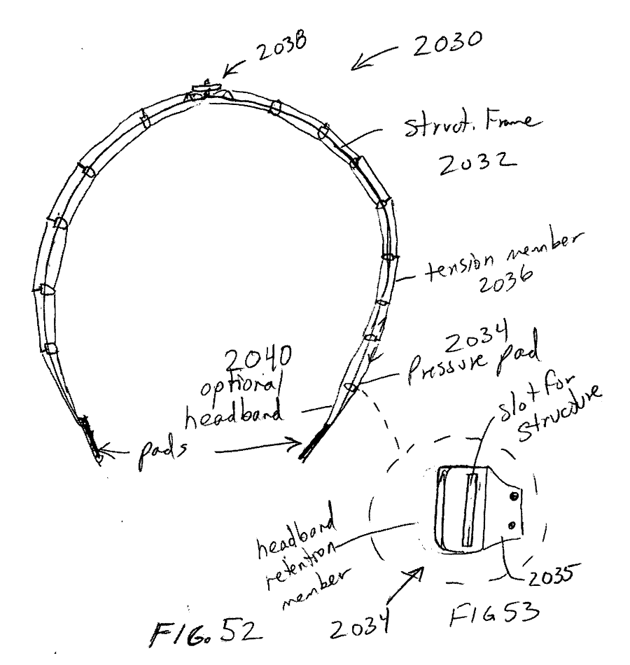

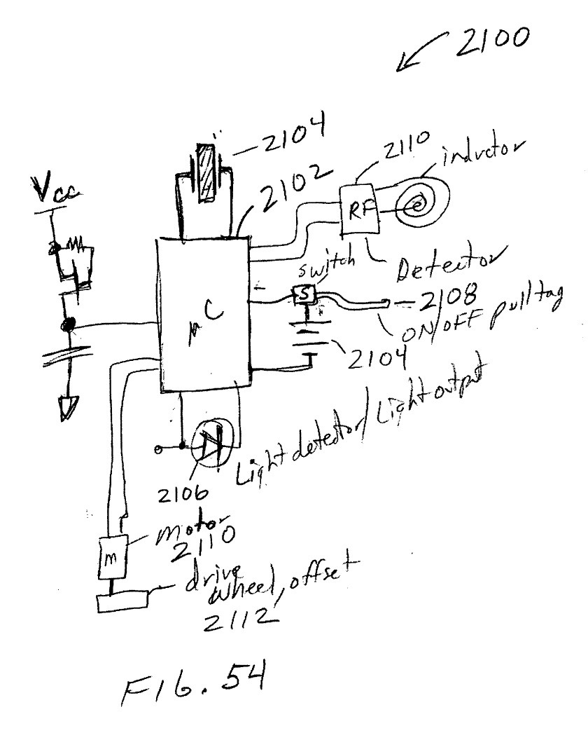

FIG. 52 depicts another embodiment 2030 of a suspension visor frame with a structural frame 2032 having slidable pressure pads 2034 seen in FIG. 53, installed along the inside of the arc, with support portions 2035 for supporting tension members 2036, the tension of which is adjusted with knob 2038. In addition an optional inner headband 2040 is shown threaded through the pressure pads to provide a headband so that all the retention pressure is borne by the pressure pads. The headband is preferably fabricated of a cotton cloth or other absorbent, and/or ventilated material. The pressure pads are preferably constructed of memory foam, as are the pads at the distal end of the support arms for the frame.

For the sake of clarity, the features in FIG. 49 and FIG. 52 were shown separated, however, the present invention is preferably practiced with all the described options to achieve maximum comfort and convenience.

It should also be appreciated that the structural members may be directed toward the interior of the frame with interior tensioning members, such as a sweat band, wherein increasing tension causes the frame to tighten on the head of the wearer.

21.0 Cr epettes—Autoresponsive Electronic Soundwave Stinkbombs

21.1 Summary.

Entertaining toy product that may be readily hidden and that generates audio (and/or less preferably light) in response to time and/or environmental conditions. These toys are configured to provide a harmless soundwave “stinkbomb”, that may be used for “bugging” other children or for use in various urban seeking games, such as are becoming popular using GPS tracking technology, however, scaled down to the technical and price level for children. These toys generally are configured with wheels, free wheeling or driven, to simplify placement of the units or driven as an output mode.

The devices are preferably shaped as a small insect, rodent, animal, or fictional creatures, and are referred to herein as a “Creepette”. Each Creepette contains microelectronics and preferably occupies less than one cubic inch, and more preferably less than one-quarter cubic inch, wherein they may be easily hidden. The units do not provide an alphanumeric or graphic display, or a substantial on-device user interface.

Units are configured with a self contained power supply, either a battery or capacitor. Battery power may be provided by small primarily cells such as alkaline or lithium. Alternatively, power may be supplied from a super capacitor within the unit that is coupled to charging mechanism, such as a connection, or power received through an inductive loop such as generated by the locator unit. Power is preferably activated on the unit by pulling on an extending, which alternatively extends or retracts on successive pulls to enter an ON or OFF state. Other modes of activation may be provided, such as a push button, or based on charging from a locator unit. The units need not have replaceable batteries, they can be disposable.

The units may be configured to respond to different aspects of the environment such as light, heat, RF signal, electromagnetic flux, sound, vibration, acceleration, and so forth, along with the passage of time. Each unit is equipped with one or more of these senses and an output device.

The Creepettes may provide any of a variety of outputs, for example in the form of sound, light, motion or combinations thereof.

In use the user activates the Creepette device, such as pulling its tail, wherein a short activation output signal is annunciated, such as a short audio sequence, or light flashing. The unit then enters a placement mode wherein it delays for a predetermined period of time, such as from approximately 2-5 minutes, whereafter it enters an active state to provide its given environmentally and/or time sensitive function. Once active the unit may awakened based on environment and time to generate sound effects, and/or lighting effects.

To facilitate locating the Creepettes, your own or those placed by others, each unit preferably includes an inductive or RF circuit that is sensitive to a signal generated by a locator unit at a reasonably close proximity, such as up to 3-5 feet. On pressing a button on the locator is signal is sent that is received by the Creepette, wherein it responds giving a short location marker sound (and/or light). The period of time between subsequent triggers is preferably limited, such as to more than about 10-20 seconds, wherein some challenge still remains to finding the Creepette unit. Locating the Creepette devices may utilize all the modes described above for the finding of tools using the tool tracker device, which is incorporated herein by reference. Once found, the tag (may appear as a tail or antenna on some models) is pulled to disengage power and thus deactivate the unit. Furthermore, the units preferably will not respond to the signal from the locator unless they have been activated by the environment at least once. In this way a preemptive search will not yield results until units have been able to perform their task as least once.

The responsive sound (and/or light) emitted by the Creepette is similar to the game of “Marco Polo” played by children in a pool wherein a child with his eyes closed shouts out “Marco” and each player is required to return with the response “Polo”, such that the “blinded” child may locate and tag one of the other players. The responsive sound in the Creepette unit may be configured to generate an annunciation that is responsive to the signal strength, or even relative location, of the signal being received, wherein the user receives feedback that is responsive to the correctness of their search (getting cooler or hotter).

Each of the units is preferably configured with LED eyes that light up to provide additional feedback in addition to the sound effects generated. These are preferably implemented as a single SMT LED coupled to a light pipe that directs the light to the eyes. Alternatively other forms of lighting may be provided.

A few examples being described below, however, it should be appreciated that a wide variety of variations may be implemented using combinations of the inputs and outputs for the devices.

Cantankerous Cricket:

Randomly generates short bursts of a pseudo-cricket like sound, and then returns to an inactive state. For example, the sounds bursts are limited to from 5-8 seconds and spaced a minimum of 5-10 minutes apart with the timing between bursts being random, such that up to over an hour could elapse with no sounds being generated.

Spooky Salamander:

The unit senses the onset of darkness (LEDs may be used in a light sensing mode, or optical sensor coupled to processor) and then randomly generates creepy sounds, such as creaking, moaning, wailing, and so forth. Periodically it energizes a small motor that drives an offset wheel device which thumps on the ground a number of times although it preferably does not move the very far, such as in a circle only. The sound of the thumping as the wheel strikes the floor or other acoustic surface adding to the effects of the unit.

Urban Jungle Commando:

Shaped like a soldier in a prone position holding a rifle. After a long period of inactivity the unit “comes out of hiding” to fulfill its mission. On a random basis the unit awakes and in response to sounds it will generate an urban commando sound effects, such as a gunshot(s), mortar round sound(s), sounds of tanks, sounds of aircraft and so forth. It preferably adjusts its sound threshold so that it generates sound effects separated by a number of minutes apart.

Tanks For Nuttin:

Shaped as a miniature tank with an operating motor drive, preferably a simple compliant wheel under the device (cheaper than driving tank treads). When activated by vibrations, such as walking the unit engages its engine and drives forward replete with engine sounds and canon firing sounds. The path taken by the unit is preferably selectable as straight or circular. The firing sounds may be generated in response to light vibrations, whereas the activation of the engine may require heavier vibrations.

Plate Edge Cookaracha:

This unit after its setup delay is configured with a motor and has a default program that upon sensing a significant vibration, parties moving a table when they sit down to eat, the unit emits a very slight set of sounds at a very low volume, followed by a low volume after which it scurries out at full speed and begins emitting a cacaphony of sounds. Obviously the name is derived from its use.

Submersible Squid:

This unit can be submerged, such as in a can of soda. It senses tilting after activation and generates an output vibration periodically. The vibration can be created by a motor with an offset weight, such as used in pagers and so forth. The tentacles on the squid are preferably flexible to simplify inserting the unit into a “situation”.

Malicous Mosquito:

This unit has the outward appearance of a really fat and ugly mosquito. When it is dark it then senses when the environment reaches a time of silence, such as the person falls asleep, wherein it activates to generate mosquito buzzing sounds. It stops and retriggers itself periodically based on the sound conditions, and low lighting conditions.

Gassy Grasshopper:

The unit is configured with a spring loaded launching base which is activated according to time delay, light intensity and so forth. When triggered the eyes light up and “flatulence” sound is generated as the base is activated to launch the unit up and in a forward direction, whereafter it continues with its gassy serenade.

Running Grenade:

Shaped as a clear grenade with a motorized set of wheel, or wind up wheels triggered into action. The unit contains a high intensity light source, such as LED, incandescent, strobe light, or similar and a high intensity sound source. The unit need not be located as it is a one time firing unit. At a random, or set time, after being activated the unit engages the motor drive and zooms out of hiding as it engages its bright lights, preferably flashing, and emits large explosive sound effects. It stops after a certain amount of time.

Pugnacious Pen:

Shaped as a fat writing pen, and may have conventional pen workings, the unit is configured to be hidden with other pens and writing implements. Set to generate “Uggghh” sounds at random intervals.

Giggly Glowbug:

The unit is configured with a base that can adhere to surfaces such as windows, walls, and furniture, such as using suction cup devices, adhesives, and so forth. It is configured with a plurality of lighting elements throughout its generally clear body. Once the registered lighting intensity drops below a given threshold it then randomly activates wherein the lights are put in motion, preferably with different colors, (similar effect as floats in the Disneyland Electric Parade), and it emits a giggling sound. The unit should remain activated after being triggered, until the user powers it off.

Burpin Bed Buddy:

A heat activated unit that when it warms up to sufficiently close to body temperature, begins randomly emitting various burping sounds.

Sound Scorpion:

Shaped as a scorpion and configured to sense sounds and to add additional background sounds ONLY when a sufficient sound level is reached. The allowable minimum time between sounds limits sound output. The types of sounds generated are variable, such as hissing, boos, tapping, and so forth.

Ghastly Candywrapper, That Darn Fly!!, Angry Hornet, Widget Woodpecker, etc. etc.

Hundreds of inventive combinations of body styles and response personalities may be created such that the children will collect them for various situations. Using slightly more expensive electronics the units may be configured to generate spoken audio, such as jokes, or phrases, and to be made responsive to selected events, such as certain things being said or sound ranges within the environment.

The Creepettes may be sold preprogrammed for various personalities, such as described above. In addition the personality of each unit may be completely or partially programmed by the user. The inclusion of an RF receiver, or more preferably inductive loop, allows the unit to receive a series of programming signals for establishing simple programming of the unit. Preferably these characteristics may be downloaded to the locator unit, such as over a USB cable, from the web site of the manufacturer. The user can be lead through a set up screen for each type of Creepette that they want to program, wherein they can set the various parameters for the device, such as time delays, types of sounds generated, length of generated sound, volume, activity level, responsivity to environment, type of triggering, use of mechanical output or light, and so forth. The user may also select from a set of precreated profiles with catchy names, wherein the users need not select individual parameters but can “morph” their unit to perform other functions. It will be appreciated that the Creepettes may be manufactured with a single circuit and even body, and programmed to perform the various functions, however, it is contemplated that the identification of a body shape with its function will enhance the entertainment value of the units, and promote sales of additional units.

Typically, the system would be sold with a base pack containing a locator device and a few stock Creepettes, wherein additional Creepettes, or sets of them may be purchased for use with the locator. It should be appreciated that hundreds of different shapes, and personalities may be created, wherein the purchasers can use their imagination on how to deploy the devices.

Although the preferred approach of programming using an inductive loop has been described it will be appreciated that the units may be programmed by means of a wired connection, audio registered over the audio transducer in a detection mode, or other conventional forms of communication, such as switches and so forth.

Games may be played using the devices, wherein a unit is set to put out a sound in response to a given cue such as audio, or even by time, wherein persons are expected to find the units. This is similar to the game of Marco-Polo often played by children. The children use their locators to then find each of the units.

The units may be configured to operate in concert, wherein one unit may signal another nearby unit, such that they may be triggered in concert with one another. This can add confusion when sounds appear to be heard from displaced locations.

21.2 Description of Embodiments.

FIG. 54 illustrates by way of example embodiment a simple creepette controller circuit 2100 wherein an inexpensive microcontroller (i.e. 4 or 8 bit) 2102 with battery power 2104. An audio transducer 2104 and LED output 2106 are preferably provided. Power to the unit is preferably controlled by a pull-on pull-off power switch 2108 mechanism, although any convenient means of activation may be less preferably utilized. The unit is shown connected to an inexpensive RFID transponder unit 2110 which may be used to trigger the device to facilitate locating it with a locator unit.

It will be appreciated that simple circuits may be connected to the microcontroller 2102 for sensing various environmental variables as described above to suit a given personality for a Creepette. It is preferred within this embodiment that piezoelectric device 2104 can be utilized in both a conventional output mode, and in an input mode wherein the voltage output in response to ambient sound can be detected in the microprocessor for triggering actions of the creepette. Similarly, output LED 2106 can be utilized in an input mode because light on the P-N junction results in a small voltage being generated. Programmable I/O on the microprocessor allows the use of these devices in either an input of output mode. Sensing is preferably performed using analog-to-digital inputs on the microprocessor due to the low voltages generated by either device when in an input mode.

An optional motor 2110 (or muscle wire) is shown for causing the device to move via a drive wheel 2112, or to otherwise exhibit a mechanized personality.

The controller is preferably configured with a low power sleep mode that allows the unit to remain, “at station” for long periods of time, waking up periodically to sense the environment and generally to perform a random number generation from which it is determined if and how the unit should activate.

21.3 Addition Aspects of Invention.

ON switch—a pull cord/string/membrane.

RFID locating—each unit may be equipped an RFID tag that allows the unit to respond to a locator that is programmed for the device. The owner may then locate the devices.

Locator and optional power unit if capacitor powered. My be in the form of a keychain activator (optional locator)—Examples: (a) a strip of PCB with contacts inserted to active the unit, (b) magnetic triggers.

Optionally programmed by audio such as over a phone, or from an audio port or speaker.

Tagged with owners name—Tagged so finder can return to user, or for emblazoning other messages. Examples of tag forms include: a band as for birds, a rolled up elongated tag, (e.g. from Tyvex™ material).

Rollers to allow rolling into hard to reach locations.

Magnetic coupling—unit with ferromagnetic material or magnet so that a rod equipped with a magnet can be used to retrieve units located in hard to reach places.

22.0 Patrolling Fishing Lure.

To provide a self-powered lure that moves about a given station to attract fish. A lure is adapted with a propulsion unit and lighting, with sound being optionally provided. The lure is configured to be slightly buoyant and held down in the water by a sinker of sufficient weight. It will be appreciated that a conventional lure is configured to sink. The very slight buoyancy, which may be user adjusted for the desired depth, (such as by adding small spheres to a weight compartment) allows the unit to float up above the weight wherein the propulsion unit drives its movement in a circle above the lure to attract fish to bite it.

Propulsion may be provided using a propeller driven by a motor, or a set of internal turbine blades driven by a motor, or by any other desired and preferably inexpensive means.

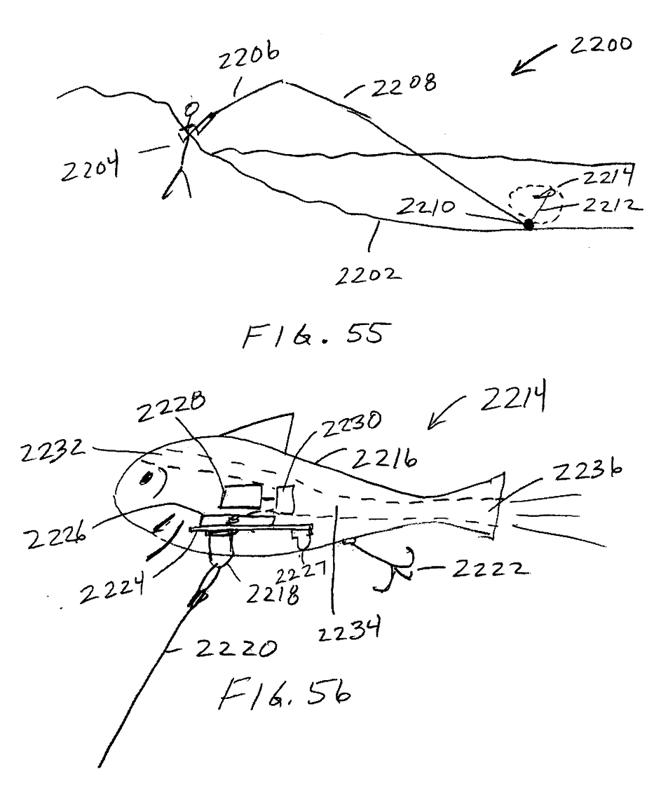

FIG. 55 illustrates an example 2200 of a method of utilizing the patrolling lure wherein a body of water having a bottom 2202 is being fished by user 2204. The user has cast out their line 2208, with a weight 2210 to which are attached leader 2212 with patrolling lure 2214, with fishing pole 2206. Once resting on the bottom, the patrolling lure 2214 rises up to apply tension to leader 2212. Preferably after a delay period after being submersed in the water the power on the unit activates.

Patrolling lure 2214 is shown comprising a housing 2216 in the shape of a small bait item, such as a minnow or the like, having an underside attachment 2218 configured for connecting a the leader line 2220. The housing is slightly positively buoyant wherein it floats above the sinker 2210 having sufficient mass to counteract the buoyancy. On or more hooks 2222 is attached to the housing for hooking a fish that bites patrolling lure 2214. A circuit 2224 draws power from a power source 2226 such as a battery or capacitor. A light source 2227, such an LED, or OLED strip, is preferable connected to circuit 2224 for outputting light so that the unit is more readily seen by fish. A motor 2228 is connected through circuit 2224 and drives a propeller, or in this case a ducted fan 2230 to which fluid is communicated via an intake passageway 2232 to a central chamber 2234, and out through outlet passage 2236. The use of a ducted mechanism causing the sound to emanate from the interior of the device to appear more lifelike and to reduce the chance of entanglements from exposed propellers.

Circuit 2224 is configured to drive lighting, optional audio transducers, and optionally to cycle motor power on and off periodically, or randomly to change the motion pattern of the unit wherein it appears more lifelike and likely to be taken as bait.

An external switch, or a sufficient tug on attachment 2218 configured as a switch, engages power to the unit through a switch, such as a MOSFET having positive feedback wherein it stays ON for a given period of time, as determined by the control circuit, without further pressure on the power switch.

23.0 Color Changing Fishing Lure.

To increase the attention paid to a lure by fish proximal to the lure, the exterior of at least a portion of the housing incorporates color changing materials (color change terms used generically to include any visible optical changes including intensity change, shade changing, reflectivity changing, and so forth). Examples of such material include both electronic ink or polymeric OLEDs.

The lure device may be configured conventionally, it may provide the patrolling feature as described above, or it may utilize a battery and a control circuit which modulates the colors and patterns generated on the color changing materials.

By way of example, to increase attractiveness to fish, the exterior of the lure is provided with electronic ink spheres with electrodes on the interior and exterior of the material. Method for controlling electronic ink being described in a patent application by the same inventor, Ser. No. ______ filed Jul. 1, 2003 describing electronic ink utilization.

An electronic circuit, such as a sequencer or microcontroller, within the lure generates a voltage across the electronic ink electrodes to vary the coloring of the surface of the lure wherein the device is more attractive to fish. By joining the electronic ink spheres (at a low enough density to prevent blocking of all light) onto a transparent or semi-transparent housing a light in the interior may be provided to increase recognition and additional effects.

FIG. 56 illustrates a lure housing 2216 with a battery 2226 and a control circuit 2224. At least one output from control circuit 2224 may be coupled to electrodes that stimulate optical property changes in an electronic ink, or that drive pixels in OLED material, or other optical property changing material disposed about all or portions of the exterior of the lure. By dividing the color changing material into sections which are separately driven, the exterior of the unit may be made to glimmer in the water appearing like movement and skin reflections and further luring fish with a more attractive appearance.

It should be appreciated that a number of alternative material may be utilized whose optical properties can be visibly modulated in response to electric stimulation, these material may be substituted herein without departing from the teachings of the present invention.

24.0 Limitations of Embodiment Exemplifications.

It should be appreciated that the embodiments of the inventions described herein are examples of the inventions, and no attempt is made to disclose every variation of the invention which can be created by one of ordinary skill in the art based on the teachings of the invention.

The aspects, modes, embodiments, variations, and features described are considered beneficial to the embodiments described or select applications or uses; but are illustrative of the invention wherein they may be left off or substituted for without departing from the scope of the invention.

Moreover, systems and methods according to the various embodiments of the invention described may be provided with all with all of features described herein, or only portions thereof, which combinations may be sold together or separately. In this regard, such systems and methods may be “adapted to” include or otherwise couple to such equipment without departing from the intended scope hereof.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus for outputting signals from a marker buoy, comprising:
a laser light source configured for projecting at least one beam of light;
housing for retaining said collimated light source, and configured for attachment to a buoy;
electromechanical actuators for varying the horizontal and vertical angle of said collimated light source;
a tilt sensor;
a control system which generates signals to modulate the movement of said electromechanical actuators in response to signals from said tilt sensor to maintain desired directions of light projections despite buoy motion;
an electronic compass for registering compass orientation from which buoy horizontal orientation and the horizontal direction of devices coupled to said buoy may be determined;
a means for directing a beam of audio sounds and/or speech in a selected horizontal (compass) angle from said apparatus and dispersed over a horizontal angle from ten degrees to thirty degrees;
wherein said audio sounds and/or speech generated is responsive to the horizontal (compass) direction from the buoy giving listeners an indication of angular position in relation to said buoy;
sensors for registering the status of said apparatus and/or systems coupled to said buoy;
sensors for registering ambient conditions at said buoy;
wherein said sensors are selected from the group of ambient sensors consisting of air temperature, fog intensity, fog distance, humidity, wind speed, wind direction, sky obscuration, wave activity, water temperature, light intensity, audio transducers and video imagers;
a radio frequency communications link configured for conveying sensor data from said apparatus at said buoy and for receiving remote control commands to said apparatus.

2. An apparatus as recited in claim 1:
further comprising a large area display covering at least one square foot of the exterior of said buoy and configured for indicating conditions detected by said apparatus;
wherein said large area display is a non-volatile display;
wherein said display comprises an electronic ink display.

3. An apparatus for powering a marker buoy comprising:
an electrical generator configured to generate an electrical current in response to a mechanical input;
wherein said electrical generator is configured for mounting on a marker buoy;
a mechanical coupling attaching the mechanical input of said generator to an fixed anchor or to an elongated member joining to said fixed anchor;
an electrical energy storage device;
a power system for receiving energy from said electrical generator and conditioning it for storage on said electrical energy storage device; and
a solar collector assembly coupled to said power system, for converting ambient light energy to electrical energy for storage on said electrical energy storage device;
wherein said mechanical input is a lever arm extending from said generator.

4. An apparatus for powering a marker buoy comprising:
a fuel tank configured for retention in the base of a buoy;
a fuel cell for converting chemical energy from the fuel in said fuel tank to electrical energy, said fuel cell configured for secure retention in the base of said buoy;
an electrical energy storage device configured for temporarily storing electrical energy from said fuel cell;
fuel level sensor configured to generate a signal in response to retained fuel level; and
a circuit for communicating said retained fuel level indication over a radio communication link to a remote location.

5. An apparatus for preventing loss of synchronization on a vehicle driven by multiple propellers through a fluid, comprising:
means for sensing fluid motion along the hull of said vehicle proceeding toward the propellers;
means for estimating fluid motion conditions that will occur at said propellers in response to pressure gradient measurements; and
means for rapidly altering the rotational speed of the propellers based on said fluid motion estimation to maintain synchronization between propellers.

6. A method of controlling propeller speed when maintaining synchronization, comprising:
(a) estimating the necessary load compensation to prevent synchronization loss;
wherein said estimates are based on measured fluid flow patterns;
(b) varying the field current in generators in response to said load compensation signals;
wherein said generators are mechanically coupled to the rotating outputs driving said propellers.

7. A method for maintaining timeclocks in synchronization, comprising:
(a) modifying a power output signal at predetermined times;
(b) drawing power from the output for operating a clock or time-keeping device;
(c) detecting said modification of said power output; and
(d) adjusting said clock or time-keeping device according to the difference between the time being kept and the time associated with the predetermined time.

8. An apparatus for providing a comfortable resting position, comprising:
a flexible base configured for being supported on a substantially flat surface forward of the seated position of the user;
wherein the underside of said flexible base is configured for securely resting on a tray table from the rear of a airline seat;
a face ring shaped for supporting the head of the user over a cavity within the base;
openings between said cavity within said flexible base and the ambient air for providing ventilation;
hand-arm supports for extending down below the height of a tray table and configured for receiving the hands or arms in a relaxed position.

9. An apparatus as recited in claim 8, further comprising an air filter retained in said opening for filtering air being received by the user.

10. An apparatus for displaying positions and routes on a map display in response to data received from web sites, comprising:
a map database containing street and roadway information;
a map display program at map server web site configured for displaying portions of said map database in response to user control or data received from a web site; and
an interface for collecting location specific information from a non-mapping web site and displaying the information over the street and roadway information generated by the map display program;
wherein said location specific information can include animation data depicting nodes along a route;
wherein said location specific information can include graphic elements provided by said non-mapping web site.

11. An apparatus for displaying temporal related messages with limited user intervention, comprising:
a display array;
a user interface adapted with audio output and microphone input;
an electronic controller operably connected to said user interface, and said display array;
a speech to text converter within said controller for converting selected user input through said microphone to text for display on said display; and
wherein said electronic controller is adapted to convert user commands to selected data output on said display which may include user voiced messages which are converted to messages displayed on said display array;
wherein said voice input may be converted to display commands in response to display command context.

12. An apparatus for tracking tool location to prevent loss, comprising:
a portable housing with self contained power source configured for being carried by a user as a tracking unit;
an RFID transceiver within said tracking unit configured for challenging RFID units attached to tools to be kept track of;
an annunciator for indicating the status or location of tools being tracked;
memory for retaining a list of tools and status for each tool;
a computer processor executing instructions from memory and controlling the operation of said RFID transceiver and said annunciator; and
programming configured to execute on said computer processor for,
attempting communication with RFID units associated with each tool,
annunciating tools from the list of tools from which a response to the challenge is not received.

13. An apparatus as recited in claim 12, further comprising a positioning system for registering the location of the person wearing the tracking unit.

14. An apparatus as recited in claim 13, wherein said positioning system comprises a Global Positioning System (GPS), Inertial Navigation System (INAV), other system or combination of devices.

15. An apparatus as recited in claim 13, further comprising a compass for registering the orientation of said tracking unit.

16. An apparatus as recited in claim 12, further comprising a communication channel configured for communicating with other tracking units for the exchange of tool information.

17. An apparatus as recited in claim 16, wherein said programming further comprises sharing information about RFIDs and tool identifications with other tracking units within the range of said communication channel, and tracking information about tool use and location for tools associated with those additional RFIDs.

18. An apparatus as recited in claim 12, wherein said annunciator comprises a display and/or audio annunciator from which the description of a tool may be communicated to the user.

19. An apparatus as recited in claim 12, wherein said RFID transceiver is configured for communicating with RFID tags having a specific coding and which are within range of the RFID transceiver.

20. An apparatus as recited in claim 19, wherein said RFID transceiver issues a challenge and detects a response from those RFID tags with a unit code matching the challenge.

21. An apparatus as recited in claim 12, wherein said RFID transceiver is configured to generate sufficient energy in a form allowing a passive RFID unit to utilize energy received from the RFID transceiver when generating a response.

22. An apparatus for applying a liquid repair material to pavement cracks and voids, comprising:
a base adapted for mounting to a vehicle;
means for sensing cracks and voids in a pavement surface and generating a responsive signal, said means for sensing cracks being mounted on said base;
a mechanical translation stage attached to said base;
a reservoir for retaining liquid repair materials;
a nozzle adapted for dispensing liquid repair materials from said reservoir and mounted to said translation stage;
whereby said nozzle mounted to said translation stage is adapted for positioned dispensement of liquid repair material from said reservoir over selected portions of said pavement surface;
a flow control assembly coupled to said nozzle for regulating the flow of said liquid repair material from said reservoir; an electronic controller device operably coupled to said mechanical translation stage, said flow control assembly and said means for sensing; and
said electronic controller adapted to generate control signals for positioning said nozzle on said translation stage to align with said cracks and voids in said pavement and for activating said flow control assembly to dispense a sufficient quantity of liquid repair materials through said nozzle for sealing and or repairing said cracks and voids in said pavement.

23. An apparatus as recited in claim 22, wherein said apparatus comprises a plurality of said nozzles which are adapted for movement in one or more mechanical translation stages.

24. An apparatus as recited in claim 23:
wherein multiple mechanical translation stages are attached to said base;
wherein said multiple translation stages are adapted for moving more than one of a multiple of said nozzles into alignment with cracks and voids to be sealed and/or repaired;
wherein at least one of said mechanical translation stages are positioned in a substantially lateral direction in relation to the longitudinal movement direction of said vehicle to which said base may be mounted;

25. An apparatus for dispensing fluids for consumption, comprising
a fluid container configured to retain a water or a beverage;
a valve coupled to said fluid container configured for being opened by mouth or one hand for accessing the fluid contents of said fluid container; and
a means for restricting the amount of fluid which can be consumed from said fluid container in response to opening of said valve;
wherein said restricted amount of fluid comprises a between approximately five percent and thirty five percent of the total fluid container volume.

26. An apparatus for dispensing fluids for consumption, comprising
a housing configured for retaining fluid including water and beverages;
a first fluid chamber in said housing;
a valve coupled to said first fluid chamber configured for being opened by mouth or one hand for accessing the fluid contents of said first fluid chamber; and
a second fluid chamber sealed against said first fluid chamber for retaining a reserve quantity of fluid; and
means for unsealing second fluid chamber from said first fluid chamber to access the reserve quantity of fluid.

27. A visor frame comprising:
a structural frame member configured to wrap around a portion of the head of the wearer;
supports extending at intervals from the structural frame member;
at least one elongated tension member slidable engaged with said supports whose ends are attached near the ends of said structural frame; and
a means for adjusting the tension applied through said elongated tension member and said supports to said structural frame thereby changing the tension with which the visor frame is retained on the head of a wearer.

28. A visor frame as recited in claim 26, wherein said means comprises a rotating knob that engages said elongated tension member to change its tension in response to knob adjustments.

29. A toy apparatus, comprising:
a power source;
at least one environmental sensor;
an audio output;
a radio frequency response circuit configured to detect a challenge from a radio frequency transceiver held in sufficient proximity; and
a microcontroller circuit configured for generating an audio output in response to said detected challenge, the signal response from said environmental sensor, and/or time delays determined by said microcontroller.

30. A toy apparatus as recited in claim 29, wherein said challenge contains a selective code to which said radio frequency response is configured to detect.

31. A fishing lure, comprising:
a housing having a slight positive buoyancy in water;
wherein said housing is configured in the shape of a bait item and contains;
at least one hook assembly extending from said housing;
an anchor point configured for attachment of a leader line;
an electrical power source; and
a fluid propulsion system receiving drive power from said electrical power source, wherein motion is imparted to said housing and limited by the length of said leader line.

32. A fishing lure as recited in claim 31, wherein said fluid propulsion system comprises:
a motor coupled to said electrical power source; and
a propeller assembly, or ducted fan retained between an intake and outlet duct;

33. A fishing lure as recited in claim 31, further comprising a control circuit configured for modulating the activity of said motor to vary the path of said lure.

34. A fishing lure as recited in claim 31, further comprising a light output coupled to said electrical power source.

35. A fishing lure as recited in claim 34, wherein said light output is driven by the output of a control circuit which modulates the intensity of the light output.

36. A fishing lure as recited in claim 34, wherein said light output comprises an LED, or OLED.

37. A fishing lure as recited in claim 31, wherein said power source comprises a battery.

38. A fishing lure as recited in claim 31, wherein said power source comprises a capacitor configured for charging at the point of use by a charging device configured for use with said lure.

39. A fishing lure as recited in claim 31, further comprising a power switch for connecting the source of electrical power to a control circuit configured for controlling the operation of said propulsion system or a light output.

40. A fishing lure as recited in claim 39, wherein said control circuit is connected to said fluid propulsion system whose state of activity is modulated to alter the movement paths through the water of said housing;
further comprising an audio annunciator configured for generating audio signals to alert predator fish and increase the range by which fish are attracted to the lure.

41. An apparatus for outputting signals from a marker buoy, comprising:
collimated light source configured for projecting at least one beam of light;
housing for retaining said collimated light source, and configured for attachment to a buoy;
means for varying the horizontal and vertical angle of said collimated light source; and
means for sensing the motion of a buoy to which said collimated source is attached and modulating said horizontal and said vertical angle of said collimated light source to maintain desired directions of light projections despite buoy motion.

42. An apparatus as recited in claim 41, wherein said collimated light source comprises at least one laser light source.

43. An apparatus as recited in claim 41, wherein said means for varying the horizontal and vertical angle of said collimated light source comprises electromechanical actuators.

44. An apparatus as recited in claim 41, wherein said means for varying the horizontal angle of said collimated light source comprises an electromechanical actuator coupled for rotating said housing.

45. An apparatus as recited in claim 41, wherein said means for varying the vertical angle of said collimated light source comprises an electromechanical actuator coupled to a mirror for redirecting the light reflection.

46. An apparatus as recited in claim 41, wherein said means for sensing the motion of a buoy to which said collimated source is attached and modulating said horizontal and said vertical angle of said collimated light source, comprises:
a tilt sensor; and
a control circuit configured to generate signals for modulating the horizontal and vertical direction of said collimated light source in response to the signals generated from said tilt sensor.

47. An apparatus as recited in claim 41, further comprising an electronic compass for registering compass orientation from which buoy horizontal orientation and the horizontal direction of devices coupled to said buoy may be determined.

48. An apparatus as recited in claim 47, further comprising a means for directing a beam of audio sounds and/or speech in a selected horizontal (compass) angle from said apparatus.

49. An apparatus as recited in claim 48, wherein said beam of audio sounds and/or speech is directed over an angular of from two degrees to forty five degrees.

50. An apparatus as recited in claim 48, wherein said beam of audio sounds and/or speech is directed over an angular spread of from ten degrees to thirty degrees.

51. An apparatus as recited in claim 50, wherein said audio sounds and/or speech generated is responsive to the horizontal (compass) direction from the buoy giving listeners an indication of angular position in relation to said buoy.

52. An apparatus as recited in claim 41, further comprising sensors for registering the status of said apparatus and/or systems coupled to said buoy.

53. An apparatus as recited in claim 41, further comprising sensors for registering ambient conditions at said buoy.

54. An apparatus as recited in claim 53, wherein said sensors are selected from the group of ambient sensors consisting of air temperature, fog intensity, fog distance, humidity, wind speed, wind direction, sky obscuration, wave activity, water temperature, and light intensity.

55. An apparatus as recited in claim 53, wherein said sensors are selected from the group of ambient sensors consisting of audio transducers and video imagers.

56. An apparatus as recited in claim 53, further comprising a communications link configured for conveying sensor data from said apparatus at said buoy and for receiving remote control commands to said apparatus.

57. An apparatus as recited in claim 41, further comprising a means for detecting objects at a distance from said apparatus.

58. An apparatus as recited in claim 41, further comprising a large area display covering at least one square foot of the exterior of said buoy and configured for indicating conditions detected by said apparatus.

59. An apparatus as recited in claim 58, wherein said large area display is a non-volatile display; wherein said display comprises an electronic ink display.

60. An apparatus for powering a marker buoy comprising:
an electrical generator configured to generate an electrical current in response to a mechanical input;
wherein said electrical generator is configured for mounting on a marker buoy;
a mechanical coupling attaching the mechanical input of said generator to a location subject to less motion than experienced by said buoy;
an electrical energy storage device;
a power system for receiving energy from said electrical generator and conditioning it for storage on said electrical energy storage device.

61. An apparatus as recited in claim 60, wherein said mechanical coupling attached between the mechanical input of said generator and an anchor point attached to the floor of a body of water, or to an elongated member that attaches to said floor of said body of water.

62. An apparatus as recited in claim 60, further comprising a solar collector assembly coupled to said power system, for converting ambient light energy to electrical energy for storage on said electrical energy storage device.

63. An apparatus for powering a marker buoy comprising:
a fuel tank configured for retention in the base of a buoy;
a fuel cell for converting chemical energy from the fuel in said fuel tank to electrical energy, said fuel cell configured for secure retention in the base of said buoy;
an electrical energy storage device configured for temporarily storing electrical energy from said fuel cell.

64. An apparatus as recited in claim 63, wherein said electrical storage device comprises batteries or capacitors.

65. An apparatus as recited in claim 63, further comprising:
fuel level sensor configured to generate a signal in response to retained fuel level; and
a circuit for communicating said retained fuel level indication over a radio communication link to a remote location.

66. An apparatus for providing a comfortable resting position, comprising:
a flexible base configured for being supported on a substantially flat surface forward of the seated position of the user;
a face ring shaped for supporting the head of the user over a cavity within the base; and
openings between said cavity within said flexible base and the ambient air for providing ventilation.

67. An apparatus as recited in claim 66:
wherein said flexible base is inflatable toward reducing stored size;
wherein a fill stem is providing on said flexible base for inflating it.

68. An apparatus as recited in claim 66, wherein said flexible base is configured for securely resting on a generally horizontal surface.

69. An apparatus as recited in claim 68, wherein said flexible base is configured for securely resting on a tray table from the rear of a airline seat.

70. An apparatus as recited in claim 66, further comprising hand-arm supports for extending down below the height of a tray table and configured for receiving the hands or arms in a relaxed position.

71. An apparatus as recited in claim 70, wherein the length of said hand-arm supports are adjustable.

72. An apparatus as recited in claim 70, wherein said hand-arm supports are configured as an elongated loop extending from the each side of said flexible base;

73. An apparatus as recited in claim 66, further comprising an air filter retained in said opening for filtering air being received by the user.

74. An apparatus as recited in claim 66, further comprising a message holder on the exterior of said flexible base configured for reminding flight attendants of the wishes of the passengers.

75. An apparatus for reducing the extraneous loads placed on a vehicle engine during acceleration, comprising:
acceleration pedal sensor configured to sense if attempted acceleration exceeds a predetermined threshold; and
a control circuit for disengaging the air conditioning clutch in response to attempted acceleration exceeding said threshold.

76. An apparatus as recited in claim 75, wherein said control circuit is configured for reducing the field current in the alternator in response to acceleration which exceeds the threshold.

77. An apparatus as recited in claim 75, wherein said control circuit comprises a controller for the engine which is configured with accelerator pedal sensing, air conditioner clutch control output and programming for disengaging the clutch in response to a sufficient acceleration.

78. An apparatus as recited in claim 77, wherein said engine controller is further configured to reduce the field current in the alternator in response to acceleration which exceeds the threshold.

79. A system for registering vehicles automatically, comprising:
a electronic imager configured for capturing wide angle and zoomed images;
a computer configured to perform image processing;
programming operable on said computer for,
zooming in to the image of the license plate of a vehicle;
extracting license plate information from said image;
registering status of vehicle;
checking history of vehicle;
displaying relevant information about vehicle to user.

80. An apparatus for reserving a parking space, comprising:
housing configured for attachment to a parking space;
means for detecting the proximity of a vehicle parking over said housing;
an audio alarm configured for generating a loud alarm sequence;
a wireless communication link; and
a control circuit that activates said audio alarm upon said means detecting a parking vehicle, unless communication is received over said wireless communication link indicating that the vehicle is that of the space owner.

81. In a tape measure having an elongated ruled measure which extends from a housing, the improvement comprises:
a recess in the side of the tape measure adapted for receiving and retaining a small notepad.

82. The improvement as recited in claim 2, further comprising a storage compartment on said tape measure for receiving a writing implement.

83. In a tape measure having an elongated ruled measure which extends from a housing, the improvement comprises:
electronically readable markings on the elongated ruled measure; and
a reader assembly adapted to generate signals in response to reading of said electronically readable markings on said extended elongated ruled measure;
an output device for annunciating measurements; and
a controller operably connected to said reader assembly and said output device and adapted to generate length readings which are annunciated on said output device in response to the extension of said elongated ruled measure.

84. The improvement as recited in claim 83, wherein said output device comprises an audio output device, or a display, which is configured to annunciate measurements registered by said tape measure.

85. In a tape measure having an elongated ruled measure which extends from a housing, the improvement comprises:
electronically readable markings on the elongated ruled measure; and
a reader assembly adapted to generate signals in response to reading of said electronically readable markings on said extended elongated ruled measure;
a controller circuit operably connected to said reader assembly and adapted to communicate with a display enabled device for registering the associated measurements.

86. An apparatus for securing articles being transported in a moving vehicle, comprising:
at least one flexible bladder adapted for deployment within a storage area of a vehicle;
means for filling and emptying said bladder;
a control device for regulating said means for the filling and emptying of said bladder;
wherein control device activates said bladder which expands to a predetermined pressure to retain articles within said storage area and prevent rattling or shifting of contents, and may be emptied so that articles may be added or removed form said storage area.

87. An apparatus as recited in claim 86, wherein said means for filling and emptying said bladder comprises:
a reversible pump; and
a source of power for operating said pump.

88. An apparatus as recited in claim 86, wherein said pump is electrically driven and operates from a source of electrical power.

89. An apparatus for verifying that the lights on an automobile trailers are operating correctly, comprising:
a housing;
a connector adapted for establishing an electrical connection with the lighting receptacle plug from a trailer;
a voltage source adapted for generating a voltage across selected connections;
a current sensor adapted to sense current flow through said connections in response to the voltage generated by said voltage source;
a controller connected to said current source and adapted to sense if said current flow is within a predetermined range of current; and
an annunciator operatively coupled to said controller and adapted to indicate if the current draw through said connections is within a predetermined range.

90. An apparatus as recited in claim 89, wherein said apparatus is portable and sufficiently small as to be easily held in one hand.

91. An apparatus as recited in claim 89, wherein said apparatus is powered from a power source within or connected to said apparatus.

92. An apparatus as recited in claim 91, wherein said apparatus is powered from power retention devices within said housing.

93. An apparatus as recited in claim 92, wherein said power retention devices may be selected from the group of power retention devices consisting of batteries, fuel cells, capacitors, or combinations thereof.

94. An apparatus as recited in claim 93, wherein said capacitors may be charged from an external source of power.

95. An apparatus as recited in claim 94, wherein said external source of power comprises the charge current supplied from a vehicle power connection.

96. An apparatus as recited in claim 95, wherein said vehicle power connection comprises a cigarette lighter receptacle.

97. An apparatus as recited in claim 89, wherein said voltage source comprises the voltage supplied from said power source.

98. An apparatus as recited in claim 97, wherein said voltage source comprises the voltage from said power source after passing through a voltage regulator.

99. An apparatus as recited in claim 89, wherein said current sensor comprises a sense resistor from said voltage source, wherein the voltage drop across said sense resistor is indicative of the current flow.

100. An apparatus as recited in claim 89, wherein said current sensor comprises a current sensing element that provides an output in response to the level of current flow.

101. An apparatus as recited in claim 89, wherein said current sensor comprises an inductive sensor.

102. An apparatus as recited in claim 89, further comprising a switching device wherein said voltage source may be connected to any of a plurality of trailer lights.

103. An apparatus as recited in claim 102, wherein said trailer lights may be selected from the group of lighting elements consisting of: running lights, brake lights, turn signals, reverse lights, left turn signal, and right turn signal.

104. An apparatus as recited in claim 102, wherein said switching device is operated manually.

105. An apparatus as recited in claim 102, wherein said switching device is operated by said controller, in response to user input to said controller.

106. An apparatus as recited in claim 102, wherein said switching device is operated by said controller and automatically switches said voltage source between connections on said lighting receptacle.

107. An apparatus as recited in claim 106, wherein said switching device is adapted to perform said automatic switching sequentially through a series of connections to apply said voltage source to trailer lighting elements.

108. An apparatus as recited in claim 107, wherein said series of connections comprises each of the available lighting circuits within said lighting receptacle.

109. An apparatus as recited in claim 89, further comprising non-volatile data storage operatively coupled to said controller for storing configuration information for said apparatus.

110. An apparatus as recited in claim 109, wherein said configuration information includes information as to which connections are to be tested.

111. An apparatus as recited in claim 109, wherein said configuration information includes current values for selected connections.

112. An apparatus as recited in claim 111, wherein said current values comprise nominal current values that may be read by said controller when determining if said current flow is within a predetermined range of current.

113. An apparatus as recited in claim 89, wherein said controller comprises one or more digital circuit elements selected from the group of digital circuit elements consisting of microcontrollers, microprocessors, gate arrays, programmable logic elements, custom circuitry containing digital circuitry, discrete logic circuits, and combinations thereof.

114. An apparatus as recited in claim 89, wherein said controller comprises a processing element and programming for,
operating said switching element to select which trailer light connection said voltage source is to be applied,
registering said current from said current sensor,
comparing said current value with a predetermined threshold current value,
activating an annunciator in response to the result of said comparison.

115. An apparatus as recited in claim 89, wherein said annunciator comprises a display adapted to provide visual indications of whether said current falls within said predetermined range.

116. An apparatus as recited in claim 115, wherein said display comprises indicator elements which light up or change appearance to provide visual indications as to whether said sensed current has fallen within the predetermined range.

117. An apparatus as recited in claim 116, wherein said display comprises a display adapted for displaying icons, numbers, textual information, or combinations thereof.

118. An apparatus as recited in claim 117, wherein said display comprises LED indicator elements.

119. An apparatus as recited in claim 117, wherein said display comprises an LCD display.

120. An apparatus as recited in claim 117, wherein said display comprises an electronic ink display.

121. An apparatus as recited in claim 115, wherein said annunciator comprises an audio annunciator adapted to generate indications of whether said current falls within said predetermined range.

122. An apparatus for applying a liquid repair material to fill pavement cracks and voids, comprising:
means for sensing cracks and voids in a pavement surface and generating a responsive signal, said means for sensing cracks being mounted on said base;
a mechanical translation stage attached to said base;
a reservoir for retaining liquid repair materials;
a nozzle adapted for dispensing liquid repair materials received from a reservoir and mounted to said translation stage;
whereby said nozzle mounted to said translation stage is adapted for positioned dispensement of liquid repair material from said reservoir over selected portions of said pavement surface;
a flow control assembly coupled to said nozzle for regulating the flow of said liquid repair material from said reservoir;
an electronic controller device operably coupled to said mechanical translation stage, said flow control assembly and said means for sensing; and
said electronic controller adapted to generate control signals for positioning said nozzle on said translation stage to align with said cracks and voids in said pavement and for activating said flow control assembly to dispense a sufficient quantity of liquid repair materials through said nozzle for sealing and or repairing said cracks and voids in said pavement.

123. An apparatus as recited in claim 122, wherein said apparatus comprises a plurality of said means for sensing cracks and voids.

124. An apparatus as recited in claim 122, wherein said means for sensing cracks and voids comprises a mechanical feeler device.

125. An apparatus as recited in claim 124, wherein said mechanical feeler device comprises:
a plurality of elongated members retained in a predetermined position in relation to said base and having a free end adapted for maintaining contact with the surface of said pavement; and
a sensor operably coupled to each of said elongated members to detect movement therein.

126. An apparatus as recited in claim 122, wherein said means for sensing cracks and voids comprises an optical sensing device.

127. An apparatus as recited in claim 126, wherein said optical sensing device comprises a light source and a light sensitive receptor.

128. An apparatus as recited in claim 126, wherein said optical sensing device may be selected from the group of optical sensing devices consisting of cameras, photoreceptors, reflective sensors, photodiodes, and photocells.

129. An apparatus as recited in claim 126, wherein said optical sensing device comprises an array of optical sensors.

130. An apparatus as recited in claim 129, wherein said array of optical sensors spans a line adapted to detect cracks and voids which pass beneath any portion of said array of optical sensors.

131. An apparatus as recited in claim 130, wherein said array spanning said line is adapted to span a lateral portion of said base, in relation to a longitudinal movement of said vehicle to which said base is mounted, whereby cracks and voids along said lateral portion of said pavement may be sensed by said array in response to movement of said vehicle.

132. An apparatus as recited in claim 129, wherein said array of optical sensors spans an area and is adapted to detect cracks and voids which pass beneath any portion of area of said array of optical sensors.

133. An apparatus as recited in claim 122, wherein said mechanical translation stage comprises:
a track adapted for receiving said nozzles; and
a drive assembly adapted for connection to said nozzle for moving said nozzle along said track.

134. An apparatus as recited in claim 133, wherein said track comprises a substantially straight section of track.

135. An apparatus as recited in claim 122, wherein said mechanical translation stage comprises:
an arm adapted for receiving said nozzles;
a drive assembly adapted for providing angular rotation to said arm to move said nozzle.

136. An apparatus as recited in claim 122, further comprising means for increasing the flow rate of said liquid repair material through said nozzle beyond that of a gravity fed flow rate.

137. An apparatus as recited in claim 136, wherein said means for increasing the flow rate comprises a pump.

138. An apparatus as recited in claim 137, wherein said pump is located between said reservoir and said nozzle.

139. An apparatus as recited in claim 138, wherein said pump is attached to said reservoir.

140. An apparatus as recited in claim 139, wherein said pump is located on said nozzle.

141. An apparatus as recited in claim 122, wherein said flow control means comprises a valve assembly for controlling the flow of liquid repair material to said nozzle.

142. An apparatus as recited in claim 141, wherein said valve is located within said nozzle.

143. An apparatus as recited in claim 141, wherein said electronic controller comprises:
an electronic computational device;
user interface connected with said controller;
programming adapted for execution on said computational device for responding to the detection of said cracks and voids by positioning said nozzles in alignment with said cracks and voids and activating said flow control to dispense a quantity of liquid repair material.

144. An apparatus as recited in claim 143, wherein said electronic computational device is selected from the group of microcontroller devices, microprocessor devices, signal processors, and sequencers.

145. An apparatus as recited in claim 122, wherein said means for sensing cracks and voids is positioned sufficiently forward of said mechanical translation stage, for a given speed of said apparatus, to allow sufficient time for said nozzles to be positioned in alignment with said cracks or voids as they move rearwardly toward said mechanical translation stage.

146. An apparatus as recited in claim 122, further comprising means for sensing the velocity of said apparatus.

147. An apparatus as recited in claim 146, wherein said electronic controller receives a signal in response to the velocity of said apparatus from said means for sensing velocity.

148. An apparatus as recited in claim 146, wherein said means for sensing said velocity comprises:
a roller assembly adapted for retaining contact with said pavement; and
a rotational sensor coupled to said roller for generating an electrical signal in response to the rotations of said roller traversing said pavement.

149. An apparatus as recited in claim 122, further comprising means of sensing turn rate and direction of said apparatus.

150. An apparatus as recited in claim 122, further comprising means of detecting hills and valleys within said pavement and generating an electronic signal.

151. An apparatus as recited in claim 150, wherein said electronic controller is adapted to receive said electronic signal, and to respond to said electronic signal by adjusting the positioning of said nozzles and dispensement of fluids from said nozzle to compensate for detected variations in distance from the pavement surface.

152. An apparatus as recited in claim 122:
further comprising means of detecting local wind velocity near said nozzles and generating a signal to said controller; and
wherein flow rates and nozzle positioning may be adjusted by said controller to correct wind induced errors.

153. An apparatus as recited in claim 122, further comprising means of detecting physical location of said apparatus.

154. An apparatus as recited in claim 153, wherein said means for detecting physical location comprises a global positioning unit, an inertial navigation system, or combinations thereof.

155. An apparatus as recited in claim 122, further comprising means for logging the extent of repair and sealing work performed.

156. An apparatus as recited in claim 155, wherein said means for logging comprises a data storage area operably coupled to said electronic controller into which information about the dispensing of said liquid repair material is entered.

157. An apparatus as recited in claim 156, wherein said means for logging is adapted to log the physical position of said apparatus.

158. An apparatus as recited in claim 156, wherein said means for logging is adapted to record a mapping of each crack or void as it is filled by said apparatus.

159. An apparatus for manually dispensing liquid repair material onto cracks and voids in a pavement surface, comprising:
a shaft adapted for being positioned manually;
means for sensing cracks and voids in a pavement surface and generating a responsive signal, said means for sensing cracks being mounted on said base;
a mechanical translation stage attached to said shaft;
a nozzle adapted for dispensing liquid repair materials from a source of a fluid repair material;
whereby said nozzle mounted to said translation stage is adapted for positioned dispensement of liquid repair material from said reservoir over selected portions of said pavement surface;
a flow control assembly coupled to said nozzle for regulating the flow of said liquid repair material from said reservoir;
an electronic controller device operably coupled to said mechanical translation stage and said means for sensing; and
said electronic controller adapted to generate control signals for positioning said nozzle on said shaft to align with said cracks and voids in said pavement.

160. An apparatus as recited in claim 159, further comprising a manual valve controlled by a user for dispensing fluid repair material.

161. An apparatus as recited in claim 159, further comprising a electronic valve controlled by said electronic controller for dispensing fluid repair material in response to the amount determined in response to said signal from said means for sensing.
